(19) United States
(12) Patent Application Publication
(10) Pub. No.: US 2018/0208846 A1
(43) Pub. Date: Jul. 26, 2018

(54) LIQUID CRYSTAL COMPOSITION AND LIQUID CRYSTAL DISPLAY DEVICE INCLUDING THE SAME

(71) Applicant: DIC Corporation, Tokyo (JP)

(72) Inventors: Megumi Uzawa, Kita-adachi-gun (JP); Junko Yamamoto, Kita-adachi-gun (JP); Shirou Taniguchi, Kita-adachi-gun (JP); Tomoaki Hara, Kita-adachi-gun (JP); Go Sudo, Kita-adachi-gun (JP)

(73) Assignee: DIC Corporation, Tokyo (JP)

(21) Appl. No.: 15/745,804

(22) PCT Filed: Jul. 26, 2016
(86) PCT No.: PCT/JP2016/071843

§ 371 Date: Jan. 18, 2018

(30) Foreign Application Priority Data
Aug. 7, 2015 (JP) 2015-157100
Apr. 22, 2016 (JP) 2016-086204

(51) Int. Cl. C09K 19/34; C09K 19/54; C09K 19/42

(52) U.S. Cl. CPC C09K 19/3447; C09K 2019/548; C09K 19/42; C09K 19/542

(57) ABSTRACT

There are provided a liquid crystal composition containing one or two or more compounds represented by the general formula (I) and a liquid crystal display device including the liquid crystal composition. A liquid crystal composition containing a compound represented by the general formula (I) has high dielectric constant anisotropy and low viscosity and is of great practical use as a liquid crystal composition for liquid crystal displays. A liquid crystal display device including a liquid crystal composition according to the present invention has a high contrast, high-speed responsivity, high light resistance, and a lower occurrence of image sticking and display defects, and is effective for higher-speed response and high-quality reliability.

### TECHNICAL FIELD

The present invention relates to a liquid crystal composition useful as an electrooptical liquid crystal display material.

### BACKGROUND ART

Liquid crystal display devices are used in various measuring instruments, automotive panels, word processors, electronic notebooks, printers, computers, television sets, clocks and watches, and advertising boards, as well as clocks and watches and electronic calculators. Typical liquid crystal display modes include a twisted nematic (TN) mode, a super twisted nematic (STN) mode, a vertically aligned (VA) mode characterized by vertical alignment including a thin-film transistor (TFT), and an in-plane switching (IPS)/fringe field switching (FFS) mode characterised by horizontal alignment including a thin-film transistor (TFT).

Liquid crystal materials having a negative dielectric constant anisotropy (Δε) are characteristically used in the IPS mode, an electrically controlled birefringence. (ECB) mode, the VA mode, and a color super homeotropic (CSH) mode among such display modes. By contrast, liquid crystal compositions having a positive Δε are used in horizontal alignment displays of the TN mode, the STN mode, and the IPS mode. In recent years, a display drive mode has been reported that includes vertically aligning a liquid crystal composition having a positive Δε under no voltage application and applying an IPS mode/FFS mode electric field to the liquid crystal composition. In all these drive modes, there is a demand for low-voltage drive, high-speed response, and a wide operating temperature range. In other words, there is a demand for a high absolute Δε, a low viscosity (η), and a high nematic phase-isotropic liquid phase transition temperature (Tₙᵢ). In order to set the product Δn×d of refractive index anisotropy (Δn) and cell gap (d) at a predetermined value, the Δn of a liquid crystal composition must be adjusted in an appropriate range for the cell gap. Furthermore, liquid crystal display devices for use in television sets require a liquid crystal composition with a low γ₁ due to the importance of high-speed responsivity. Liquid crystal compositions are generally composed of several to tens of compounds to optimize the Δs and Δn in each display device.

In addition to the demands on the physical properties of liquid crystal compositions, a liquid crystal composition, for use in a liquid crystal display device should be stable toward external stimuli, such as water, air, heat, and light. A lack of stability toward external stimuli causes display defects of a liquid crystal display device, such as image sticking or display unevenness. A high voltage holding ratio (VHR) is generally believed to be essential to prevent display defects, such as image sticking or display unevenness. Thus, it is known that some liquid crystal compositions contain a particular compound in combination with, for example, an antioxidant, an ultraviolet absorber, or a light stabilizer (Patent Literature 1 and Patent Literature 2). Stability toward external stimuli is regarded as important in any application. Thus, further development of a liquid crystal composition that can achieve a high VHR is required.

Furthermore, liquid crystal compositions for use in liquid crystal television sets that require high-speed response need a sufficiently low η, a sufficiently low γ₁, a high elastic constant (K₃₃), and a high VHR without a decrease in Δn and Tₙᵢ. Furthermore, there is a demand for a liquid crystal display device including such a liquid crystal composition with no or few display defects, such as image sticking or display unevenness and with high display quality and a high-speed response time.

### CITATION LIST

### Patent Literature

PTL 1: Japanese Unexamined Patent Application Publication No. 2014-84460

PTL 2: Japanese Unexamined Patent Application Publication No. 2014-84462

### SUMMARY OF INVENTION

### Technical Problem

It is an object of the present invention to provide a liquid crystal composition that is stable toward heat and light and can maintain a high voltage holding ratio and to provide a liquid crystal display device with high display quality including the liquid crystal composition.

### Solution to Problem

The present inventors have completed the present invention by examining various liquid crystal compounds and various chemical substances and finding that a particular compound can be used to solve the problems described above.

The present invention provides a liquid crystal composition, containing a compound represented by the general formula (I) and a liquid crystal display device including the liquid crystal composition.

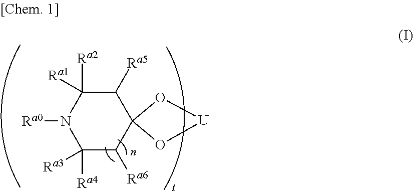

(In the formula, R^{a0} denotes a hydrogen atom, a hydroxy group, an alkyl group having 1 to 12 carbon atoms, or an alkenyl group having 3 to 12 carbon atoms,

R^{a1}, R^{a2}, R^{a3}, and R^{a4} independently denote an alkyl group having 1 to 6 carbon atoms, or R^{a1} and R^{a2}, R^{a3} and R^{a4}, or both may together form a ring structure,

R^{a5} and R^{a6} independently denote a hydrogen atom or an alkyl group having 1 to 6 carbon atoms,

n is 0 or 1,

t ranges from 1 to 4, and

U denotes a (2×t)-valent organic group that forms a ring structure, and pluralities of R^{a0}s, R^{a1}s, R^{a2}a, R^{a3}s, R^{a4}s, R^{a5}s, and R^{a6}s, if present, may be the same or different R^{a0}s, R^{a1}s, R^{a2}s, R^{a3}s, R^{a4}s, R^{a5}s, and R^{a6}s, respectively.)

### Advantageous Effects of Invention

A liquid crystal composition according to the present invention is stable toward heat and light and can maintain a high voltage holding ratio. Thus, a liquid crystal display device including the liquid crystal composition has no or few display defects and high display quality.

### DESCRIPTION OF EMBODIMENTS

A liquid crystal composition according to the present invention contains one or two or more compounds represented by the general formula (I).

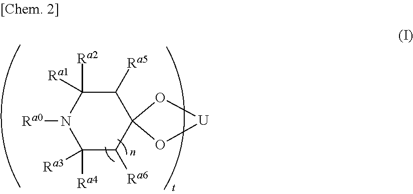

In the general formula (I), R^{a0} is preferably a hydrogen atom or a hydroxy group, particularly preferably a hydrogen atom, in order to improve ability to prevent photodegradation. An alkyl group having 1 to 12 carbon atoms or an alkenyl group having 3 to 12 carbon atoms is preferred in order to improve compatibility in the liquid crystal composition.

R^{a1}, R^{a2}, R^{a3}, and R^{a4} preferably independently denote an alkyl group having 1 to 4 carbon atoms, particularly preferably a methyl group. Preferably, R^{a1} and R^{a2}, R^{a3} and R^{a4}, or both together form a ring structure to facilitate the removal of polar impurities introduced during production.

R^{a5} and R^{a6} preferably independently denote a hydrogen atom or an alkyl group having 1 to 4 carbon atoms, particularly preferably a hydrogen atom in terms of manufacturability.

n is preferably 1.

t is preferably 1 or 2, particularly preferably 1, in order to improve the storage stability of the liquid crystal composition. In order to improve ability to prevent photodegradation, t is preferably 3 or 4 due to an increased number of hindered amine structures per unit weight.

U is preferably a structure represented by the general formula (I-a) in order to improve the storage stability of the liquid crystal composition.

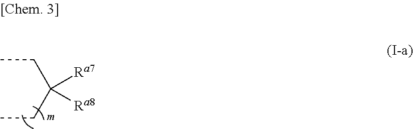

(In the formula, each broken line denotes a bond to an oxygen atom, R^{a7} and R^{a8} independently denote a hydrogen atom or a monovalent organic group, or R^{a7} and R^{a8} may together form a ring structure, and m is 0 or 1.) In order to facilitate the formation of a linear structure as in typical liquid crystal compounds and consequently improve compatibility in the liquid crystal composition, R^{a7} particularly preferably denotes a hydrogen atom or an alkyl group having 1 to 4 carbon atoms, and m is particularly preferably 1.

If t in the general formula (I) is 1, R^{a8} preferably denotes a hydrogen atom or an alkyl group having 1 to 12 carbon atoms, more preferably an alkyl group having 1 to 8 carbon atoms, and one —CH₂— or two or more nonadjacent —CH₂— groups in the alkyl group may be substituted with —O—, —COO—, —OCO—, —CH═CH—, or —C≡C—.

R^{a8} particularly preferably denotes a structure represented by the general formula (I-d) to improve compatibility in the liquid crystal composition, Sp^{a1} and Sp^{a2} preferably independently denote a single bond or an alkylene group having 1 to 12 carbon atoms, preferably a single bond or an alkylene group having 1 to 8 carbon atoms, more preferably a single bond or an alkylene group having 1to 6 carbon atoms, one —CH₂— or two or more nonadjacent —CH₂— groups in the alkylene group optionally being substituted with —O—, —COO—, —OCO—, —CH═CH—, or —C≡C—, particularly preferably a single bond.

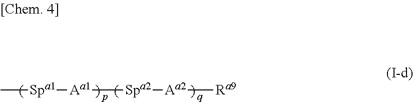

In order to improve the storage stability of the liquid crystal composition, A^{a1} and A^{a2} preferably independently denote a group selected from the group consisting of

(a) a 1,4-cyclohexylene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═).

The groups (a), (b), and (c) may be independently substituted with a cyano group, a fluorine atom, a chlorine atom, a methyl group, or a methoxy group. R^{a9} preferably denotes a hydrogen atom or an alkyl group having 1 to 12 carbon atoms, more preferably a hydrogen atom or an alkyl group having 1 to 6 carbon atoms, and one —CH₂— or two or more nonadjacent —CH₂— groups in the alkyl group may be substituted with —O—, —S—, —COO—, —OCO—, —CO—, —CH═CH—, or —C≡C— and are preferably substituted with —O— or —CH═CH—.

p and q are preferably independently 0 or 1.

If t in the general formula (I) is 2, U preferably has a structure represented by the general formula (I-b) or (I-c) in order to enhance the ability to prevent photodegradation.

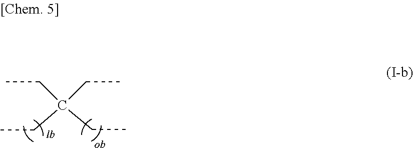

(In the formula, each broken line denotes a bond to an oxygen atom, and lb and ob are independently 0 or 1.) preferably has a structure represented by in order to enhance the ability to prevent photodegradation.

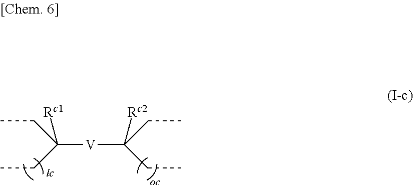

(In the formula, each broken line denotes a bond to an oxygen atom, lc and oc are independently 0 or 1, R^{c1} and R^{c2} independently denote a hydrogen atom or a monovalent organic group, and V denotes a divalent organic group.)

R^{a1} and R^{a2} preferably denote a hydrogen atom or an alkyl group having 1 to 10 carbon atoms, preferably a hydrogen atom or an alkyl group having 1 to 5 carbon atoms, preferably a hydrogen atom or an alkyl group having 1 to 3 carbon atoms, more preferably a hydrogen atom, a methyl group, or an ethyl group.

The general formula (I-c) is preferably a structure represented by the general formula (I-c1).

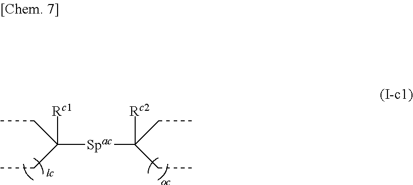

(In the formula, each, broken, line denotes a bond to an oxygen atom, lc and oc are independently 0 or 1, R^{c1} and R^{c2} independently denote a hydrogen atom or a monovalent organic group, Sp^{ac} denotes a single bond or an alkylene group having 1 to 12 carbon atoms, and one —CH₂— or two or more nonadjacent —CH₂— groups in the alkylene group may be substituted with —O—, —COO—, —OCO—, —CH═CH—, or —C≡C—.)

Sp^{ac} more preferably denotes a single bond or an alkylene group having 1 to 8 carbon atoms.

The general formula (I-c) is preferably a structure represented by the general formula (I-c2).

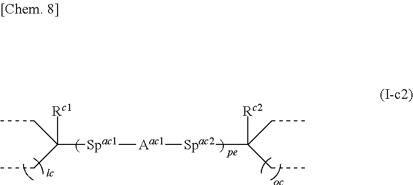

(In the formula, each broken line denotes a bond to an oxygen atom, lc and oc are independently 0 or 1, R^{c1} and R^{c2} independently denote a hydrogen atom or a monovalent organic group, Sp^{ac1} and Sp^{ac2} independently have the same meaning as Sp^{a1} in the general formula (I-d), and A^{ac1} denotes a group selected from the group consisting of

(a) a 1,4-cyclohexylene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═),

the groups (a), (b), and (c) may be independently substituted with a cyano group, a fluorine atom, a chlorine atom, a methyl group, or a methoxy group, pc is 1 or 2, and pluralities of Sp^{ac1}s, Sp^{ac2}s, and A^{ac1}s, if present, may be the same or different Sp^{ac1}s, Sp^{ac2}s, and A^{ac1}s, respectively.)

If t in the general formula (I) is 3 or 4, U preferably has a structure represented by the general formula (I-f) in order to enhance the ability to prevent photodegradation.

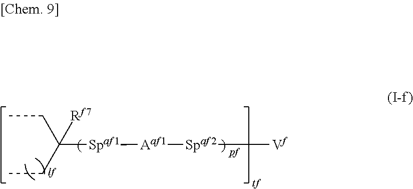

(In the formula, each broken line denotes a bond to an oxygen atom, lf is 0 or 1, R^{f7} denotes a hydrogen atom or a monovalent organic group, Sp^{af1} and Sp^{af2} independently have the same meaning as Sp^{a1} in the general formula (I-c), A^{af1} has the same meaning as A^{a1} in the general formula (I-c), pf is 0, 1, or 2, tf is 3 or 4, V^{f} denotes a trivalent or tetravalent group, the valence of V^{f} is the same as the value of tf, and pluralities of Sp^{af1}s, Sp^{af2}s, and A^{af1}s, if present, may be the same or different Sp^{af1}s, Sp^{af2}s, and A^{af1}s, respectively.)

R^{f7} preferably denotes an alkyl group having 1 to 10 carbon atoms, preferably a hydrogen atom or an alkyl group having 1 to 5 carbon atoms, preferably a hydrogen atom or an alkyl group having 1 to 3 carbon atoms, more preferably a hydrogen atom, a methyl group, or an ethyl group.

If tf in the general formula (I-f) is 3, that is, if V^{f} has a valence of 3, V^{f} preferably denotes a hydrocarbon group having 1 to 15 carbon atoms, and one —CH₂— or two or more nonadjacent —CH₂— groups in the carbon atoms in the hydrocarbon group may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, —OCF₂—, —CF₂O—, or —C≡C—. V^{f} more preferably denotes a group selected from the groups represented by the formulae (V3-1) to (V3-12).

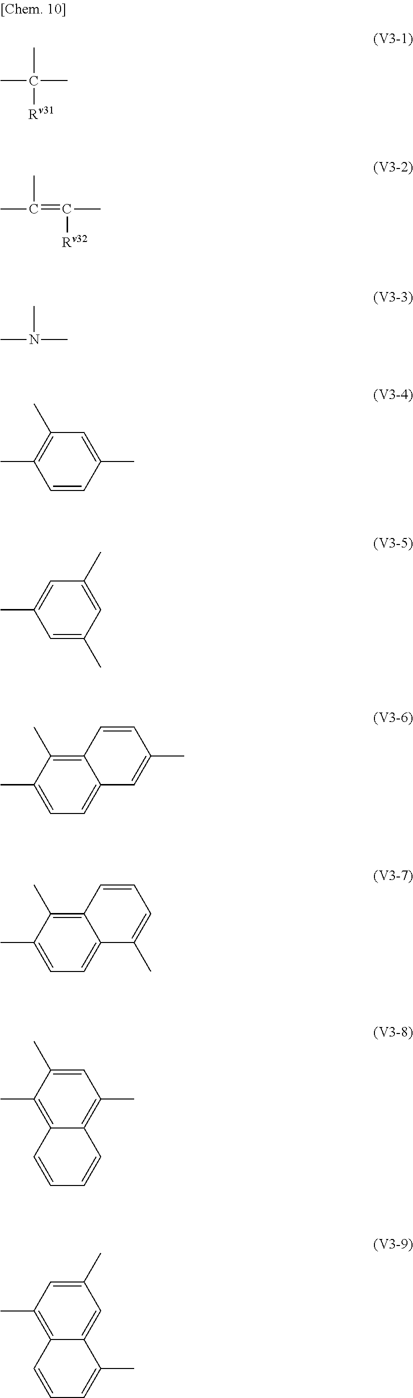

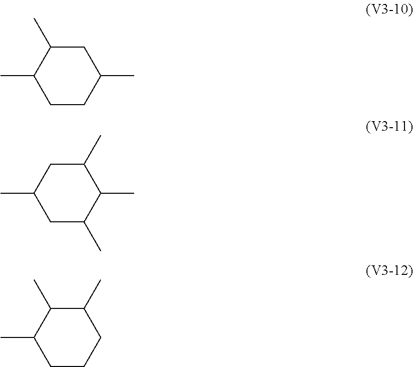

(In the formula, R^{v31} and R^{v32} denote a hydrogen atom, a hydroxy group, or an alkyl group having 1 to 10 carbon atoms, and one or two or more —CH₂— groups in the alkyl group may be independently substituted with —O—, —S—, —CH═CH—, —C≡C—, —CO—O—, or —O—CO—. A hydrogen atom in the ring structure may be substituted with a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, or an alkyl group having 1 to 12 carbon atoms, and one —CH₂— or two or more nonadjacent —CH₂— groups in the alkyl group may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, —OCF₂—, —CF₂O—, or —C≡C—.)

R^{v31} and R^{v32} preferably denote a hydrogen atom, a hydroxy group, or an alkyl group having 1 to 8 carbon atoms and are preferably linear. The formulae (V3-4) to (V3-12) are preferably independently unsubstituted, and a hydrogen atom in the formulae (V3-4) to (V3-12) may be substituted with a cyano group, a fluorine atom, a chlorine atom, a methyl group, or a methoxy group.

From the perspective of the availability and manufacturability of raw materials, a group selected from the formula (V3-1), the formula (V3-2), and the unsubstituted formulae (V3-3) to (V3-12) is particularly preferred.

If tf in the general formula (I-f) is 4, that is, if V^{f} has a valence of 4, V^{f} preferably denotes a hydrocarbon group having 1 to 15 carbon atoms, and one —CH₂— or two or more nonadjacent —CH₂— groups in the carbon atoms in the hydrocarbon group may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, —OCF₂—, —CF₂O—, or —C≡C—. V^{f} more preferably denotes a group selected from the groups represented by the formulae (V4-1) to (V4-21).

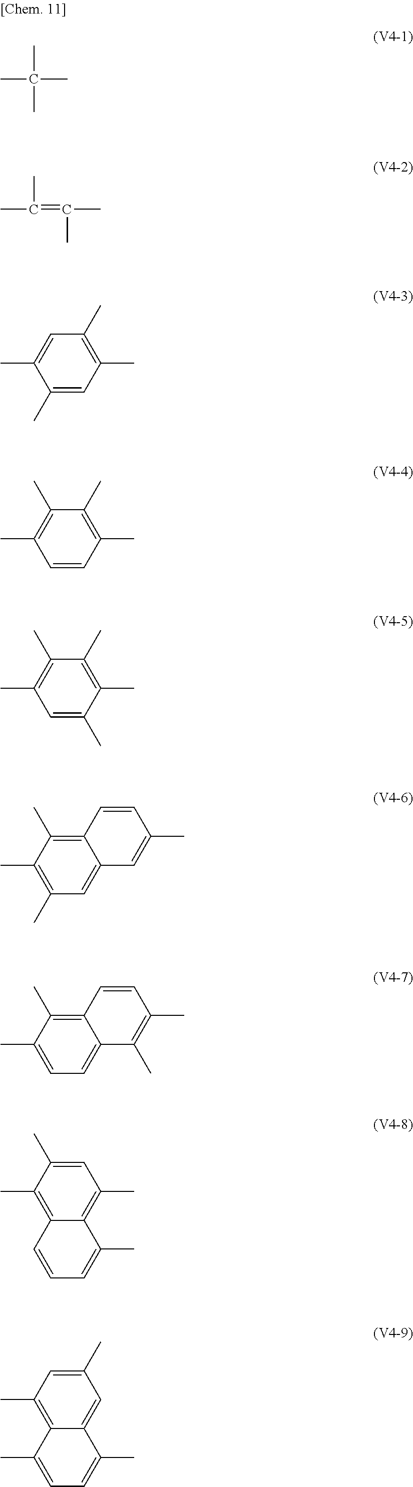

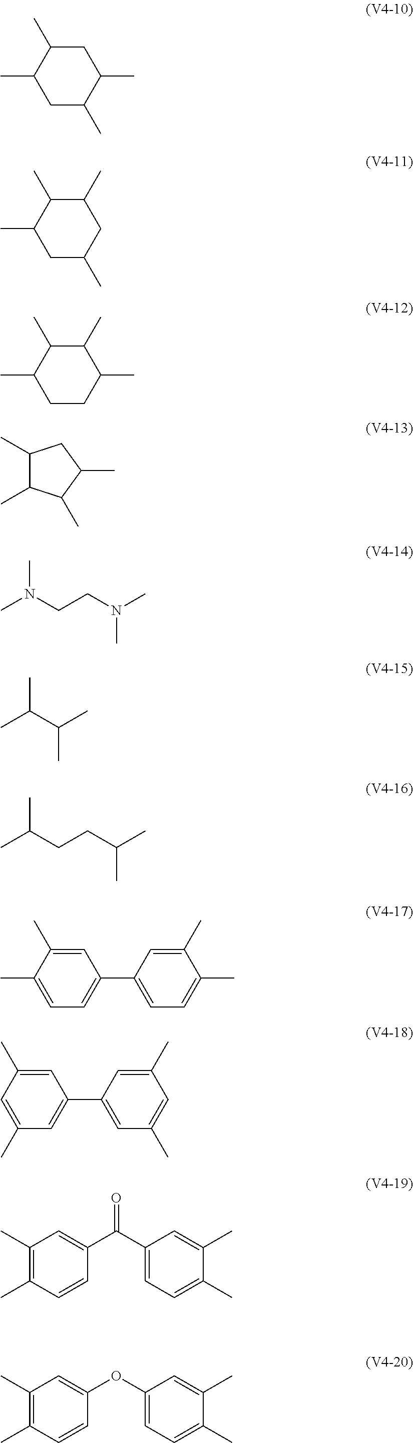

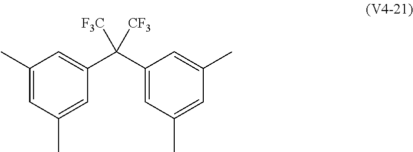

A hydrogen atom in the ring structure may be substituted with a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, or an alkyl group having 1 to 12 carbon atoms, and one —CH₂— or two or more nonadjacent —CH₂— groups in the alkyl group may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, — COO—CH═CH—, —OCO—CH═CH—, —CH═CH—, —CF═CF—, —OCF₂—, —CF₂O—, or —C≡C—. The formulae (V4-3) to (V4-21) are preferably independently unsubstituted, and a hydrogen atom in the formulae (V4-3) to (V4-21) may be substituted with a cyano group, a fluorine atom, a chlorine atom, a methyl group, or a methoxy group.

From the perspective of the availability and manufacturability of raw materials, a group selected from the formula (V4-1), the formula (V4-2), and the unsubstituted formulae (V-3) to (V-21) is particularly preferred.

Although specific examples of preferred compounds of compounds represented by the general formula (I) according to the present invention are described below, the present invention is not limited to these compounds.

A compound represented by the general formula (I) is preferably a compound represented by the general formula (I-1).

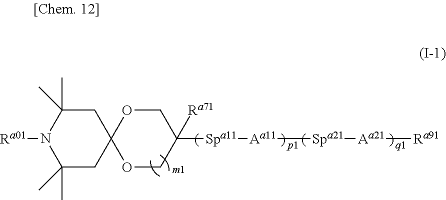

(In the formula, R^{a01} denotes a hydrogen atom or a hydroxy group, and R^{a71} denotes a hydrogen atom or a monovalent organic group,

Sp^{a11} and Sp^{a21} independently denote a single bond or an alkylene group having 1 to 12 carbon atoms, one —CH₂— or two or more nonadjacent —CH₂— groups in the alkylene group may be substituted with —O—, —COO—, —OCO—, —CH═CH—, or —C≡C—, and A^{a11} and A^{a21} independently denote a group selected from the group consisting of

(a) a 1,4-cyclohexylene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═),

the groups (a), (b), and (c) may be independently substituted with a cyano group, a fluorine atom, a chlorine atom, a methyl group, or a methoxy group, and R^{a91} denotes a hydrogen atom, an alkyl group having 1 to 12 carbon atoms, or a group represented by the general formula (I-e),

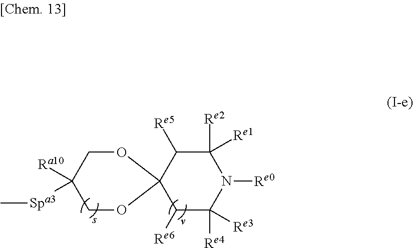

(In the formula, R^{e0}, R^{e1}, R^{e2}, R^{e3}, R^{e4}, R^{e5}, and R^{e6} have the same meaning as R^{a0}, R^{a1}, R^{a2}, R^{a3}, R^{a4}, R^{a5}, and R^{a6}, respectively, in the general formula (I), R^{a10} denotes a hydrogen atom or a monovalent organic group, Sp^{a3} denotes a single bond or an alkylene group having 1 to 12 carbon atoms, one —CH₂— or two or more nonadjacent —CH₂— groups in the alkylene group may be substituted with —O—, —COO—, —OCO—, —CH═CH—, or —C≡C—, and s and v are independently 0 or 1.)

one —CH₂— or two or more nonadjacent 13 CH₂— groups in R^{a91} may be substituted with —O—, —S—, —COO—, —OCO—, —CO—, —CH═CH—, or —C≡C—, and

m1, p1, and q1 are independently 0 or 1.)

R^{a01} preferably denotes a hydrogen atom.

R^{a10} preferably denotes a hydrogen atom or an alkyl group having 1 to 4 carbon atoms.

Sp^{a11} and Sp^{a21} preferably independently denote a single bond or an alkylene group having 1 to 8 carbon atoms, more preferably a single bond or an alkylene group having 1 to 6 carbon atoms, one —CH₂— or two or more nonadjacent —CH₂— groups in the alkyl group preferably being substituted with —O—, —COO—, —OCO—, —CH═CH—, or —C≡C—, particularly preferably a single bond.

R^{a91} preferably denotes a hydrogen atom or an alkyl group having 1 to 6 carbon atoms, and one —CH₂— or two or more nonadjacent —CH₂— groups in the alkyl group are also preferably substituted with —O— or —CH═CH—.

R^{a91} preferably denotes a group represented by the general formula (I-e) in order to enhance the ability to prevent photodegradation. R^{e0} preferably denotes a hydrogen atom or a hydroxy group in order to enhance the ability to prevent photodegradation, particularly preferably a hydrogen, atom in terms of manufacturability. An alkyl group having 1 to 12 carbon atoms or an alkenyl group having 3 to 12 carbon atoms is preferred in order to improve compatibility in the liquid crystal composition.

R^{e1}, R^{e2}, R^{e3}, and R^{e4} preferably independently denote an alkyl group having 1 to 4 carbon atoms, particularly preferably a methyl group. Preferably, R^{e1} and R^{e2}, R^{e3} and R^{e4}, or both together form a ring structure to facilitate the removal of polar impurities introduced during production.

R^{e5} and R^{e6} preferably independently denote a hydrogen atom or an alkyl group having 1 to 4 carbon atoms, particularly preferably a hydrogen atom in terms of manufacturability.

Sp^{a3} preferably independently denotes a single bond or an alkylene group having 1 to 8 carbon atoms, one —CH₂— or two or more nonadjacent —CH₂— groups in the alkyl group preferably being substituted with —O—, —COO—, —OCO—, —CH═CH—, or —C≡C—, particularly preferably a single bond.

R^{a10} preferably denotes a hydrogen atom.

s and v are preferably independently 1.

The general formula (I-e) is preferably a group represented by the general formula (I-e1).

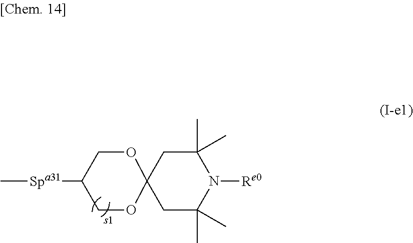

(In the formula, R^{e01} denotes a hydrogen atom or a hydroxy group, Sp^{a31} has the same meaning as Sp^{a3} in the general formula (I-e), and sl denotes 0 or 1.) A structure represented by is particularly preferred in order to enhance the ability to prevent photodegradation. R^{e01} preferably denotes a hydrogen atom. Sp^{a31} preferably denotes a single bond or an alkylene group having 1 to 6 carbon atoms, one —CH₂— or two or more nonadjacent —CH₂— groups in the alkylene group preferably being substituted with —O—, —COO—, —OCO—, —CH═CH—, or —C≡C—, particularly preferably a single bond, sl is preferably 1.

m1 and p1 are preferably 1. q1 is preferably 0.

A compound represented by the general formula (I) preferably has a structure represented by the general formula (I-2).

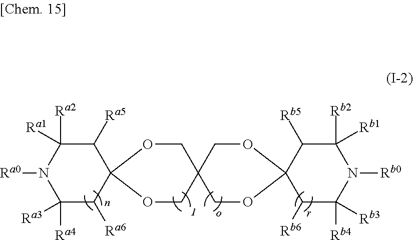

(In the formula, R^{a0}, R^{a1}, R^{a2}, R^{a3}, R^{a4}, R^{a5}, R^{a6}, and n have the same meaning as R^{a0}, R^{a1}, R^{a2}, R^{a3}, R^{a4}, R^{a5}, R^{a6}, and n, respectively, in the general formula (I), R^{b0}, R^{b1}, R^{b2}, R^{b3}, R^{b4}, R^{b5}, and R^{b6} have the same meaning as R^{a0}, R^{a1}, R^{a2}, R^{a3}, R^{a4}, R^{a5}, and R^{a6}, respectively, in the general formula (I), and l, o, and r are independently 0 or 1.)

R^{b0} preferably denotes a hydrogen atom or a hydroxy group in order to enhance the ability to prevent photodegradation, particularly preferably a hydrogen atom in terms of manufacturability. An alkyl group having 1 to 12 carbon atoms or an alkenyl group having 3 to 12 carbon atoms is preferred in order to improve compatibility with a liquid crystal. R^{b1}, R^{b2}, R^{b3}, and R^{b4} preferably independently denote an alkyl group having 1 to 4 carbon atoms, particularly preferably a methyl group. Preferably, R^{b1} and R^{b2}, R^{b3} and R^{b4}, or both together form a ring structure to facilitate the removal of polar impurities introduced during production. R^{b5} and R^{b6} preferably independently denote a hydrogen atom or an alkyl group having 1 to 4 carbon atoms, particularly preferably a hydrogen atom in terms of manufacturability. Preferably, l, o, and r are independently 1 to improve the storage stability of the liquid crystal composition.

The compounds represented by the general formula (I) are particularly preferably represented by the following general formulae (I-a-1) to (I-a-11), (I-b-1), and (I-c-1) to (I-c-11).

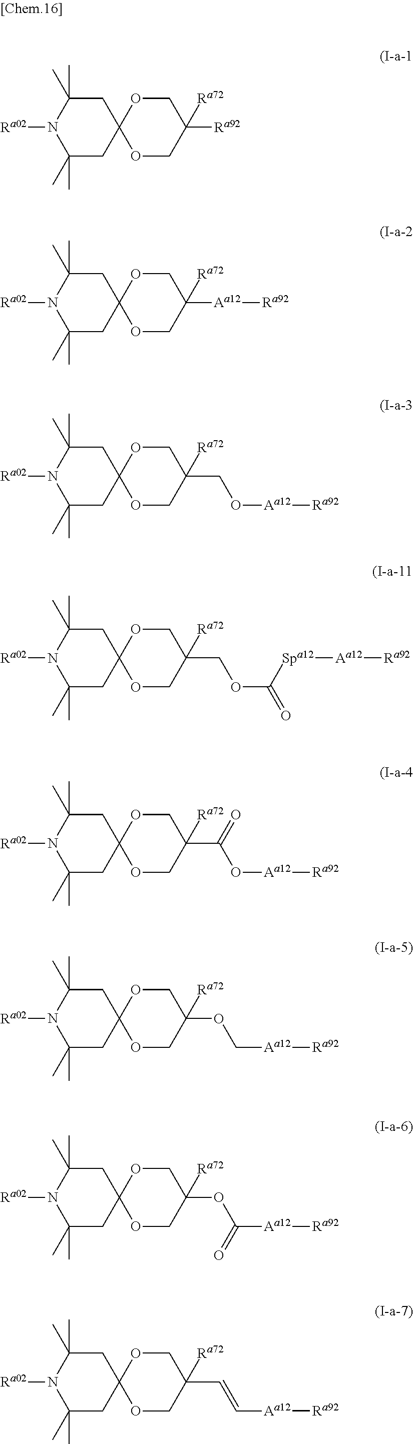

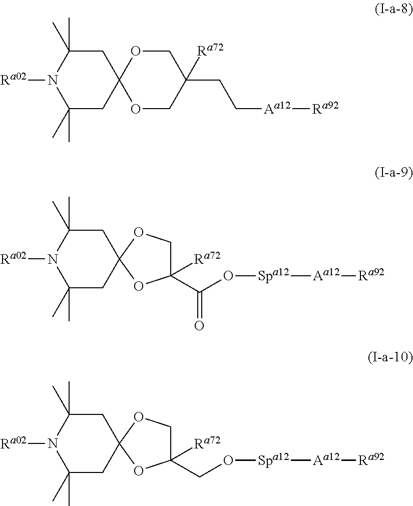

(In the formula, R^{a02} has the same meaning as R^{a0} in the general, formula (I), R^{a72} has the same meaning as R^{a71} in the general formula (I), R^{a92}, A^{a12}, and Sp^{a12} have the same meaning as R^{a9}, A^{a1}, and Sp^{a1}, respectively, in the general formula (I-d), Sp^{a13} denotes a single bond or an alkylene group having 1 to 8 carbon atoms, one —CH₂— or two or more nonadjacent —CH₂— groups in the alkylene group may be substituted with —O—, —COO—, —OCO—, —CH═CH—, or —C≡C—, p^{a1} is 1 or 2, and pluralities of Sp^{a13}s and A^{a12}s, if present, may be the same or different Sp^{a13}s and A^{a12}s, respectively.)

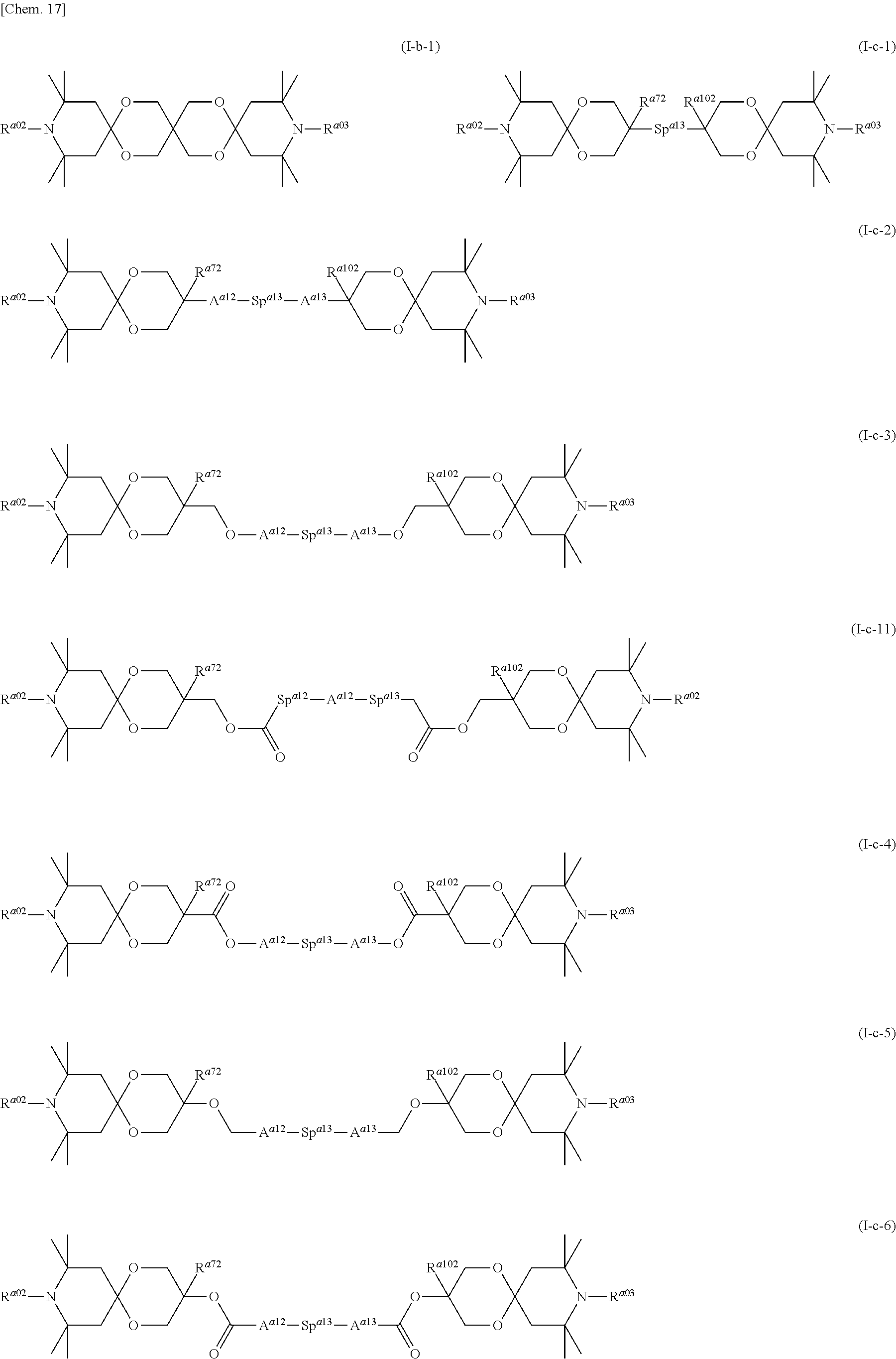

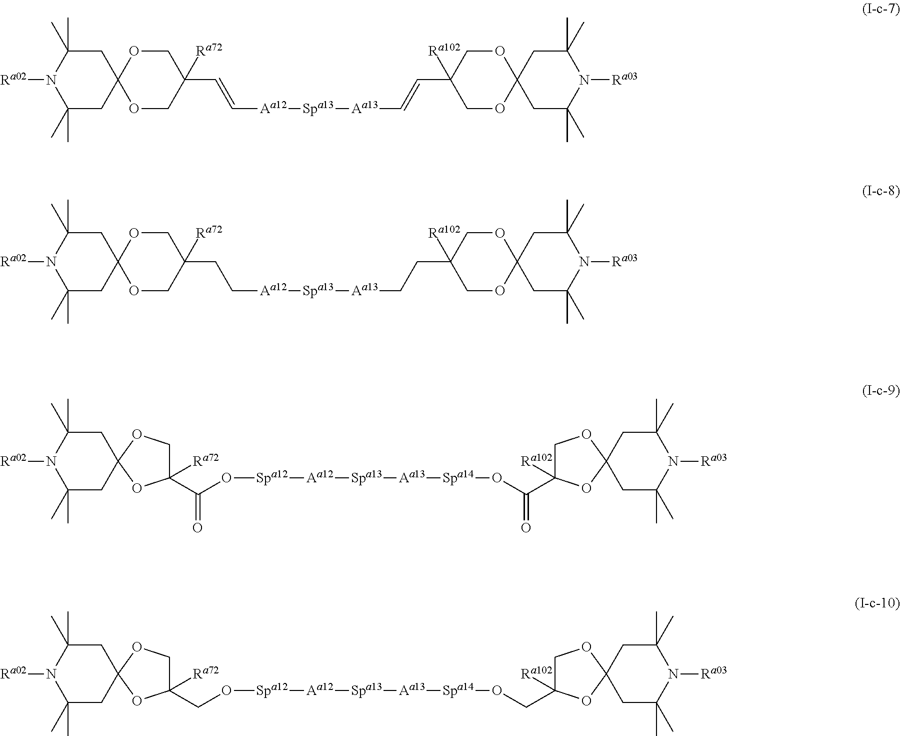

In the formula, R^{a02} and R^{a03} independently have the same meaning as R^{a0} in the general formula (I), R^{a72} and R^{a102} have the same meaning as R^{a71} in the general formula (I), A^{a13}, Sp^{a14}, and Sp^{a15} have the same meaning as A^{ac1}, Sp^{ac1}, and Sp^{ac2}, respectively, in the general formula (I-c2), Sp^{a16} and Sp^{a17} independently denote a single bond or an alkylene group having 1 to 8 carbon atoms, one —CH₂— or two or more nonadjacent —CH₂— groups in the alkylene group may be substituted with —O—, —COO—, —OCO—, —CH═CH—, or —C≡C—, p^{c1} is 1 or 2, and pluralities of Sp^{a16}s, Sp^{a17}s, and A^{a13}s, if present, may be the same or different Sp^{a16}s, Sp^{a17}s, and A^{a13}s, respectively.)

The lower limit of the total amount of compounds represented by the general formula (I) in a liquid crystal composition according to the present invention is preferably 0.01% or more, preferably 0.02% or more, preferably 0.03% or more, preferably 0.05% or more, preferably 0.07% or more, preferably 0.1% or more, preferably 0.15% or more, preferably 0.2% or more, preferably 0.25% or more, preferably 0.3% or more, preferably 0.5% or more, preferably 1% or more. The upper limit is preferably 5% or less, preferably 3% or less, preferably 1% or less, preferably 0.5% or less, preferably 0.45% or less, preferably 0.4% or less, preferably 0.35% or less, preferably 0.3% or less, preferably 0.25% or less, preferably 0.21 or less, preferably 0.15% or less, preferably 0.1% or less, preferably 0.07% or less, preferably 0.05.% or less, preferably 0.03% or less. Furthermore, 0.01% to 1% by mass, 0.05% to 0.5% by mass, 0.10% to 0.3% by mass, and 0.15% to 0.25% are preferred in order to reduce nonuniformity in the device.

More specifically, 0.01% to 5% by mass is preferred, 0.01% to 0.3% by mass is preferred, 0.02% to 0.3% by mass is more preferred, and 0.05% to 0.25% by mass is particularly preferred. Still more specifically, when a reduction in precipitation at low temperatures is regarded as important, the content preferably ranges from 0.01% to 0.1% by mass.

A liquid crystal composition according to the present invention preferably contains one or two or more compounds represented by the general formula (II).

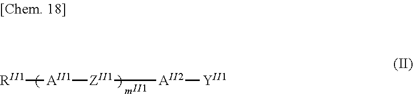

(In the formula, R^{II1} denotes an alkyl group having 1 to 10 carbon atoms, and one —CH₂— or two or more nonadjacent —CH₂— groups in the alkyl group may be independently substituted with —CH═CH—, —C≡C—, —O—, —CO—, —COO—, or —OCO—,

A^{II1} and A¹¹² independently denote a group selected from the group consisting of

(a) a 1,4-cyclohexyiene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═),

the groups (a), (b), and (c) may be independently substituted with a cyano group, a fluorine atom, or a chlorine atom,

Z^{II1} denotes a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,

Y^{II1} denotes a hydrogen atom, a fluorine atom, a chlorine atom, a cyano group, or an alkyl group having 1 to 10 carbon atoms, one —CH₂— or two or more nonadjacent —CH₂— groups in the alkyl group may be independently substituted with —CH═CH—, —C≡C—, —O—, —CO—, —COO—, or —OCO—, and one or two or more hydrogen atoms in the alkyl group may be substituted with a fluorine atom, and

m^{II1} is 1, 2, 3, or 4, and if m^{II1} is 2, 3, or 4, pluralities of A^{II1}s and Z^{II1}s may be the same or different A^{II1}s and Z^{II1}s, respectively.)

### First Embodiment of Compound Represented by General Formula (II)

A compound represented by the general formula (II) is a so-called p-type liquid crystal compound with positive dielectric constant anisotropy and may be a compound represented by the following general formula (J).

A compound represented by the general formula (II) preferably contains one or two or more compounds represented by the general formula (J). These compounds correspond to dielectrically positive compounds (with Δε of more than 2).

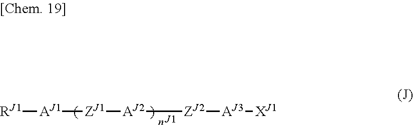

(In the formula, R^{J1} denotes an alkyl group having 1 to 8 carbon atoms, and one —CH₂— or two or more nonadjacent —CH₂— groups in the alkyl group may be independently substituted with —CH═CH—, —C≡C—, —O—, —CO—, —COO—, or —OCO—,

n^{J1} is 0, 1, 2, 3, or 4,

A^{J1}, A^{J2}, and A^{J3} independently denote a group selected from the group consisting of

(a) a 1,4-cyclohexylene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═),

the groups (a), (b), and (c) may be independently substituted with a cyano group, a fluorine atom, a chlorine atom, a methyl group, a trifluoromethyl group, or a trifluoromethoxy group,

Z^{J1} and Z^{J2} independently denote a single bond, —CH₂CH₂—, —(CH₂)₄—, —OCH₂—, —CH₂O—, —OCF₂—, —CF₂O—, —COO—, —OCO—, or —C≡C—,

if n^{J1} is 2, 3, or 4, a plurality of A^{J2}s may be the same or different A^{J2}s, and if n^{J1} is 2, 3, or 4, a plurality of Z^{J1}s may be the same or different Z^{J1}s, and

X^{J1} denotes a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.)

In the general formula (J), R^{J1} preferably denotes an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, more preferably an alkyl group having 1 to 5 carbon atoms or an alkenyl group having 2 to 5 carbon atoms, still more preferably an alkyl group having 2 to 5 carbon atoms or an alkenyl group having 2 or 3 carbon atoms, particularly preferably an alkenyl group having 3 carbon atoms (a propenyl group).

R^{J1} is preferably an alkyl group when reliability is regarded as important or an alkenyl group when reduced viscosity is regarded as important.

When, the ring structure to which it is bonded is a phenyl group (aromatic), a linear alkyl group having 1 to 5 carbon atoms, a linear alkoxy group having 1 to 4 carbon atoms, or an alkenyl group having 4 or 5 carbon atoms is preferred. When the ring structure to which it is bonded is a saturated ring structure, such as cyclohexane, pyran, or dioxane, a linear alkyl group having 1 to 5 carbon atoms, a linear alkoxy group having 1 to 4 carbon atoms, or a linear alkenyl group having 2 to 5 carbon atoms is preferred. In order to stabilize the nematic phase, the total number of carbon atoms and, if present, oxygen atoms is preferably 5 or less, and a straight chain is preferred.

The alkenyl group is preferably selected from the groups represented by the formulae (R1) to (R5). (The dark dot in each formula denotes a carbon atom in the ring structure to which the alkenyl group is bonded.)

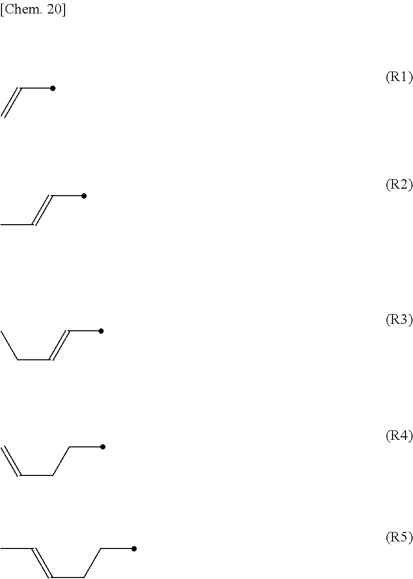

A^{J1}, A^{J2}, and A^{J3} preferably independently denote an aromatic when an increased Δn is required, denote an aliphatic to improve the response time, or denote a trans-1,4-cyclohexylene group, a 1,4-phenylene group, a 1,4-cyclohexenylene group, a 1,4-bicyclo[2.2.2 ]octylene group, a piperidine-1,4-diyl group, a naphthalene-2,6-diyl group, a decahydronaphthalene-2,6-diyl group, or a 1,2,3,4-tetrahydronaphthalene-2,6-diyl group, they optionally being substituted with a fluorine atom, and more preferably independently denote the following structures,

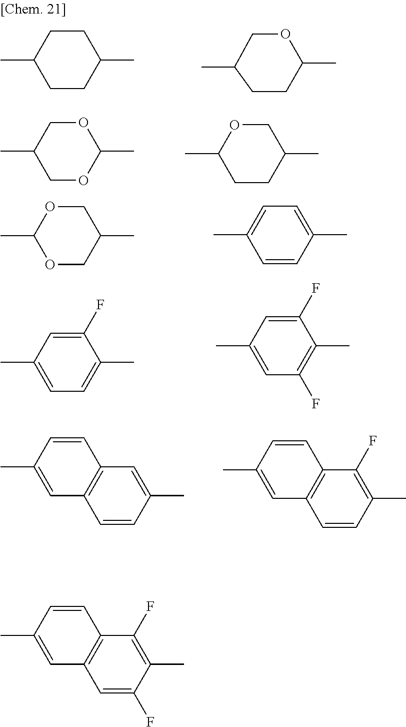

still more preferably the following structures.

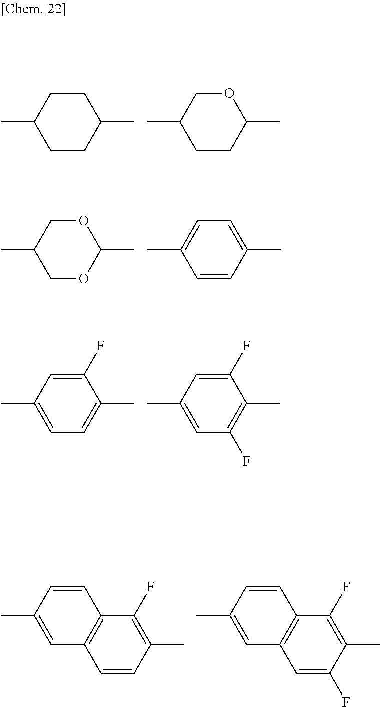

Z^{J1} and Z^{J2} preferably independently denote —CH₂O—, —OCH₂—, —CF₂O—, —CH₂CH₂—, —CF₂CF₂—, or a single bond, more preferably −OCH₂—, —CF₂O—, —CH₂CH₂—, or a single bond, particularly preferably −OCH₂—, —CF₂—, or a single bond.

X^{J1} preferably denotes a fluorine atom or a trifluoromethoxy group, preferably a fluorine atom.

n^{J1} is preferably 0, 1, 2, or 3, preferably 0, 1, or 2, preferably 0 or 1 when improved Δε is regarded as important, preferably 1 or 2 when Tni is regarded as important.

Although compounds of any types may be: combined, these compounds are combined in a manner that depends on the desired characteristics, such as solubility at low temperatures, transition temperature, electrical reliability. and birefringence index. For example, one, two, or three compounds are used in one embodiment of the present invention. Alternatively, four, five, six, or seven, compounds are used in another embodiment of the present invention.

The amount of compound represented by the general formula (J) in a composition according to the present invention should be appropriately adjusted in a manner that depends on the desired characteristics, such as solubility at low temperatures, transition temperature, electrical reliability, birefringence index, process compatibility, drop marks, image sticking, and/or dielectric constant anisotropy.

The lower limit of the preferred amount of compound represented by the general formula (J) is 1%, 10%, 20%, 30%, 40%, 50%, 55%, 60%, 65%, 70%, 75%, or 80% of the total amount of composition according to the present invention. For example, in one embodiment of the present invention, the upper limit of the preferred amount is 95%, 85%, 75%, 65%, 55%, 45%, 35%, or 25% of the total amount of composition according to the present invention.

When a composition according to the present invention with a low viscosity and a high-speed response time is required, the lower limit is preferably decreased, and the upper limit is preferably decreased. When a composition according to the present invention with a high Tni and high temperature stability is required, the lower limit is preferably decreased, and the upper limit is preferably decreased. When the dielectric constant anisotropy is increased to maintain a low drive voltage, the lower limit is preferably increased, and the upper limit is preferably increased.

R^{J1} is preferably an alkyl group when reliability is regarded as important or an alkenyl group when reduced viscosity is regarded as important.

A compound represented by the general formula (J) is preferably a compound represented by the general formula (M) or a compound represented by the general formula (K).

A composition according to the present invention preferably contains one or two or more compounds represented by the general formula (M). These compounds correspond to dielectrically positive compounds (with Δε of more than 2).

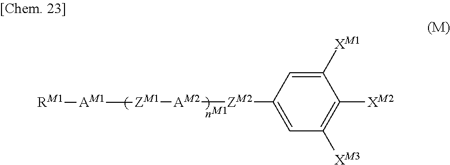

(In the formula, R^{M1} denotes an alkyl group having 1 to 8 carbon atoms, and one —CH₂— or two or more nonadjacent —CH₂— groups in the alkyl group may be independently substituted with —CH═CH—, —C≡C—, —O—, —CO—, —COO—, or —OCO—,

n^{M1} is 0, 1, 2, 3, or 4,

A^{M1} and A^{M2} independently denote a group selected from the group consisting of

(a) a 1,4-cyclohexylene group (in which one —CH₂— or two or more nonadjacent —CH₂— groups may be substituted with —O— or —S—), and

(b) a 1,4-phenylene group (in which one —CH═ or two or more nonadjacent —CH═ groups may be substituted with —N═),

a hydrogen atom of the group (a) and the group (b) may be independently substituted with a cyano group, a fluorine atom, or a chlorine atom,

Z^{M1} and Z^{M2} independently denote a single bond, —CH₂CH₂—, —(CH₂)₄—, —OCH₂—, —CH₂O—, —OCF₂—, —CF₂O—, —COO—, —OCO—, or —C≡C—,

if n^{M1} is 2, 3, or 4, a plurality of A^{M2}s may be the same or different A^{M2}s, and if n^{M1} is 2, 3, or 4, a plurality of Z^{M1}s may be the same or different Z^{M1}s,

X^{M1} and X^{M3} independently denote a hydrogen atom, a chlorine atom, or a fluorine atom, and

X^{M2} denotes a hydrogen atom, a fluorine atom, at chlorine atom, a cyano group, a trifluoromethyl group, a fluoromethoxy group, a difluoromethoxy group, a trifluoromethoxy group, or a 2,2,2-trifluoroethyl group.)

In the general formula (M), R^{M1} preferably denotes an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, more preferably an alkyl group having 1 to 5 carbon atoms or an alkenyl group having 2 to 5 carbon atoms, still more preferably an alkyl group having 2 to 5 carbon atoms or an alkenyl group having 2 or 3 carbon atoms, particularly preferably an alkenyl group having 3 carbon atoms (a propenyl group).

R^{M1} is preferably an alkyl group when reliability is regarded as important or an alkenyl group when reduced viscosity is regarded as important.

When the ring structure to which it is bonded is a phenyl group (aromatic), a linear alkyl group having 1 to 5 carbon atoms, a linear alkoxy group having. 1 to 4 carbon, atoms, or an alkenyl group having 4 or 5 carbon, atoms is preferred. When the ring structure to which it is bonded is a saturated ring structure, such as cyclohexane, pyran, or dioxane, a linear alkyl group having 1 to 5 carbon atoms, a linear alkoxy group having 1 to 4 carbon atoms, or a linear alkenyl group having 2 to 5 carbon atoms is preferred. In order to stabilize the nematic phase, the total number of carbon atoms and, if present, oxygen atoms is preferably 5 or less, and a straight chain is preferred.

The alkenyl group is preferably selected from the groups represented by the formulae (R1) to (R5). (The dark dot in each formula denotes a carbon atom in the ring structure to which the alkenyl group is bonded.)

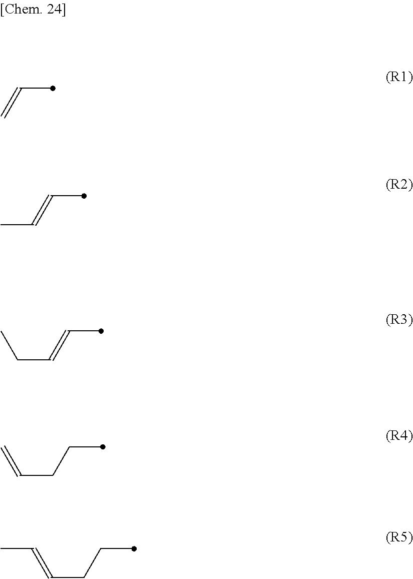

A^{M1} and A^{M2} preferably independently denote an aromatic when an increased Δn is required, denote an aliphatic to improve the response time, or denote a trans-1,4-cyclohexylene group, a 1,4-phenylene group, a 2-fluoro-1,4-phenylene group, a 3-fluoro-1,4-phenylene group, a 3,5-difluro-1,4-phenylene group, a 2,3-difluro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, more preferably the following structures,

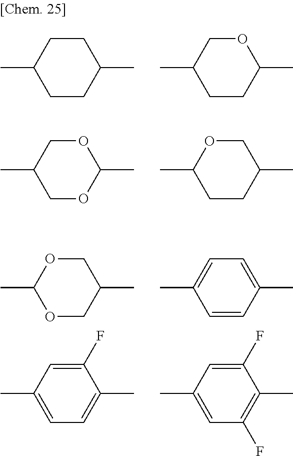

still more preferably the following structures.

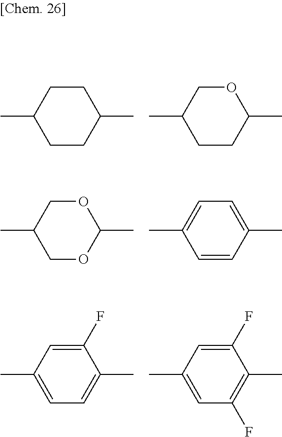

Z^{M1} and Z^{M2} preferably independently denote —CH₂O—, —CF₂O—, —CH₂CH₂—, —CF₂CF₂—, or a single bond, more preferably −CF₂O—, —CH₂CH₂—-, or a single bond, particularly preferably −CF₂O— or a single bond.

n^{M1} is preferably 0, 1, 2, or 3, preferably 0, 1, or 2, preferably 0 or 1 when improved Δε is regarded as important, preferably 1 or 2 when Tni is regarded as important.

Although compounds of any types may be combined, these compounds are combined in a manner that depends on the desired characteristics, such as solubility at low temperatures, transition temperature, electrical reliability, and birefringence index. For example, one, two, or three compounds are used in one embodiment of the present invention. Alternatively, four, five, six, or seven compounds are used in another embodiment of the present invention.

The amount of compound represented by the general formula (M) in a composition according to the present invention should be appropriately adjusted in a manner that depends on the desired characteristics, such as solubility at low temperatures, transition temperature, electrical reliability, birefringence index, process compatibility, drop marks, image sticking, and/or dielectric constant anisotropy.

The lower limit of the preferred amount of compound represented by the formula (M) is 0%, 1%, 10%, 20%, 30%, 40%, 50%, 55%, 60%, 65%, 70%, 75%, or 80% of the total amount of composition according to the present invention. For example, in one embodiment of the present invention, the upper limit of the preferred amount is 95%, 85%, 75%, 65%, 55%, 45%, 35%, or 25% of the total amount of composition according to the present invention.

When a composition according to the present invention with a low viscosity and a high-speed response time is required, the lower limit is preferably decreased, and the upper limit is preferably decreased. When a composition according to the present invention with a high Tni and high temperature stability is required, the lower limit is preferably decreased, and the upper limit is preferably decreased. When the dielectric constant anisotropy is increased to maintain a low drive voltage, the lower limit is preferably increased, and the upper limit is preferably increased.

More specifically, a liquid crystal compound represented by the general formula (M) is preferably

represented by the following general formula (M-1) or (M-2).

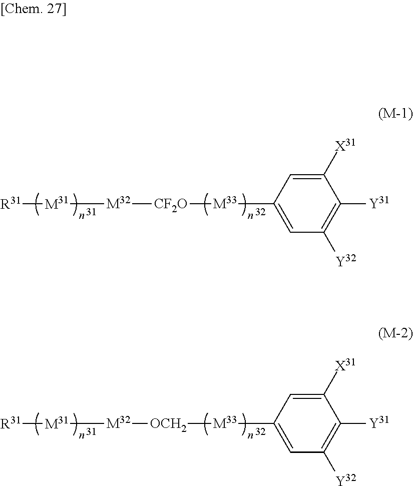

(In the formula, R³¹ denotes an alkyl group having 1 to 5 carbon atoms, an alkenyl group having 2 to 5 carbon atoms, or an alkoxy group having 1 to 4 carbon atoms, X^{J1} and X^{J2} independently denote a hydrogen atom or a fluorine atom, Y³¹ denotes a fluorine atom or OCF₃, M³¹ to M³³ independently denote a trans-1,4-cyclohexylene group or a 1,4-phenylene group, one or two —CH₂— groups in the trans-1,4-cyclohexylene group may be substituted with —O—, provided that oxygen atoms are not directly adjacent to each other, one or two hydrogen atoms in the phenylene group may be substituted with a fluorine atom, n³¹ and n³² are independently 0, 1, or 2, and n⁴¹+n⁴² is 1, 2, or 3.)

More specifically, liquid crystal compounds represented by the general formula (M-1) are preferably compounds represented by the following general formulae (M-1-a) to (M-1-f).

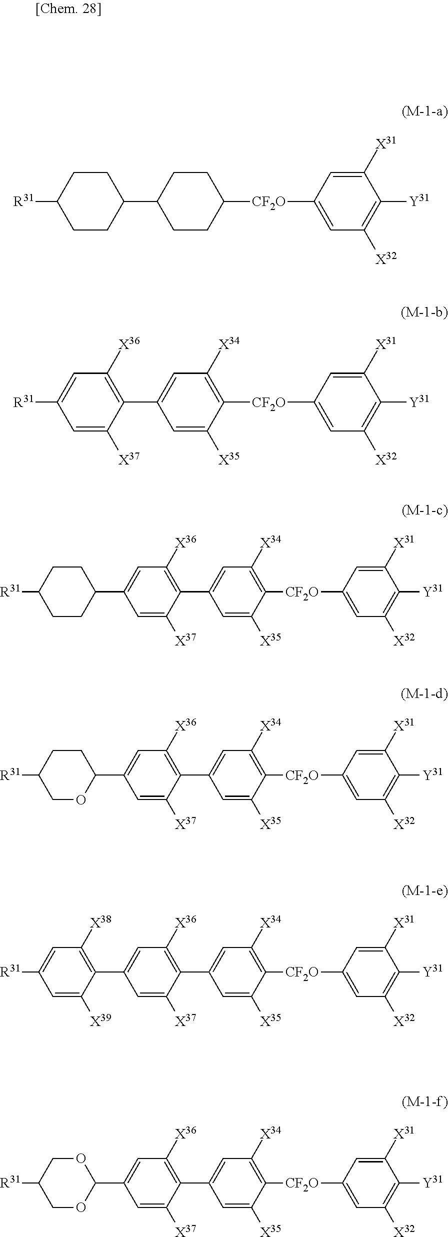

(In the formula, R³¹, X³¹, X³², and Y³¹ have the same meaning as R³¹, X³¹, X³², and Y³¹, respectively, in the general formula (M), and X³⁴ to X³⁹ independently denote a hydrogen atom or a fluorine atom.)

More specifically, liquid crystal compounds represented by the general formula (M-2) are preferably compounds represented by the following general formulae (M-2-a) to (M-2-n).

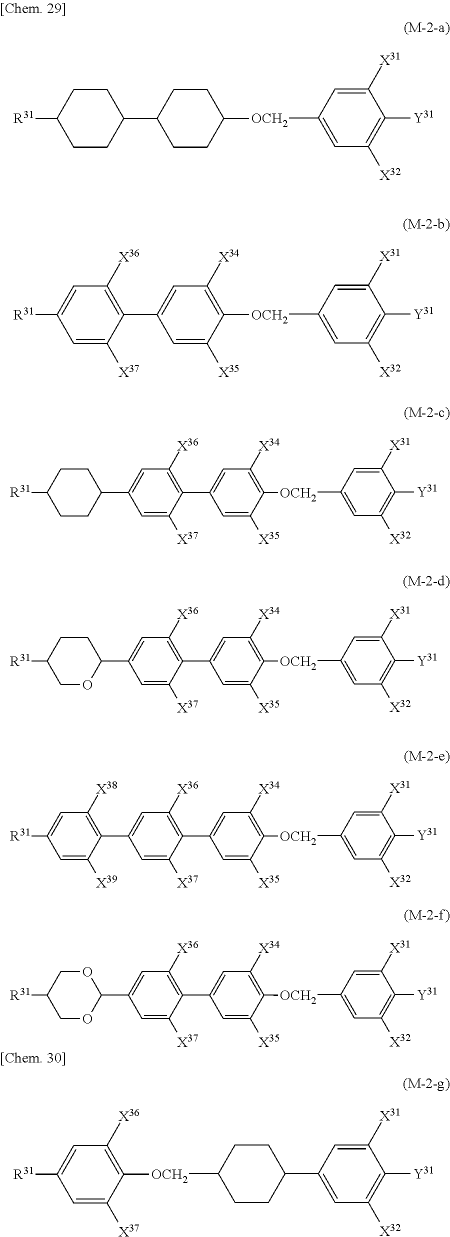

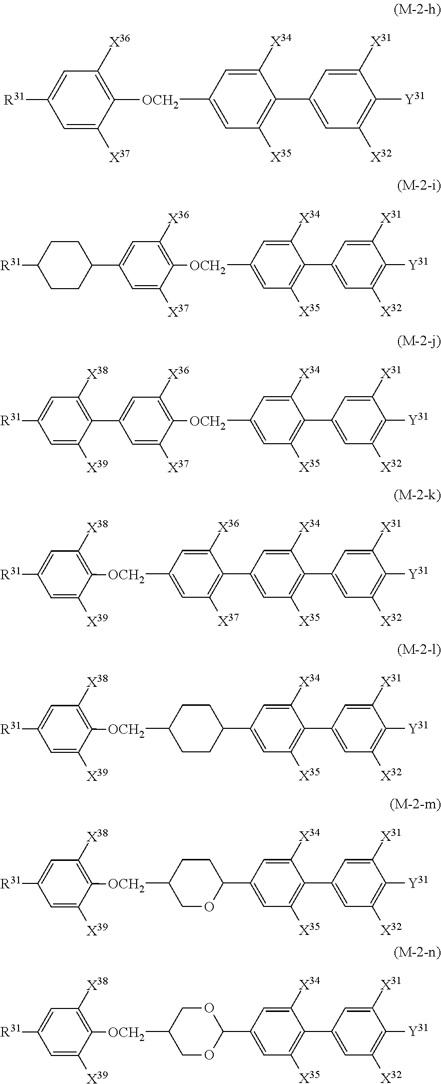

(In the formula, R³¹, X³¹, X³², and Y³¹ have the same meaning as R³¹, X³¹, X³², and Y³¹, respectively, in the general formula (M), and X³⁴ to X³⁹ independently denote a hydrogen atom or a fluorine atom.)

More specifically, liquid crystal compounds represented by the general formula (M) are preferably represented by the following general formulae (M-3) to (M-26).

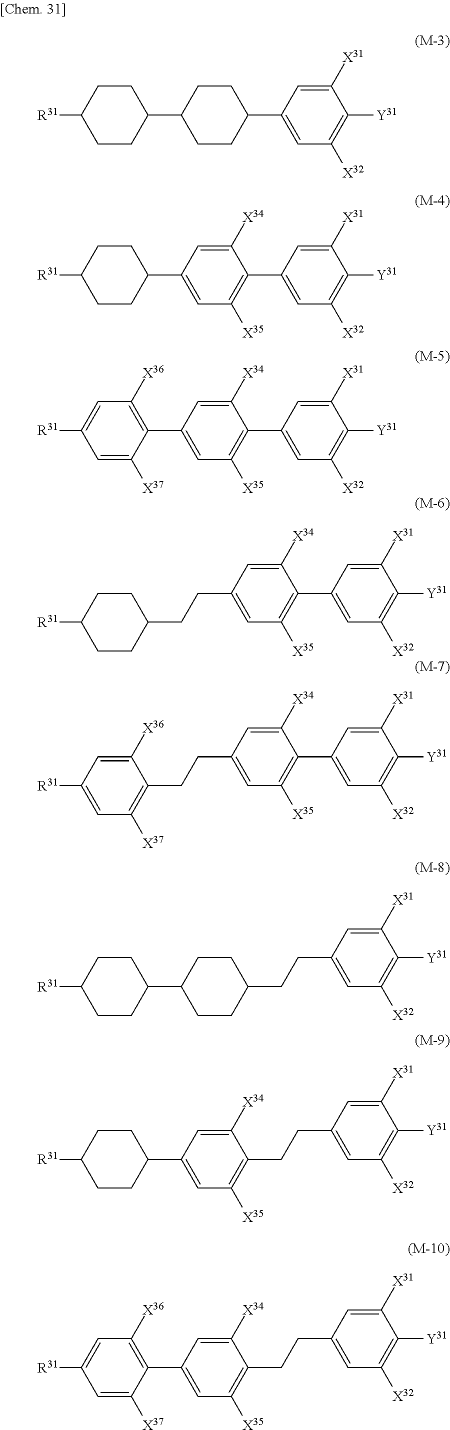

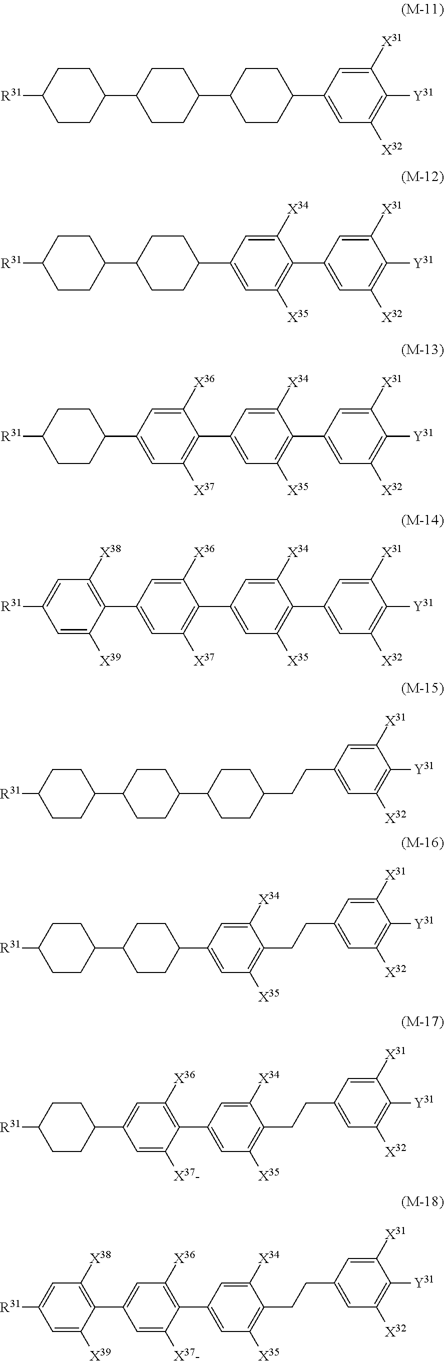

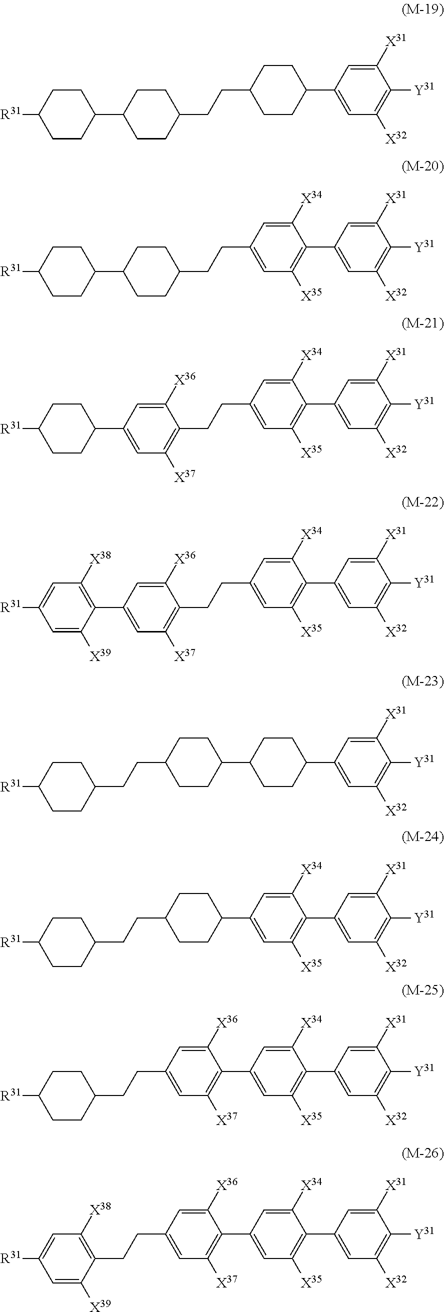

(In the formula, R³¹, X³¹, X³², and Y³¹ have the same meaning as R³¹, X³¹, X³², and Y³¹, respectively, in the general formula (M), and X³⁴ to X³⁹ independently denote a hydrogen atom or a fluorine atom.)

A composition according to the present invention preferably contains one or two or more compounds represented by the general formula (K). These compounds correspond to dielectrically positive compounds (with Δε of more than 2).

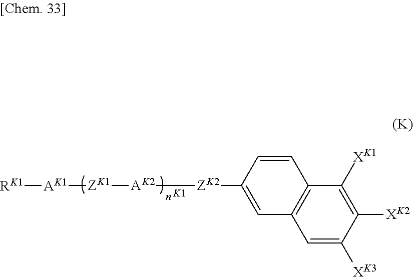

(In the formula, R^{K1} denotes an alkyl group having 1 to 8 carbon atoms, and one —CH₂— or two or more nonadjacent —CH₂— groups in the alkyl group may be independently substituted with —CH═CH—, —C≡C—, —O—, —CO—, —COO—, or —OCO—,

n^{K1} is 0, 1, 2, 3, or 4,

A^{K1} and A^{K2} independently denote a group selected from the group consisting of

(a) a 1,4-cyclohexylene group (in which one —CH₂— or two or more nonadjacent —CH₂— groups may be substituted with —O— or —S—), and

(b) a 1,4-phenylene group (in which one —CH═ or two or more nonadjacent —CH═ groups may be substituted with —N═),

a hydrogen atom of the group (a) and the group (b) may be independently substituted with a cyano group, a fluorine atom, or a chlorine atom,

Z^{K1} and Z^{K2} independently denote a single bond, —CH₂CH₂—, —(CH₂)₄—, —OCH₂—, —CH₂O—, —OCF₂—, —CF₂O—, —COO—, —OCO—, or —C≡C—,

if n^{K1} is 2, 3, or 4, a plurality of A^{K2}s may be the same or different A^{K2}s, and if n^{K1} is 2, 3, or 4, a plurality of Z^{K1}s may be the same or different Z^{K1}s,

X^{K1} and X^{K3} independently denote a hydrogen atom, a chlorine atom, or a fluorine atom, and

X^{K2} denotes a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.)

In the general formula (K), R^{K1} preferably denotes an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, more preferably an alkyl group having 1 to 5 carbon atoms or an alkenyl group having 2 to 5 carbon atoms, still more preferably an alkyl group having 2 to 5 carbon atoms or an alkenyl group having 2 or 3 carbon atoms, particularly preferably an alkenyl group having 3 carbon atoms (a propenyl group).

R^{K1} is preferably an alkyl group when reliability is regarded as important or an alkenyl group when reduced viscosity is regarded as important.

When the ring structure to which it is bonded is a phenyl group (aromatic), a linear alkyl group having 1 to 5 carbon atoms, a linear alkoxy group having 1 to 4 carbon atoms, or an alkenyl group having 4 or 5 carbon atoms is preferred. When the ring structure to which it is bonded is a saturated ring structure, such as cyclohexane, pyran, or dioxane, a linear alkyl group having 1 to 5 carbon atoms, a linear alkoxy group having 1 to 4 carbon atoms, or a linear alkenyl group having 2 to 5 carbon atoms is preferred. In order to stabilize the nematic phase, the total number of carbon atoms and, if present, oxygen atoms is preferably 5 or less, and a straight chain is preferred.

The alkenyl group is preferably selected from the groups represented by the formulae (R1) to (R5). (The dark dot in each formula denotes a carbon atom in the ring structure to which the alkenyl group is bonded.)

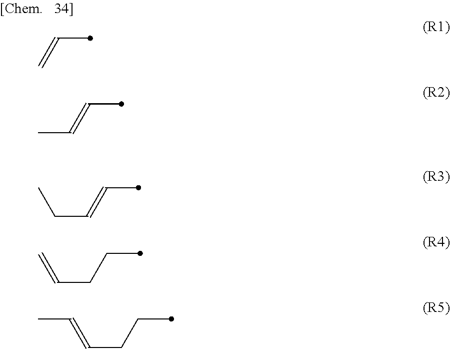

A^{K1} and A^{K2} preferably independently denote an aromatic when an increased Δn is required, denote an aliphatic to improve the response time, or denote a trans-1,4-cyclohexylene group, a 1,4-phenylene: group, a 2-fluoro-1,4-phenylene group, a 3-fluoro-1,4-phenylene group, a 3,5-difluro-1,4-phenylene group, a 2,3-difluro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, more preferably the following structures,

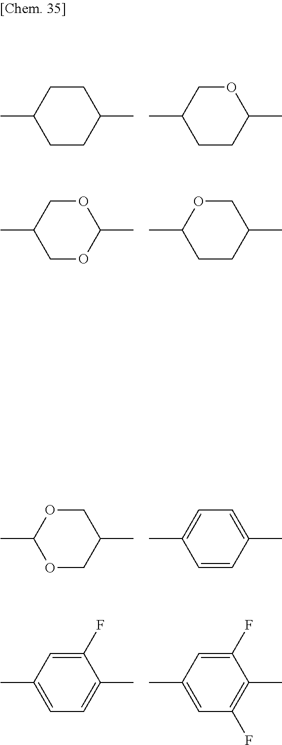

still more preferably the following structures.

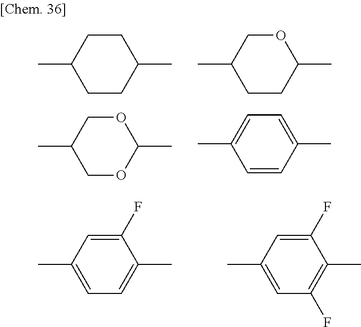

Z^{K1} and Z^{K2} preferably independently denote —CH₂O—, —CF₂O—, —CH₂CH₂—, —CF₂CF₂—, or a single bond, more preferably −CF₂O—, —CH₂CH₂—, or a single bond, particularly preferably −CF₂O— or a single bond.

n^{K1} is preferably 0, 1, 2, or 3, preferably 0, 1, or 2, preferably 0 or 1 when improved Δε is regarded as important, preferably 1 or 2 when Tni is regarded as important.

Although compounds of any types may be combined, these compounds are combined in a manner that depends on the desired characteristics, such as solubility at low temperatures, transition temperature, electrical reliability, and birefringence index. For example, one, two, or three compounds are used in one embodiment of the present invention. Alternatively, four, five, six, or seven compounds are used in another embodiment of the present invention.

The amount of compound represented by the general formula (K) in a composition according to the present invention should be appropriately adjusted in a manner that depends on the desired characteristics, such as solubility at low temperatures, transition temperature, electrical reliability, birefringence index, process compatibility, drop marks, image sticking, and/or dielectric constant anisotropy.

The lower limit of the preferred amount of compound represented by the formula (K) is 1%, 10%, 20%, 30%, 40%, 50%, 55%, 60%, 65%, 70%, 75%, or 80% of the total amount of composition according to the present invention. For example, in one embodiment of the present invention, the upper limit of the preferred amount is 95%, 85%, 75%, 65%, 55%, 45%, 35%, or 25% of the total amount of composition according to the present invention.

When a composition according to the present invention with a low viscosity and a high-speed response time is required, the lower limit is preferably decreased, and the upper limit is preferably decreased. When a composition according to the present invention with a high Tni and high temperature stability is required, the lower limit is preferably decreased, and the upper limit is preferably decreased. When the dielectric constant anisotropy is increased to maintain a low drive voltage, the lower limit is preferably increased, and the upper limit is preferably increased.

More specifically, a liquid crystal compound represented by the general formula (K) is preferably represented by the following general formula (K-1) or (K-2).

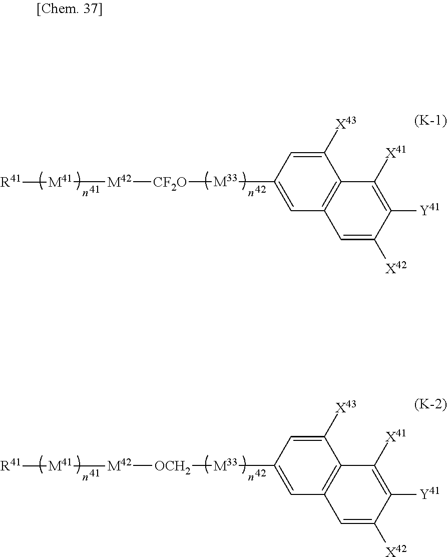

(In the formula, R⁴¹ denotes an alkyl group having 1 to 5 carbon atoms, an alkenyl group having 2 to 5 carbon atoms, or an alkoxy group having 1 to 4 carbon atoms, X⁴¹ and X⁴² independently denote a hydrogen atom or a fluorine atom, Y⁴¹ denotes a fluorine atom or OCF₃, M⁴¹ to M⁴³ independently denote a trans-1,4-cyclohexylene group or a 1,4-phenylene group, one or two —CH₂— groups in the trans-1,4-cyclohexylene group may be substituted with —O—, provided that oxygen atoms are not directly adjacent to each other, one or two hydrogen atoms in the phenylene group may be substituted with a fluorine atom, n⁴¹ and n⁴² are independently 0, 1, or 2, and n⁴¹+n⁴² is 1, 2, or 3.)

More specifically, liquid crystal compounds represented by the general formula (K-1) are preferably compounds represented by the following general formulae (K-1-a) to (K-1-d).

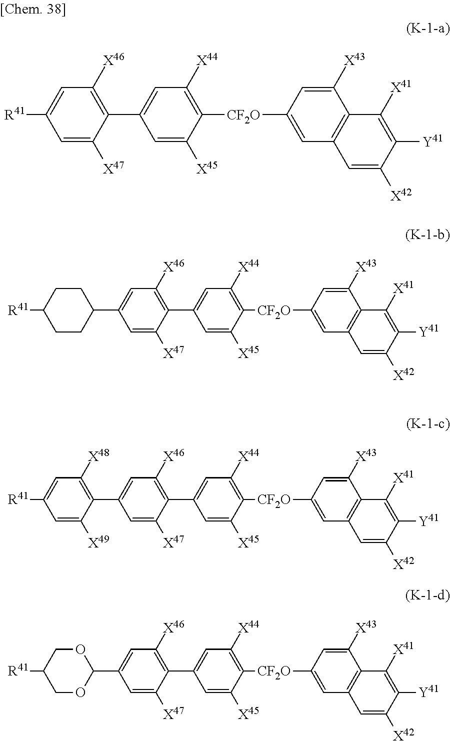

(In the formula, R⁴¹, X⁴¹, X⁴², and Y⁴¹ have the same meaning as R⁴¹, X⁴¹, X⁴², and Y⁴¹, respectively, in the general formula (K), and X⁴⁴ to X⁴⁹ independently denote a hydrogen atom or a fluorine atom.)

More specifically, liquid crystal compounds represented by the general formula (K-2) are preferably compounds represented by the following general formulae (K-2-a) to (K-2-g).

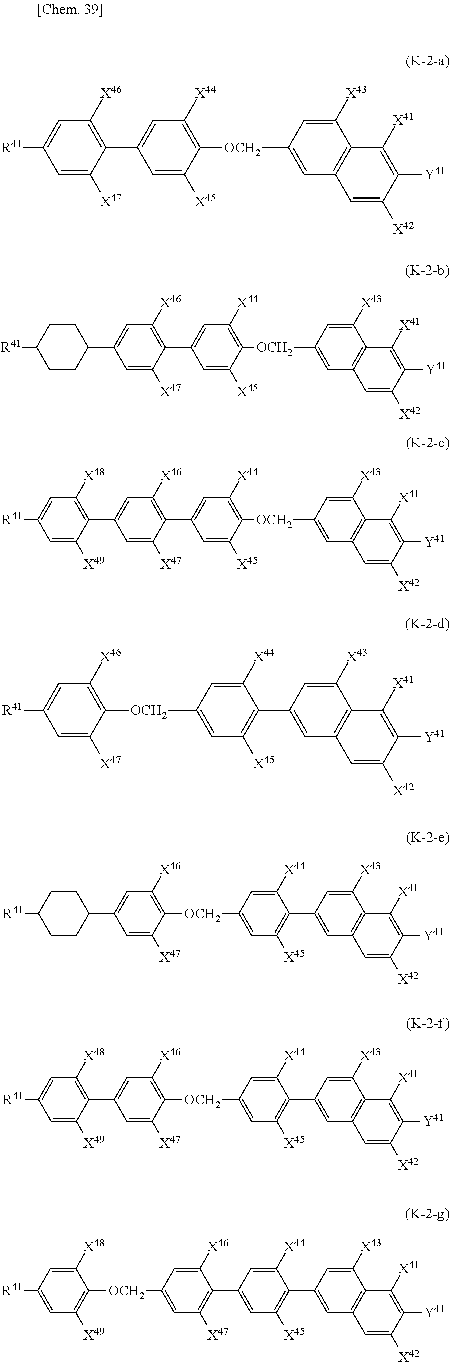

(In the formula, R⁴¹, X⁴¹, X⁴², and Y⁴¹ have the same meaning as R⁴¹, X⁴¹, X⁴², and Y⁴¹, respectively, in the general formula (K), and X⁴⁴ to X⁴⁹ independently denote a hydrogen atom or a fluorine atom.)

More specifically, liquid crystal compounds represented by the general formula (K) are preferably represented by the following general formulae (K-3) to (K-5).

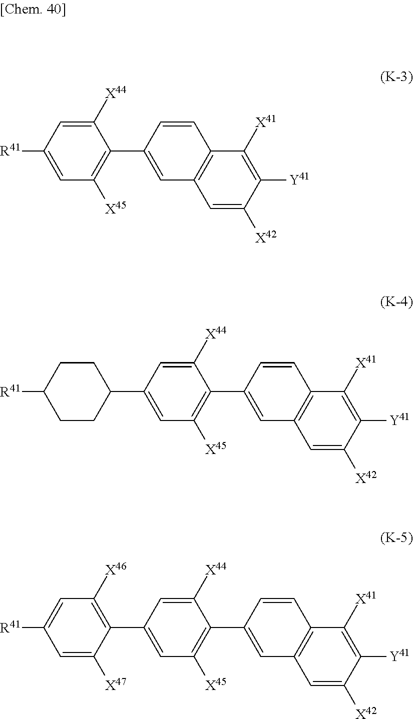

(In the formula, R⁴¹, X⁴¹, X⁴², and Y⁴¹ have the same meaning as R⁴¹, X⁴¹, X⁴², and Y⁴¹, respectively, in the general formula (K), and X⁴⁴ to X⁴⁹ independently denote a hydrogen atom or a fluorine atom.)

### Second Embodiment of Compound Represented by General Formula (II)

A compound represented by the general formula (II) is a so-called n-type liquid crystal compound with negative dielectric constant anisotropy and may be a compound represented by the following general formula (LC1) or (LC2).

A compound represented by the general formula (II) preferably contains one or two or more compounds selected from the compound group represented by the general formulae (N-1) to (N-3).

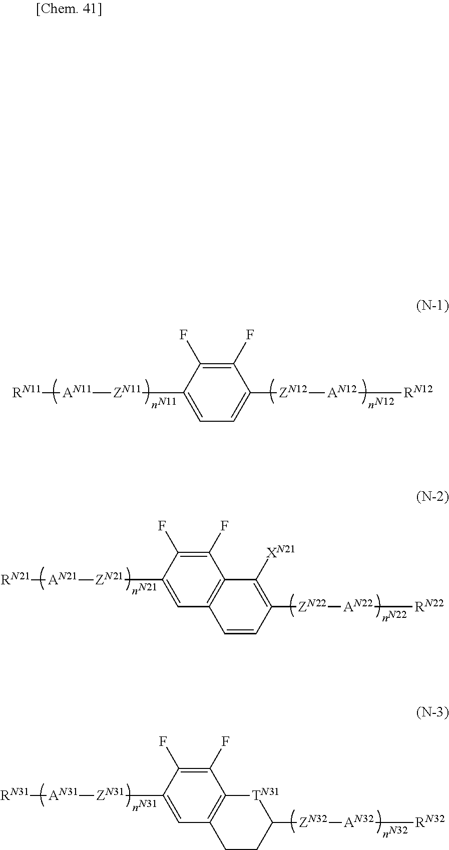

(In the formula, R^{N11}, R^{N12}, R^{N21}, R^{N22}, R^{N31}, and R^{N32} independently denote an alkyl group having 1 to 8 carbon atoms, and one —CH₂— or two or more nonadjacent —CH₂— groups in the alkyl group may be independently substituted with —CH═CH—, —C≡C—, —O—, —CO—, —COO—, or —OCO—,

A^{N11}, A^{N12}, A^{N21}, A^{N22}, A^{N31} and A^{N32} independently denote a group selected from, the group consisting of

(a) a 1,4-cyclohexylene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═),

the groups (a), (b), and (c) may be independently substituted with a cyano group, a fluorine atom, or a chlorine atom,

Z^{N11}, Z^{N12}, Z^{N21}, Z^{N22}, Z³¹, and Z^{N32} independently denote a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF-, or —C≡C—,

X^{N21} denotes a hydrogen atom or a fluorine atom,

T^{N31} denotes —CH₂— or an oxygen atom, and

n^{N11}, n^{N12}, n^{N21}, n^{N22}, n^{N31}, and n^{N32} independently denote an integer in the range of 0 to 3, n^{N11}+N^{N12}, n^{N21}+n^{N22}, and n^{N31}+n^{N32} are independently 1, 2, or 3, and pluralities of A^{N11}s to A^{N32}s and Z^{N11}s to Z^{N32}s, if present, may be the same or different A^{N11}s to A^{N32}s and Z^{N11}s to Z^{N32}s, respectively, provided that the compounds represented by the general formula (N-1) are excluded from the compounds represented by the general formulae (N-2) and (N-3) and that the compounds represented by the general formula (N-2) are excluded from the compounds represented by the general formula (N-3).)

The compounds represented by the general formulae (N-1), (N-2), and (N-3) correspond to dielectrically negative compounds (with a negative Δε having an absolute value of more than 2), preferably compounds with a negative Δε having an absolute value of more than 3.

In the general formulae (N-1), (N-2), and (N-3), R^{N11}, R^{N12}, R^{N21}, R^{N22}, R^{N31}, and R^{N32} independently denote an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, more preferably an alkyl group having 1 to 5 carbon atoms or an alkenyl group having 2 to 5 carbon atoms, still more preferably an alkyl group having 2 to 5 carbon atoms or an alkenyl group having 2 or 3 carbon atoms, particularly preferably an alkenyl group having 3 carbon atoms (a propenyl group). In particular, an compound in which at least one of R^{N11} and R^{N12} denotes an alkenyl group and a compound represented by the general formula (I) can be used in combination to significantly reduce a decrease in voltage holding ratio (VHR). Likewise, a compound in which at least one of R^{N21} and R^{N22} denotes an alkenyl group and a compound represented by the general formula (I) can be used in combination to significantly reduce a decrease in voltage holding ratio (VHR), and a compound in which at least one of R^{N31} and R^{N32} denotes an alkenyl group and a compound represented by the general formula (I) can be used in combination to significantly reduce a decrease in voltage holding ratio (VHR).

When the ring structure to which it is bonded is a phenyl group (aromatic), a linear alkyl group having 1 to 5 carbon atoms, a linear alkoxy group having 1 to 4 carbon atoms, or an alkenyl group having 4 or 5 carbon atoms is preferred. When the ring structure to which it is bonded is a saturated ring structure, such as cyclohexane, pyran, or dioxane, a linear alkyl group having 1 to 5 carbon atoms, a linear alkoxy group having 1 to 4 carbon atoms, or a linear alkenyl group having 2 to 5 carbon atoms is preferred. In order to stabilize the nematic phase, the total number of carbon atoms and, if present, oxygen atoms is preferably 5 or less, and a straight chain is preferred.

The alkenyl group is preferably selected from the groups represented by the formulae (R1) to (R5). (The dark dot in each formula denotes a carbon atom in the ring structure.)

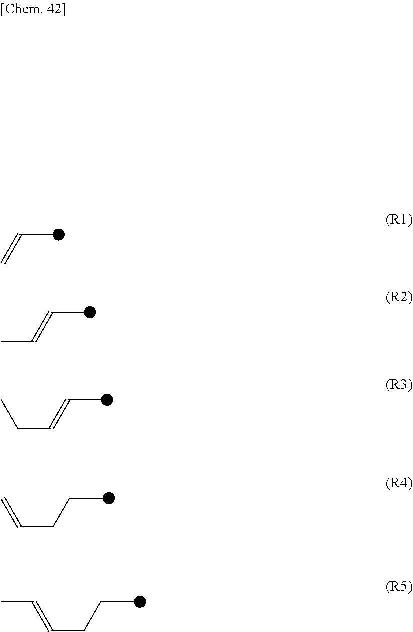

A^{N11}, A^{N12}, A^{N21}, A^{N22}, A^{N31}, and A^{N32} preferably independently denote an aromatic when an increased Δn is required, denote an aliphatic to improve the response time, or denote a trans-1,4-cyclohexylene group, a 1,4-phenylene group, a 2-fluoro-1,4-phenylene group, a 3-fluoro-1,4-phenylene group, a 3,5-difluro-1,4-phenylene group, a 2,3-difluro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, more preferably the following structures,

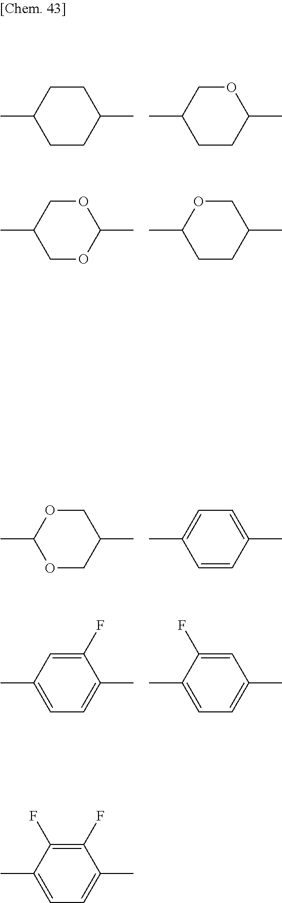

still more preferably a trans-1,4-cyclohexylene group or a 1,4-phenylene group.

Z^{N11}, Z^{N12}, Z^{N21}, Z^{N22}, Z^{N31}, and Z^{N32} preferably independently denote —CH₂O—, —CF₂O—, —CH₂CH₂—, —CF₂CF₂—, or a single bond, more preferably −CH₂O—, —CH₂CH₂—, or a single bond, particularly preferably −CH₂O— or a single bond.

X^{N21} preferably denotes a fluorine atom.

T^{N31} preferably denotes an oxygen atom.

n^{N11}+n^{N12}, n²¹+n^{N22}, and n^{N31}+n^{N32} are preferably 1 or 2, and a combination of n^{N11} of 1 and n^{N12} of 0, a combination of n^{N11} of 2 and n^{N12} of 0, a combination of n^{N11} of 1 and n^{N12} of 1, a combination of n^{N11} of 2 and n^{N12} of 1, a combination of n^{N21} of 1 and n^{N22} of 0, a combination of n^{N21} of 2 and n^{N22} of 0, a combination of n^{N31} of 1 and n^{N32} of 0, and a combination, of n³¹ of 2 and n^{N32} of 0 are preferred.

The lower limit of the preferred amount of compound represented by the formula (N-1) is 0%, 1%, 10%, 20%, 30%, 40%, 50%, 55%, 60%, 65%, 70%, 75%, or 80% of the total amount of composition according to the present invention. The upper limit of the preferred amount is 95%, 85%, 75%, 65%, 55%, 45%, 35%, 25%, or 20%.

The lower limit of the preferred amount of compound represented by the formula (N-2) is 0%, 1%, 10%, 20%, 30%, 40%, 50%, 55%, 60%, 65%, 70%, 75%, or 80% of the total amount of composition according to the present invention. The upper limit of the preferred amount is 95%, 85%, 75%, 65%, 55%, 45%, 35%, 25%, or 20%.

The lower limit of the preferred amount of compound represented by the formula (N-3) is 0%, 1%, 10%, 20%, 30%, 40%, 50%, 55%, 60%, 65%, 70%, 75%, or 80% of the total amount of composition according to the present invention. The upper limit of the preferred amount is 95%, 85%, 75%, 65%, 55%, 45%, 35%, 25%, or 20%.

When a composition according to the present invention with a low viscosity and a high-speed response time is required, the lower limit is preferably low, and the upper limit is preferably low. When a composition according to the present invention with a high Tni and high temperature stability is required, the lower limit is preferably low, and the upper limit is preferably low. When the dielectric constant anisotropy is increased to maintain a low drive voltage, the lower limit is preferably high, and the upper limit is preferably high.

A liquid crystal composition according to the present invention preferably contains as the general formula (N-1) one or two or more compounds represented by the general formula (i-I).

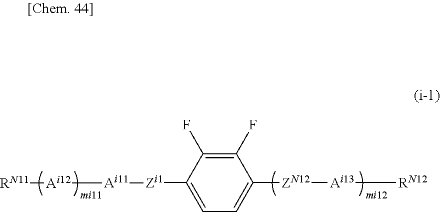

(In the formula, Aⁱ¹¹, Aⁱ¹², and Aⁱ¹³ independently denote a 1,4-cyclohexylene group or a 1,4-phenylene group, one —CH₂— or two or more nonadjacent —CH₂— groups in the 1,4-cyclohexylene group may be substituted with —O— or —S—, one hydrogen atom in the 1,4-phenylene group may be independently substituted with a fluorine atom or a chlorine atom, Zⁱ¹ denotes —OCH₂—, —CH₂O—, —CF₂O—, —OCF₂—, —CH₂CH₂—, or —CF₂CF₂—, mⁱ¹¹ and mⁱ¹² are independently 0 or 1, and R^{N11}, R^{N12}, and Z^{N12} have the same meaning as R^{N11}, R^{N12}, and Z^{N12}, respectively, in the general formula (N-1).)

A compound represented by the general formula (i-1) is preferably a compound represented by the general formula (i-1A), (i-1B), or (i-1C).

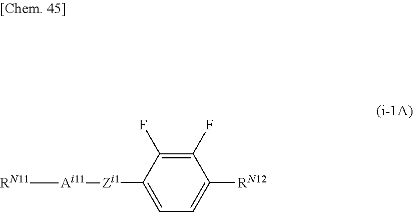

(In the formula, R^{N11}, R^{N12}, Aⁱ¹¹, and Zⁱ¹ have the same meaning as R^{N11}, R^{N12}, Aⁱ¹¹, and Zⁱ¹, respectively, in the general formula (i-1).)

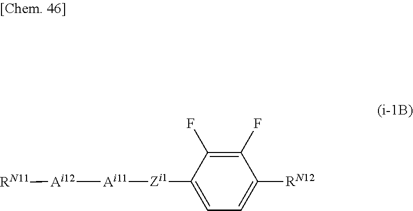

(In the formula, R^{N11}, R^{N12}, Aⁱ¹¹, Aⁱ¹², and Zⁱ¹ have the same meaning as R^{N11}, R^{N11}, Aⁱ¹¹, Aⁱ¹², and Zⁱ¹, respectively, in the general formula (i-1).)

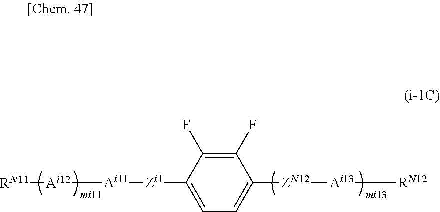

(In the formula, mⁱ¹³ is 1, R^{N11}, R^{N12}, Aⁱ¹¹, Aⁱ¹², Aⁱ¹³, Zⁱ¹, Zⁱ², and mⁱ¹¹ have the same meaning as R^{N11}, R^{N12}, Aⁱ¹¹, Aⁱ¹², Aⁱ¹³, Zⁱ¹, Zⁱ², and mⁱ¹¹, respectively, in the general formula (i-1).)

Compounds represented by the general formula (i-1A) are preferably compounds represented by the following general formulae (i-1A-1) to (i-1A-4).

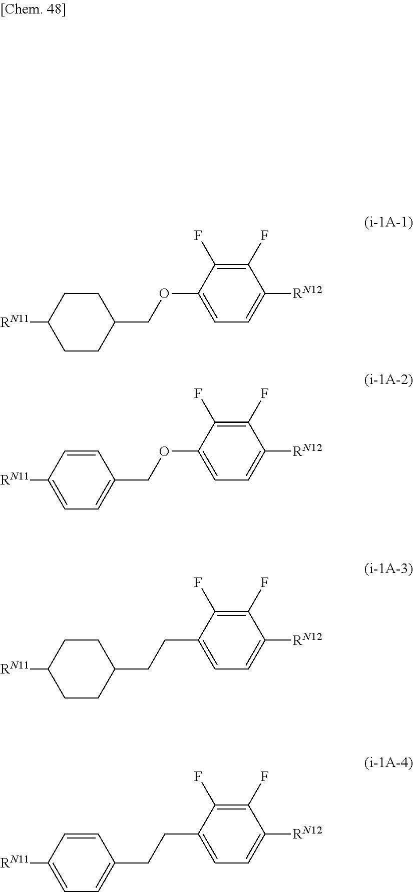

(In the formula, R^{N11} and R^{N12} have the same meaning as R^{N11} and R^{N12}, respectively, in the general formula (i-1).)

Compounds represented by the general formula (i-1B) are preferably compounds represented by the following general formulae (i-1B-1) to (i-1B-7).

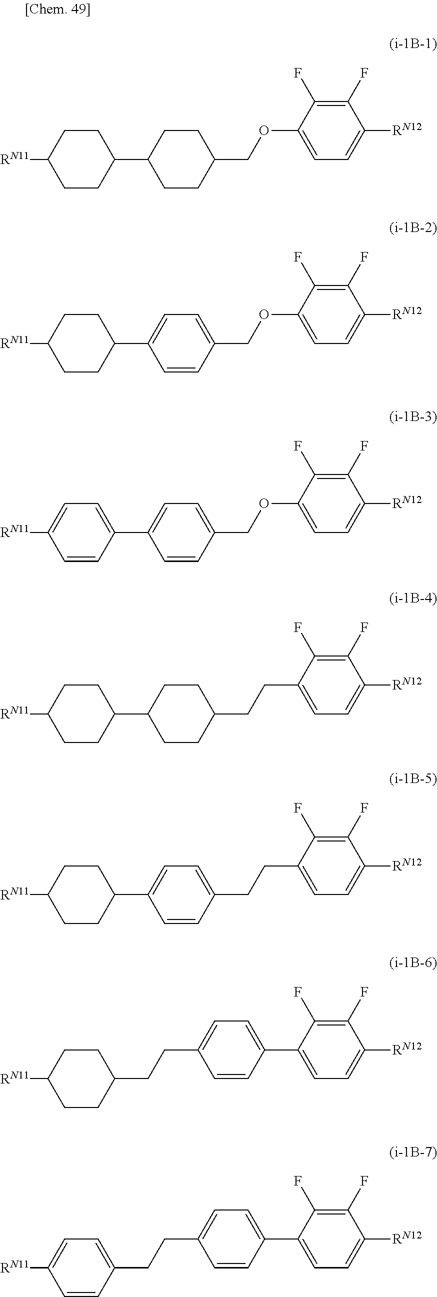

(In the formula, R^{N11} and R^{N122} have the same meaning as R^{N11} and R^{N12}, respectively, in the general formula (i-1).)

Compounds represented by the general formula (i-1C) are preferably compounds represented by the following general formulae (i-1C-1) to (i-1C-4), more preferably compounds represented by the general formulae (i-1C-1) and (i-1C-2).

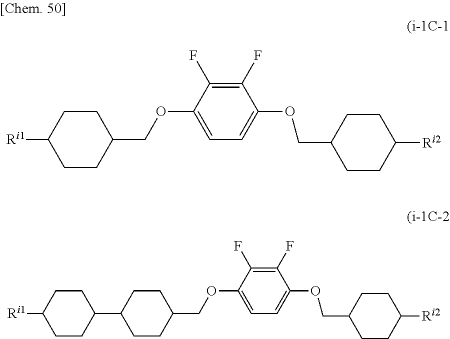

(In the formula, R^{N11} and R^{N122} have the same meaning as Ri1 and Ri2, respectively, in the general formula (i-1).)

A liquid crystal composition according to the present invention preferably contains one or two or more compounds represented by the general formula (i) and may contain one or two or more of compounds selected from the compound group represented by the general formula (i-1A), (i-1B), or (i-1C) or one or more compounds represented by each of the general formulae (i-1A), (i-1B), and (i-1C). One or two or more, more preferably two to ten, compounds represented by the general formula (i-1A) and/or the general formula (i-1B) are preferably contained.

More specifically, the general formulae (i-1A), (i-1B), and (i-1C) preferably include one or two or more compounds selected from the compound group represented by the general formulae (i-1A-1), (i-1B-1), and (i-1C-1) and are more preferably a combination of a compound represented by the general formula (i-1A-1) and a compound represented by the general formula (i-1B-1).

A liquid crystal composition according to the present invention preferably contains as the general formula (LC3) one or two or more compounds represented by the general formula (ii).

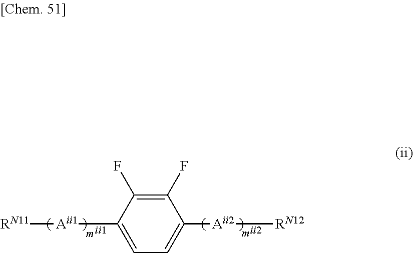

(In the formula, Aⁱⁱ¹ and Aⁱⁱ² independently denote a 1,4-cyclohexylene group or a 1,4-phenylene group, one —CH₂— or two or more nonadjacent —CH₂— groups in the 1,4-cyclohexylene group may be substituted with —O— or —S—, one hydrogen atom in the 1,4-phenylene group may be independently substituted with a fluorine atom or a chlorine atom, mⁱⁱ¹ and mⁱⁱ² are independently 1 or 2, and R^{N11} and R^{N12} have the same meaning as R^{N11} and R^{N12}, respectively, in the general formula (N-1).)

One or two or more compounds represented by the general formula (ii-1) are preferably contained as the general formula (ii-1).

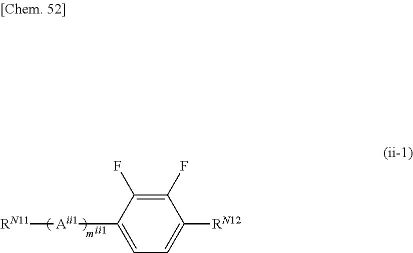

(In the formula, R^{N11}, R^{N12}, Aⁱⁱ¹, and mⁱⁱ¹ have the same meaning as R^{N11}, R^{N12}, Aⁱⁱ¹, and mⁱⁱ¹, respectively, in the general formula (ii).)

A compound represented by the general formula (ii-1) is preferably a compound represented by the general formula (II-2A) or (II-2B).

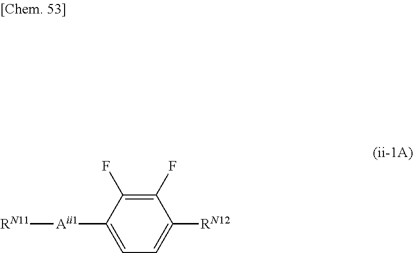

(In the formula, R^{N11}, R^{N12}, and Aⁱⁱ¹ have the same meaning as R^{N11}, R^{N12}, and Aⁱⁱ¹, respectively, in the general formula (ii).)

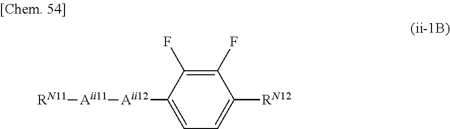

(In the formula, Aⁱⁱ¹¹ and Aⁱⁱ¹¹ independently denote a 1,4-cyclohexylene group or a 1,4-phenylene group, one —CH₂— or two or more nonadjacent —CH₂— groups in the 1,4-cyclohexylene group may be substituted with —O— or —S—, one hydrogen atom in the 1,4-phenylene group may be independently substituted with a fluorine atom or a chlorine atom, and R^{N11} and R^{N12} have the same meaning as R^{N11} and R^{N12}, respectively, in the general formula (ii).)

A compound represented by the general formula (ii-1A) is preferably a compound represented by the following general formula (ii-1A-1) or (ii-1A-2).

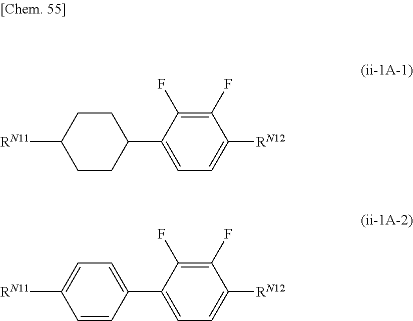

(In the formula, R^{N11} and R^{N12} have the same meaning as R^{N11} and R^{N12} in the general formula (ii).)

Compounds represented by the general formula (ii-1B) are preferably compounds represented by the following general, formulae (ii-1B-1) to (ii-1B-3).

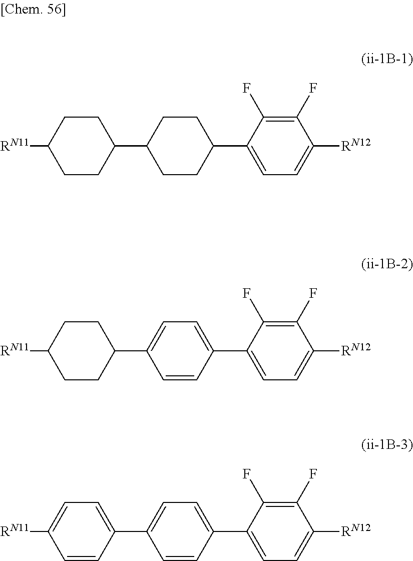

(In the formula, R^{N11} and R^{N12} have the same meaning as R^{N11} and R^{N12} in the general formula (ii).)

A liquid crystal composition according to the present invention preferably contains one or two or more compounds represented by the general formula (ii) and may contain one or two or more compounds selected from the compound group represented by the general formulae (ii-1A) and (ii-1B) or one or more compounds represented by each of the general formulae (ii-1A) and (ii-1B). Two to ten compounds represented by the general formulae (ii-1A) and (ii-1B) are preferably contained.

More specifically, the general formula (ii-1A) preferably contains one or two or more compounds selected from the compound group represented by the general formula (ii-1A-1), and the general formula (ii-1B) preferably contains one or two or more compounds selected from the compound group represented by the general formulae (ii-1B-1) and (ii-1B-2), and a combination of compounds represented by the general formulae (ii-1A-1) and (ii-1B-1) is more preferred.

One or two or more compounds represented by the following general formula (LC3-b) are preferably contained as the general formula (N-1).

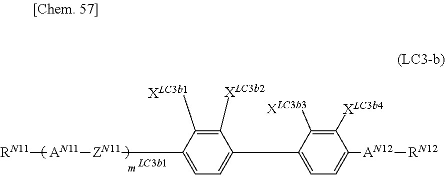

(In the formula, R^{N11}, R^{N12}, A^{N11}, A^{N12}, and Z^{N11} have the same meaning as R^{N11}, R^{N12}, A^{N11}, A^{N12}, and Z^{N11}, respectively, in the general formula (N-1), and X^{LC3b1} to X^{LC3b4} denote a hydrogen atom or a fluorine atom. X^{LC3b1} and X^{LC3b2} independently denote a fluorine atom, or X^{LC3b1} and X^{LC3b2} independently denote a fluorine atom, or X^{LC3b1} to X^{LC3b4} independently denote a fluorine atom. m^{LC3b1} is 0 or 1. The compounds represented by the general formulae (i-1) and (ii) are excluded from the compounds represented by the general formula (LC3-b).)

The general formula (LC3-b) preferably represents the following general formulae (LC3-b1) to (LC3-b10).

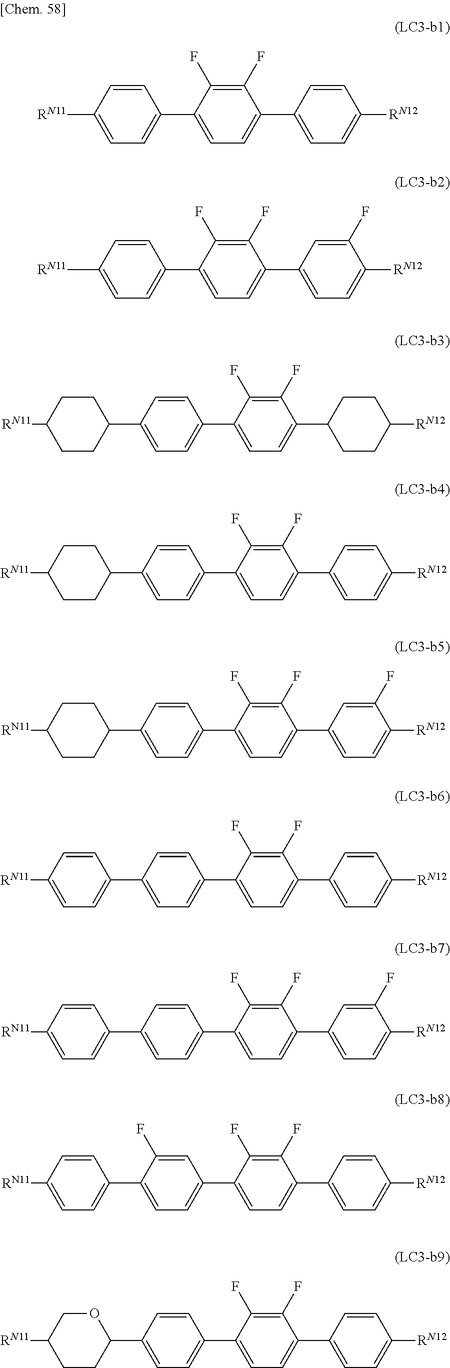

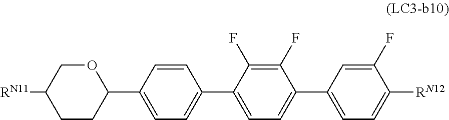

(In the formula, R^{N11} and R^{N12} have the same meaning as R^{N11} and R^{N12}, respectively, in the general formula (N-1).)

A combination of R^{N11} and R^{N12} is not particularly limited. Preferably, both R^{N11} and R^{N12} denote an alkyl group; both R^{N11} and R^{N12} denote an alkenyl group; one of R^{N11} and R^{N12} denotes an alkyl group, and the other denotes an alkenyl group; one of R^{N11} and R^{N12} denotes an alkyl group, and the other denotes an alkoxy; or one of R^{N11} and R^{N12} denotes an alkyl group, and the other denotes an alkenyloxy group. More preferably, both R^{N11} and R^{N12} denote an alkyl group, or both R^{N11} and R^{N12} denote an alkenyl group.

The general formula (LC3-b) preferably represents the following general formula (LC3-c).

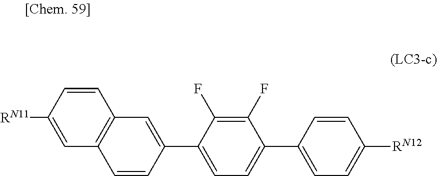

(In the formula, R^{N11} and R^{N12} have the same meaning as R^{N11} and R^{N12}, respectively, in the general formula (N-1).)

A compound represented by the general formula (N-2) is preferably a compound selected from the compound group represented by the general formulae (N-2-1) to (N-2-3).

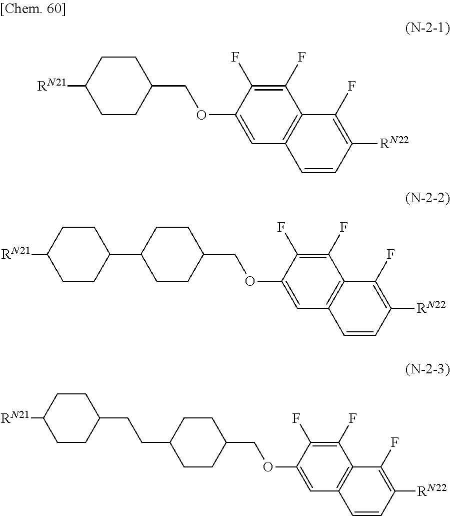

(In the formula, R^{N211} and R^{N22} have the same meaning as R^{N211} and R^{N22}, respectively, in the general formula (N-2).)

A compound represented by the general formula (N-3) is preferably a compound selected from the compound group represented by the general formulae (N-3-1) and (H-3-2).

A compound represented by the general formula (N-3-1) is the following compound.

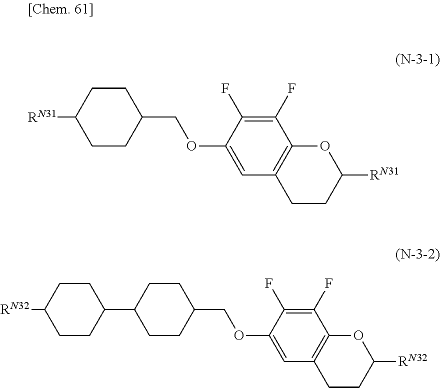

(In the formula, and R^{N31} and R^{N32} have the same meaning as R^{N31} and R^{N32}, respectively, in the general formula (N-3).)

### Third Embodiment of Compound Represented by General Formula (II)

A fourth component is a so-called nonpolar liquid crystal compound, which has a dielectric constant anisotropy of approximately 0, and may be a compound represented by the following general formula (L).

A composition according to the present invention preferably contains one or two or more compounds represented by the general formula (L). A compound represented by the general formula (L) corresponds to a dielectrically nearly neutral compound (with Δε in the range of −2 to 2).

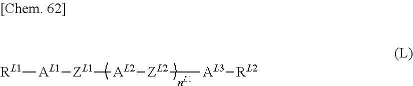

(In the formula, R^{L1} and R^{L2} independently denote an alkyl group having 1 to 8 carbon atoms, and one —CH₂— or two or more nonadjacent —CH₂— groups in the alkyl group may be independently substituted with —CH═CH—, —C≡C—, —O—, —CO—, —COO—, or —OCO—,

n^{L1} is 0, 1, 2, or 3,

A^{L1}, A^{L2}, and A^{L3} independently denote a group selected from the group consisting of

(a) a 1,4-cyclohexylene group (in which one —CH₂— or two or more nonadjacent —CH₂— groups may be substituted with —O—),

(b) a 1,4-phenylene group (in which one —CH═ or two or more nonadjacent —CH═ groups may be substituted with —N═), and

(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═),

the groups (a), (b), and (c) may be independently substituted with a cyano group, a fluorine atom, or a chlorine atom,

Z^{L1} and Z^{L2} independently denote a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—, and

if n^{L1} is 2 or 3, a plurality of A^{L2}s may be the same or different A^{L2}s, and if n^{L1} is 2 or 3, a plurality of Z^{L3}s may be the same or different Z^{L3}s. The compounds represented by the general formulae (J), (N-1), (N-2), and (N-3) are excluded.)

The compounds represented by the general formula (L) may be used alone or in combination. Although compounds of any types may be combined, these compounds are appropriately combined in a manner that depends on the desired characteristics, such as solubility at low temperatures, transition temperature, electrical reliability, and birefringence index. For example, one compound is used in one embodiment of the present invention. Two, three, four, five, six, seven, eight, nine, ten, or more compounds are used in another embodiment of the present invention.

The amount of compound represented by the general formula (L) in a composition according to the present invention should be appropriately adjusted in a manner that depends on the desired characteristics, such as solubility at low temperatures, transition temperature, electrical reliability, birefringence index, process compatibility, drop marks, image sticking, and dielectric constant anisotropy.

The lower limit of the preferred amount of compound represented by the formula (L) is 0%, 1%, 10%, 20%, 30%, 40%, 50%, 55%, 60%, 65%, 70%, 75%, or 80% of the total amount of composition according to the present invention. The upper limit of the preferred amount is 95%, 85%, 75%, 65%, 55%, 45%, 35%, or 25%.

When a composition according to the present invention with a low viscosity and a high-speed response time is required, the lower limit is preferably high, and the upper limit is preferably high. When a composition according to the present invention with a high Tni and high temperature stability is required, the lower limit is preferably high, and the upper limit is preferably high. When dielectric constant anisotropy is increased to maintain a low driving voltage, the lower limit is preferably low, and the upper limit is preferably low.

When reliability is regarded as important, both R^{L1} and R^{L2} preferably denote an alkyl group. When reduced volatility of the compound is regarded as important, both R^{L1} and R^{L2} preferably denote an alkoxy group. When reduced viscosity is regarded as important, at least one of R^{L1} and R^{L2} preferably denotes an alkenyl group.

When the ring structure to which R^{L1} and R^{L2} are bonded is a phenyl group (aromatic), R^{L1} and R^{L2} are preferably a linear alkyl group having 1 to 5 carbon atoms, a linear alkoxy group having 1 to 4 carbon atoms, or an alkenyl group having 4 or 5 carbon atoms. When the ring structure to which R^{L1} and R^{L2} are bonded is a saturated ring structure, such as cyclohexane, pyran, or dioxane, R^{L1} and R^{L2} are preferably a linear alkyl group having 1 to 5 carbon atoms, a linear alkoxy group having 1 to 4 carbon atoms, or a linear alkenyl group having 2 to 5 carbon atoms. In order to stabilise the nematic phase, the total number of carbon atoms and, if present, oxygen atoms is preferably 5 or less, and a straight chain is preferred.

The alkenyl group is preferably selected from the groups represented by the formulae (R1) to (R5). (The dark dot in each formula denotes a carbon atom in the ring structure.)

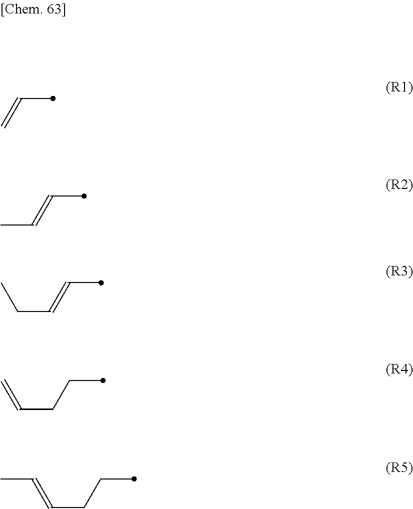

In particular, an compound in which at least one of R¹ and R^{L2} denotes an alkenyl group and a compound represented by the general formula (I) can be used in combination to significantly reduce a decrease in voltage holding ratio (VHR).

When the response time is regarded as important, n^{L1} is preferably 0. In order to improve the upper limit temperature of the nematic phase, n^{L1} is preferably 2 or 3. In order to achieve the balance therebetween, n^{L1} is preferably 1. In order to satisfy the characteristics required for the composition, compounds with different n^{L1}s are preferably combined.

A^{L1}, A^{L2}, and A^{L3} preferably independently denote an aromatic when an increased Δn is required, denote an aliphatic to improve the response time, or denote a trans-1,4-cyclohexylene group, a 1,4-phenylene group, a 2-fluoro-1,4-phenylene group, a 3-fluoro-1,4-phenylene group, a 3,5-difluro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, more preferably the following structures,

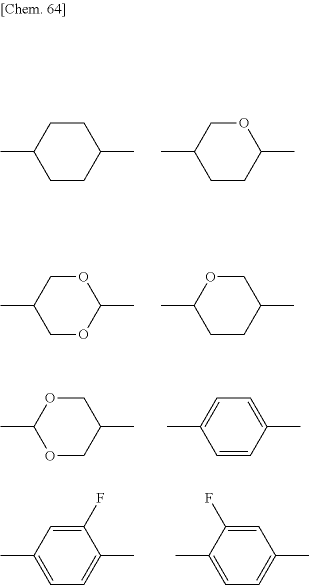

still more preferably a trans-1,4-cyclohexylene group or a 1,4-phenylene group.

When the response time is regarded: as important, Z^{L1} and Z^{L2} preferably denote a single bond.

The number of halogen atoms in the molecule: is preferably 0 or 1.

A compound represented by the general formula (L) is preferably a compound selected from the compounds represented by the general formula (L-1).

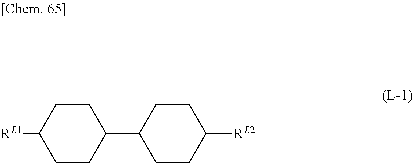

(In the formula, R^{L1} and R^{L2} have the same meaning as R^{L1} and R^{L2}, respectively, in the general formula (L).)

R^{L11} and R^{L2} preferably denote a linear alkyl group having 1 to 5 carbon atoms, a linear alkoxy group having 1 to 4 carbon atoms, or a linear alkenyl group having 2 to 5 carbon atoms. The compounds represented by the general formula (L-1) may be used alone or as a combination of two or more thereof. Although compounds of any types may be combined, these compounds are appropriately combined in a manner that depends on the desired characteristics, such as solubility at low temperatures, transition temperature, electrical reliability, and birefringence index. For example, one, two, three, four, five, or more compounds are used in one embodiment of the present invention.

The preferred lower limit of content is 1%, 2%, 3%, 5%, 7%, 10%, 15%, 20%, 25%, 30%, 35%, 40%, 45%, 50%, or 55% of the total amount of composition according to the present invention. The preferred upper limit of content is 95%, 90%, 85%, 80%, 75%, 70%, 65%, 60%, 55%, 50%, 45%, 40%, 35%, 30%, or 25% of the total amount of composition according to the present invention.

When a composition according to the present invention with a low viscosity and a high-speed response time is required, the lower limit is preferably high, and the upper limit is preferably high. When a composition according to the present invention with a high Tni and high temperature stability is required, the lower limit is preferably medium, and the upper limit is preferably medium. When dielectric constant anisotropy is increased to maintain a low driving voltage, the lower limit is preferably low, and the upper limit is preferably low.

A compound represented by the general formula (L-1) is preferably a compound represented by the general formula (L-1-1).

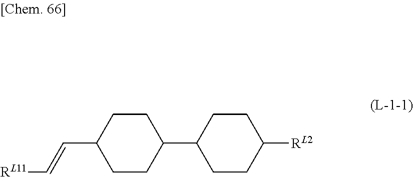

(In the formula, R^{L11} denotes a hydrogen atom or a methyl group, and R^{L2} has the same meaning as R^{L2} in the general formula (L).)

A compound represented by the general formula (L-1-1) is preferably a compound selected from the compound group represented by the formulae (L-1-1.11) to (L-1-1.13), preferably a compound represented by the formula (L-1-1.12) or (L-1-1.13), particularly preferably the compound represented by the formula (L-1-1.13).

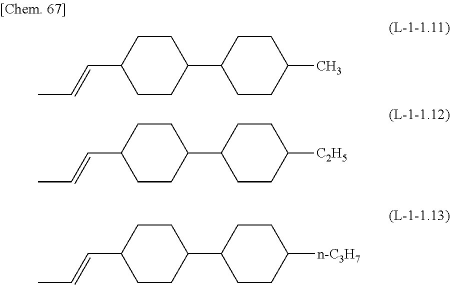

Compounds represented by the general formula (L-1-1) are preferably compounds selected from the compound group represented by the formulae (L-1-1.21) to (L-1-1.24), preferably compounds represented by the formulae (L-1-1.22) to (L-1-1.24). In particular, the compound represented by the formula (L-1-1.22) is preferred in order to particularly improve the response time of a composition according to the present invention. The compound represented by the formula (L-1-1.23) or (L-1-1.24) is preferably used to increase Tni rather than the response time.

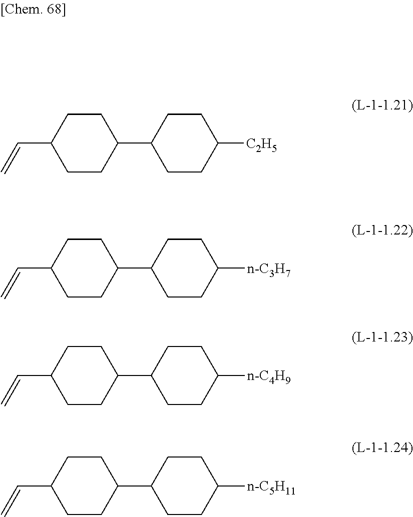

A compound represented by the general formula (L-1-1) is preferably a compound selected from the compound group represented by the formulae (L-1-1.31) and (L-1-1.41).

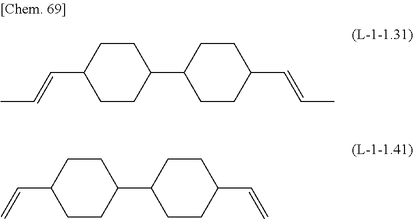

A compound represented by the general formula (L-1) is preferably a compound represented by the general formula (L-1-2).

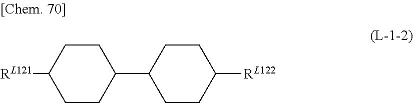

(In the formula, R¹²¹ and R¹²² independently denote an alkyl group having 1 to 8 carbon atoms or an alkoxy group having 1 to 8 carbon atoms.)

A compound represented by the general formula (L-1-2) is preferably a compound selected from the compound group represented by the formulae (L-1-2.1) to (L-1-2.12), preferably a compound represented by the formula (L-1-2.1), (L-1-2.3), or (L-1-2.4). In particular, the compound represented by the formula (L-1-2.1) is preferred in order to particularly improve the response time of a composition according to the present invention. The compounds represented by the formulae (L-1-2.3), (L-1-2.4), (L-1-2.11), and (L-1-2.12) are preferably used to increase Tni rather than the response time. In order to improve solubility at low temperatures, it is undesirable that the total amount of compounds represented by the formulae (L-1-2.3), (L-1-2.4), (L-1-2.11), and (L-1-2.12) be 20% or more.

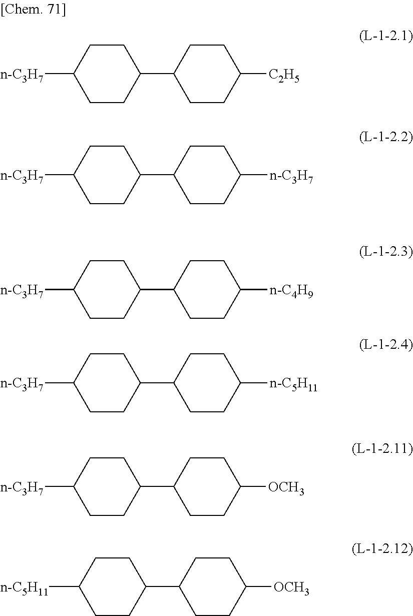

A compound represented by the general formula (L-1) is preferably a compound selected from the compound group represented by the general formula (L-1-3) and/or the general formula (L-1-4).

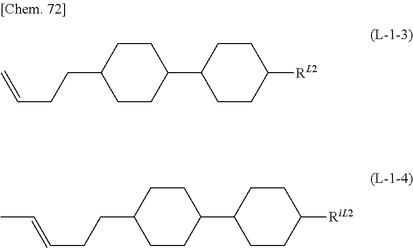

(In the formula, Rⁱⁱ³¹ and Rⁱⁱ⁴¹ independently have the same meaning as Rⁱⁱ² in the general formula (L).)

Compounds represented by the general formula (L) are preferably compounds represented by the following general formulae (L-2) to (L-11). A liquid crystal composition according to the present invention preferably contains one or two or more compounds represented by the general formulae (L-2) to (L-11) as a compound or compounds represented by the general formula (L).

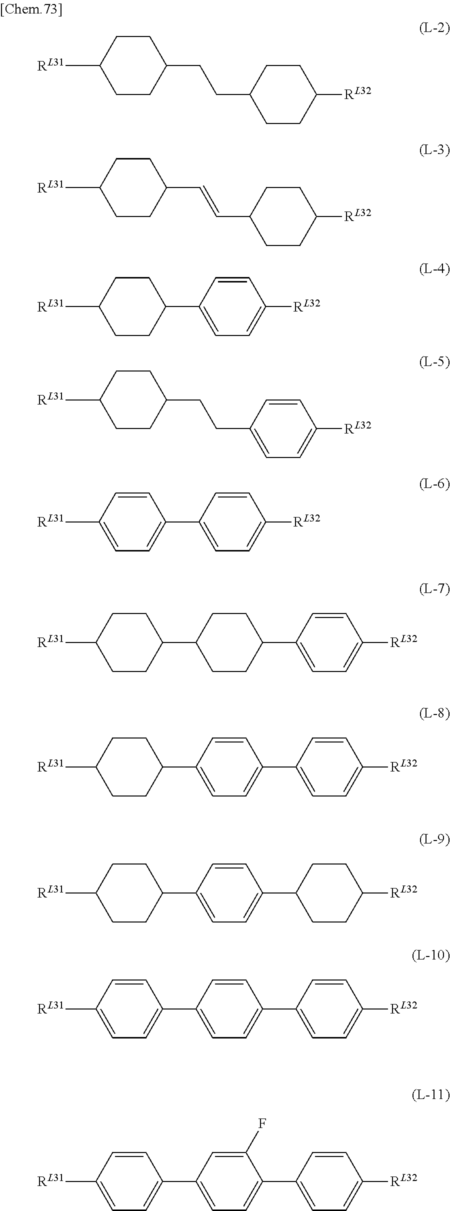

(In the formula, R^{L31} and R^{L32} denotes an alkyl group having 1 to 5 carbon atoms or an alkenyl group having 2 to 5 carbon atoms, and R^{L31} denotes an alkyl group having 1 to 5 carbon atoms, an alkoxy group having 1 to 5 carbon atoms, an alkenyl group having 2 to 5 carbon atoms, or an alkenyloxy group having 2 to 5 carbon atoms.)

A compound represented by the general formula (L) is preferably a compound selected from the general formulae (L-4), (L-6), (L-7), and (L-8), more preferably a compound selected from the general formulae (L-6), (L-7), and (L-8), still more preferably a compound selected from the general formulae (L-7) and (L-8), and a compound selected from the general formulae (L-6) and (L-8) is also preferred. More specifically, when a high Δn is required, a compound selected from the general formulae (L-6), (L-8), and (L-11) is preferred.

In a compound represented by the general formula (L-4), (L-7), or (L-8), R^{L31} preferably denotes an alkyl group having 1 to 5 carbon atoms or an alkenyl group having 2 to 5 carbon atoms, R^{L32} preferably denotes an alkyl group having 1 to 5 carbon atoms or an alkoxy group having 1 to 5 carbon atoms, R^{L31} more preferably denotes an alkenyl group having 2 to 5 carbon atoms, still more preferably an alkenyl group having 2 or 3 carbon atoms. In a compound represented by the general formula (L-6), R^{L31} and R^{L32} preferably independently denote an alkyl group having 1 to 5 carbon atoms or an alkenyl group having 2 to 5 carbon atoms.

One or two or more compounds represented by the general formula (L-12), (L-13), or (L-14) are preferably contained as a compound or compounds represented by the general formula (L).

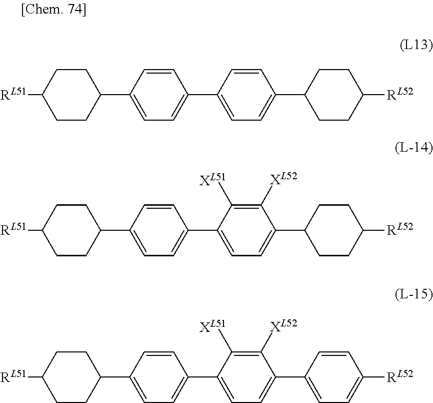

(In the formula, R^{L51} and R^{L52} independently denote an alkyl group having 1 to 5 carbon atoms, an alkenyl group having 2 to 5 carbon atoms, or an alkoxy group having 1 to 4 carbon atoms, X^{L51} and X^{L52} independently denote a fluorine atom or a hydrogen atom, and one of X^{L51} and X^{L52} denotes a fluorine atom, and the other denotes a hydrogen atom.)

One or two or more compounds represented by the general formulae (L-16.1) to (L-16.3) may be contained as a compound or compounds represented by the general formula (L).

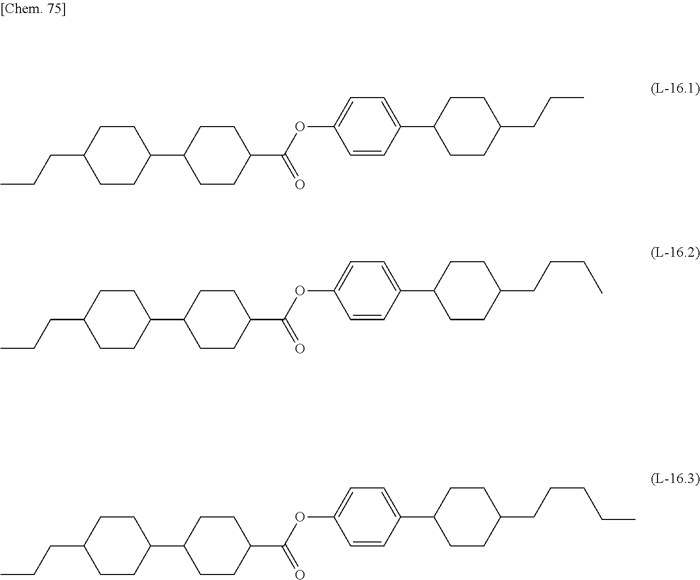

One or two or more compounds represented by the general formula (N-001) may be contained as a compound or compounds represented by the general formula (L).

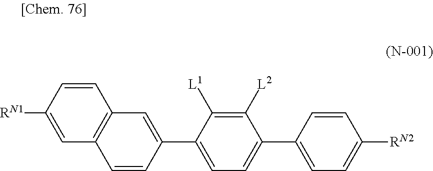

(In the formula, R^{N1} and R^{N2} independently denote an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, and L¹ and L² independently denote a hydrogen atom, a fluorine atom, CH₃, or CF₃, provided that either L¹ or L² is not a fluorine atom.)

R^{N1} and R^{N2} preferably denote an alkyl group having 1 to 5 carbon atoms.

A liquid crystal composition according to the present invention preferably has a positive dielectric constant anisotropy (Δε) at 25° C. and preferably has a dielectric constant anisotropy (Δε) in the range of 1.5 to 20.0, more preferably 1.5 to 18.0, still more preferably 1.5 to 15.0, still more preferably 1.5 to 11, particularly preferably 1.5 to 8, at 25° C.

A liquid crystal composition with a positive dielectric constant anisotropy (Δε) preferably contains a compound represented by the general formula (J) and a compound represented by the general formula (L). More specifically, such a liquid crystal composition preferably contains a compound represented by the general formula (M) and a compound represented by the general formula (L-1), preferably a compound represented by the general formula (M-1) and/or the general formula (M-2) and a compound represented by the general formula (L-1-1).

The lower limit of the total amount of a compound represented by the general formula (I), a compound represented by the general formula (J), and a compound represented by the general formula (L) in a liquid crystal composition according to the present invention is preferably 5% or more, 80% or more, 85% or more, 88% or more, 90% or more, 92% or more, 95% or more, 97% or more, 98% or more, 99% or more. Preferably, a liquid crystal composition according to the present invention is substantially free from the other compounds. The upper limit is preferably 90% or less, preferably 95% or less, preferably 98% or less, preferably 99% or less. Preferably, a liquid crystal composition according to the present invention is substantially free from the other compounds. The term “substantially”, as used herein, refers to excluding unintentional compounds, such as incidental impurities, during production.

The lower limit of the total amount of a compound represented by the general formula (I), a compound represented by the general formula (M), and a compound represented by the general formula (L) in a liquid crystal composition according to the present, invention is preferably 5% or more, 80% or more, 85% or more, 88% or more, 90% or more, 92% or more, 95% or more, 97% or more, 98% or more, 99% or more. Preferably, a liquid crystal composition according to the present, invention is substantially free from the other compounds. The upper limit is preferably 30% or less, preferably 95% or less, preferably 98% or less, preferably 99% or less. Preferably, a liquid crystal composition according to the present invention is substantially free from the other compounds.

The lower limit of the total amount, of a compound represented by the general formula (I), a compound represented by the general formula (J), and a compound represented by the general formula (L-1) in a liquid crystal composition according to the present invention is preferably 5% or more, 10% or more, 13% or more, 15% or more, 18% or more, 20% or more, 23% or more, 25% or more, 28% or more, 30% or more, 33% or more, 35% or more, 38% or more, 40% or more. The upper limit is preferably 95% or less, preferably 90% or less, preferably 88% or less, preferably 85% or less, preferably 83% or less, preferably 80% or less, preferably 78% or less, preferably 75% or less, preferably 73% or less, preferably 70% or less, preferably 68% or less, preferably 65% or less, preferably 63% or less, preferably 60% or less, preferably 55% or less, preferably 50% or less, preferably 40% or less.

A liquid crystal composition according to the present invention preferably has a negative dielectric constant anisotropy (Δε) at 25° C. and preferably has a dielectric constant anisotropv (Δε) in the range of −2.0 to −8.0, preferably −2.0 to −6.0, more preferably −2.0 to −5.0, particularly preferably −2.5 to −4.0, at 25° C.

A liquid crystal composition with a negative dielectric constant anisotropy (Δε) preferably contains a compound represented by the general formulae (N-1) to (N-3) and a compound represented by the general formula (L). More specifically, a compound represented by the general formula (N-1) and a compound represented by the general formula (L-1) are preferably contained, and a compound represented by the general formula (N-1) and a compound represented by the general formula (L-1-1) are preferably contained.

The lower limit of the total amount of a compound represented by the general formula (I), a compound represented by the general formulae (N-1) to (N-3), and a compound represented by the general formula (L) in a liquid crystal composition according to the present invention is preferably 5% or more, 80% or more, 85% or more, 88% or more, 90% or more, 92% or more, 95% or more, 97% or more, 98% or more, 99% or more. Preferably, a liquid crystal composition according to the present invention is substantially free from the other compounds. The upper limit is preferably 90% or less, preferably 95% or less, preferably 98% or less, preferably 99% or less. Preferably, a liquid crystal composition according to the present invention is substantially free from the other compounds.

The lower limit of the total amount of a compound represented by the general formula (I), a compound represented by the general formula (N-1), and a compound represented by the general formula (L) in a liquid crystal composition according to the present invention is preferably 5% or more, 80% or more, 85% or more, 88% or more, 90% or more, 92% or more, 95% or more, 97% or more, 98% or more, 99% or more. Preferably, a liquid crystal composition according to the present invention is substantially free from the other compounds. The upper limit is preferably 90% or less, preferably 95% or less, preferably 98% or less, preferably 99% or less. Preferably, a liquid crystal composition according to the present invention is substantially free from the other compounds.

The lower limit of the total amount of a compound represented by the general formula (I), a compound represented by the general formula (J), and a compound represented by the general formula (L-1) in a liquid crystal composition according to the present invention is preferably 5% or more, 10% or more, 13% or more, 15% or more, 18% or more, 20% or more, 23% or more, 25% or more, 28% or more, 30% or more, 33% or more, 35% or more, 38% or more, 40% or more. The upper limit is preferably 95% or less, preferably 90% or less, preferably 88% or less, preferably 85% or less, preferably 83% or less, preferably 30% or less, preferably 78% or less, preferably 75% or less, preferably 73% or less, preferably 70% or less, preferably 68% or less, preferably 65% or less, preferably 63% or less, preferably 60% or less, preferably 55% or less, preferably 50% or less, preferably 40% or less.

A liquid crystal composition according to the present invention has a refractive index anisotropy (Δn) in the range of 0.08 to 0.14, preferably 0.09 to 0.13, particularly preferably 0.09 to 0.12, at 25° C. More specifically, the reflective index anisotropy (An) preferably ranges from 0.10 to 0.13 for a small cell gap and 0.08 to 0.10 for a large cell gap.

A liquid crystal composition according to the present invention has a viscosity (η) in the range of 10 to 50 mPa·s, preferably 10 to 40 mPa·s, particularly preferably 10 to 35 mPa·s, at 25° C.

A liquid crystal composition according to the present invention has a rotational viscosity (γ₁) in the range of 60 to 130 mPa·s, preferably 60 to 110 mPa·s, particularly preferably 60 to 100 mPa·s, at 25° C.

A liquid crystal composition according to the present invention has a nematic phase-isotropic liquid phase transition temperature (Tₙᵢ) in the range of 60° C. to 120° C. preferably 70° C. to 100° C., particularly preferably 70° C. to 85° C.

A liquid crystal composition according to the present invention may contain an ordinary nematic liquid crystal, smectic liquid crystal, cholesteric liquid crystal, antioxidant, ultraviolet absorber, infrared absorber, polymerizable monomer, or light stabilizer (HALS) except the present invention, in addition to the compounds described above.

For example, a liquid crystal composition according to the present invention may contain a liquid crystal compound with a dielectric constant anisotropy (Δε) in the range of +2.0 to +50.0 at 25° C. as an ordinary nematic liquid crystal or a smectic liquid crystal, and the amount of the liquid crystal compound ranges from 0% to 50% by mass, preferably 1% to 30% by mass, preferably 3% to 30% by mass, preferably 5% to 20% by mass.

For example, a liquid crystal composition may contain 0.01% to 2% by mass polymerizable compound, such as a biphenyl derivative or a terphenyl derivative, as a polymerizable monomer.

One or two or more of monofunctional polymerizable compounds with one reactive group and polyfunctional polymerizable compounds with two or more reactive groups, such as bifunctional or trifunctional, may be contained as a polymerizable monomer or polymerizable monomers. A polymerizable compound with a reactive group may or may not include a mesogenic moiety.

In a polymerizable compound with a reactive group, the reactive group is preferably a photopolymerizable substituent.

Among polymerizable compounds with a reactive group, a specific monofunctional polymerizable compound with a reactive group is preferably a polymerizable compound represented by the following general formula (VI).

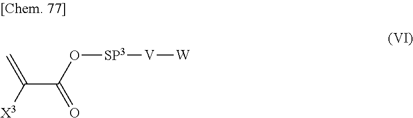

(In the formula, X³ denotes a hydrogen atom or a methyl group, Sp³ denotes a single bond, an alkylene group having 1 to 8 carbon atoms, or —O—(CH₂)ₜ— (wherein t denotes an integer in the range of 2 to 7, and the oxygen atom is bonded to an aromatic ring), V denotes a linear or branched polyvalent alkylene group having 2 to 20 carbon atoms or a polyvalent cyclic substituent having 5 to 30 carbon atoms, an alkylene group in the polyvalent alkylene group may be substituted with an oxygen atom, provided that oxygen atoms are not adjacent to each other, or may be substituted with an alkyl group having 5 to 20 carbon atoms (an alkylene group in the group may be substituted with an oxygen atom, provided that oxygen atoms are not adjacent to each other) or a cyclic substituent, and W denotes a hydrogen atom, a halogen atom, or an alkylene group having 1 to 8 carbon atoms.)

In the general formula (VI), X³ denotes a hydrogen atom or a methyl group, preferably a hydrogen atom when the reaction rate is regarded as important, preferably a methyl group when a decreased residual amount after the reaction is regarded as important.

In the general formula (VI), Sp³ denotes a single bond, an alkylene group having 1 to 8 carbon atoms, or —O—(CH₂)ₜ— (wherein t denotes an integer in the range of 2 to 7, and the oxygen atom is bonded to an aromatic ring). The carbon chain is preferably not too long. Thus, a single bond or an alkylene group having 1 to 5 carbon atoms is preferred, and a single bond or an alkylene group having 1 to 3 carbon atoms is more preferred. When Sp³ denotes —O—(CH₂)ₜ—, t preferably ranges from 1 to 5, more preferably 1 to 3.

In the general formula (VI), V denotes a linear or branched polyvalent alkylene group having 2 to 20 carbon atoms or a polyvalent cyclic substituent having 5 to 30 carbon atoms. An alkylene group in the polyvalent alkylene group may be substituted with an oxygen atom, provided that oxygen atoms are not adjacent to each other, or may be substituted with an alkyl group having 5 to 20 carbon atoms (an alkylene group in the group may be substituted with an oxygen atom, provided that oxygen atoms are not adjacent to each other) or a cyclic substituent, and is preferably substituted with two or more cyclic substituents.

More specifically, a polymerizable compound represented by the general formula (VI) may be a compound represented by the general formula (X1a).

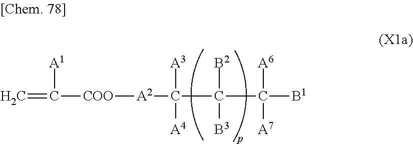

(In the formula, A¹ denotes a hydrogen atom or a methyl group,

A² denotes a single bond or an alkylene group having 1 to 8 carbon atoms (one or two or more methylene groups in the alkylene group may be independently substituted with an oxygen atom, —CO—, —COO—, or —OCO—, provided that oxygen atoms are not directly bonded to each other, and one or two or more hydrogen atoms in the alkylene group may be independently substituted with a fluorine atom, a methyl group, or an ethyl group),

A³ and A⁶ independently denote a hydrogen atom, a halogen atom, or an alkyl group having 1 to 10 carbon atoms (one or two or more methylene groups in the alkyl group may be independently substituted with an oxygen atom, —CO—, —COO—, or —OCO—, provided that oxygen atoms are not directly bonded to each other, and one or two or more hydrogen atoms in the alkyl group may be independently substituted with a halogen atom or an alkyl group having 1 to 17 carbon atoms),

A⁴ and A⁷ independently denote a hydrogen atom, a halogen atom, or an alkyl group having 1 to 10 carbon atoms (one or two or more methylene groups in the alkyl group may be independently substituted with an oxygen atom, —CO—, —COO—, or —OCO—, provided that oxygen atoms are not directly bonded to each other, and one or two or more hydrogen atoms in the alkyl group may be independently substituted with a halogen atom or an alkyl group having 1 to 9 carbon atoms),

p ranges, from 1 to 10, and

B¹, B², and B³ independently denote a hydrogen atom or a linear or branched alkyl group having 1 to 10 carbon atoms (one or two or more methylene groups in the alkyl group may be independently substituted with an oxygen atom, —CO—, —COO—, or —OCO—, provided that oxygen atoms are not directly bonded to each other, and one or two or more hydrogen atoms in the alkyl group may be independently substituted with a halogen atom or a trialkoxysilyl group having 3 to 6 carbon atoms).

More specifically, a polymerizable compound represented by the general formula (VI) may also be a compound represented by the general formula (X1b).

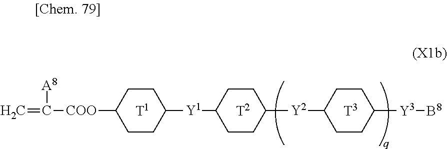

(In the formula, A⁸ denotes a hydrogen atom or a methyl group,

6-membered rings T¹, T², and T³ independently denote one of the following (wherein q denotes an integer in the range of 1 to 4),

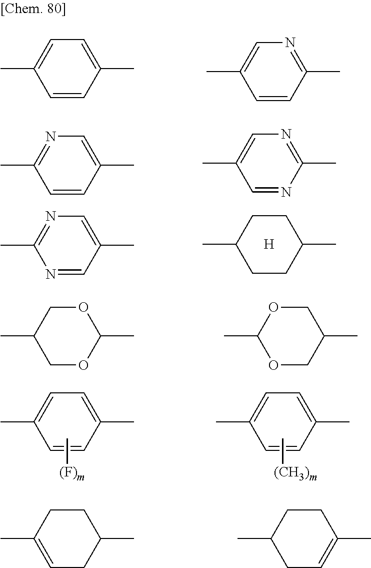

q is 0 or 1,

Y¹ and Y² independently denote a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH₂═CHCH₂CH₂—, or —CH₂CH₂CH═CH—,

Y³ denotes a single bond, —COO—, or —OCO—, and

B⁸ denotes a hydrocarbon group having 1 to 18 carbon atoms.)

More specifically, a polymerizable compound represented by the general formula (VI) may also be a compound represented by the general formula (X1c).

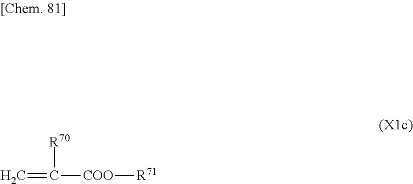

(In the formula, R⁷⁰ denotes a hydrogen atom or a methyl group, and R⁷¹ denotes a hydrocarbon group with a fused ring.)

Among polymerizable compounds with a reactive group, a polyfunctional polymerizable compound with a reactive group is preferably a polymerizable compound represented by the following general formula (VII).

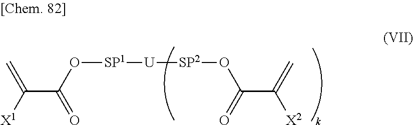

(In the formula, X¹ and X² independently denote a hydrogen atom or a methyl group, Sp¹ and Sp² independently denote a single bond, an alkylene group having 1 to 8 carbon atoms, or —O—(CH₂)ₛ— (wherein s denotes an integer in the range of 2 to 7, and the oxygen atom is bonded to an aromatic ring), U denotes a linear or branched polyvalent alkylene group having 2 to 20 carbon atoms or a polyvalent cyclic substituent having 5 to 30 carbon atoms, an alkylene group in the polyvalent alkylene group may be substituted with an oxygen atom, provided that oxygen atoms are not adjacent to each other, or may be substituted with an alkyl group having 5 to 20 carbon atoms (an alkylene group in the group may be substituted with an oxygen atom, provided that oxygen atoms are not adjacent to each other) or a cyclic substituent, and k denotes an integer in the range of 1 to 5.)

In the general formula (VII), X¹ and X² independently denote a hydrogen atom or a methyl group, preferably a hydrogen atom when the reaction rate is regarded as important, preferably a methyl group when a decreased residual amount after the reaction is regarded as important.

In the general formula (VII), Sp¹ and Sp² independently denote a single bond, an alkylene group having 1 to 8 carbon atoms , or —O—(CH₂)ₛ— (wherein s denotes an integer in the range of 2 to 7, and the oxygen atom is bonded to an aromatic ring). The carbon chain is preferably not too long. Thus, a single bond or an alkylene group having 1 to 5 carbon atoms is preferred, and a single bond or an alkylene group having 1 to 3 carbon atoms is more preferred. When Sp¹ and Sp² denote —O—(CH₂)ₛ—, s preferably ranges from 1 to 5, more preferably 1 to 3, and at least one of Sp¹ and Sp² more preferably denotes a single bond, and particularly preferably both Sp¹ and Sp² denote a single bond.

In the general formula (VII), U denotes a linear or branched polyvalent alkylene group having 2 to 20 carbon atoms or a polyvalent cyclic substituent having 5 to 30 carbon atoms. An alkylene group in the polyvalent alkylene group may be substituted with an oxygen atom, provided that oxygen atoms are not adjacent to each other, or may be substituted with an alkyl group having 5 to 20 carbon atoms (an alkylene group in the group may be substituted with an oxygen atom, provided that oxygen atoms are not adjacent to each other) or a cyclic substituent, and is preferably substituted with two or more cyclic substituents.

In the general formula (VII), more specifically, U preferably denotes the following formulae (VII-1) to (VII-5), more preferably the formulae (VII-1) to (VII-3), particularly preferably the formula (VII-1).

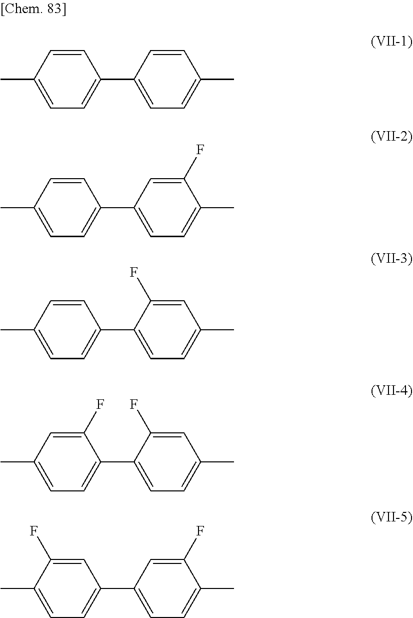

(In the formula, each end is bonded to Sp¹ or Sp².)

When U has a ring structure, at least one of Sp¹ and Sp² preferably denotes a single bond, and both Sp¹ and Sp² also preferably denote a single bond.

In the general formula (VII), k denotes an integer in the range of 1 to 5, a bifunctional compound with k being 1 or a trifunctional compound with k being 2 is preferred, and a bifunctional compound is more preferred.

More specifically, one or two or more polymerizable compounds represented by the general formula (P) are preferably contained.

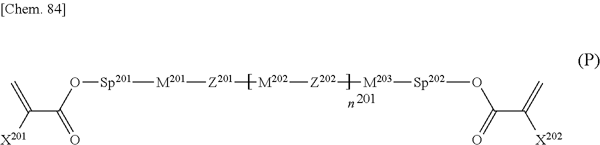

In the general formula (P), X²⁰¹ and X²⁰² independently denote a hydrogen atom, a methyl group, or a —CF³ group. A diacrylate derivative with X²⁰¹ and being a hydrogen atom or a dimethacrylate derivative with X²⁰¹ and X²⁰² being a methyl group is preferred. In another preferred compound, one of X²⁰¹ and X²⁰² denotes a hydrogen atom, and the other denotes a methyl group. A compound suitable for each application can be used. In PSA display devices, a polymerizable compound represented by the general formula (P) preferably includes at least one methacrylate derivative or two methacrylate derivatives.

In the general formula (P), Sp²⁰¹ and S²⁰² independently denote a single bond, an alkylene group having 1 to 8 carbon atoms, or —O—(CH₂)ₛ— (wherein s denotes an integer in the range of 2 to 7, and the oxygen atom is bonded to a ring). In PSA liquid crystal display devices, at least one of Sp²⁰¹ and Sp²⁰² preferably denotes a single bond. A compound with both Sp²⁰¹ and Sp²⁰² being a single bond is preferred. Alternatively, preferably, one of Sp²⁰¹ and Sp²⁰² denotes a single bond, and the other denotes an alkylene group having 1 to 8 carbon atoms or —O—(CH₂)ₛ—, wherein an alkylene group having 1 to 4 carbon atoms is preferred, and s preferably ranges from 1 to 4.

In the general formula (P), M²⁰¹, M²⁰², and M²⁰³ independently denote a trans-1,4-cyclohexylene group (one —CH₂— or two or more nonadjacent —CH₂— groups in the group may be substituted with —O— or —S—), a 1,4-phenylene group (one —CH═ or two or more nonadjacent —CH═ groups in the group may be substituted with —N═), a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and a hydrogen atom in the groups may be substituted with a fluorine atom, a —CF₃ group, an alkyl group having 1 to 10 carbon atoms, an alkoxy group having 1 to 10 carbon atoms, or any of the formulae (R-1) to (R-15).

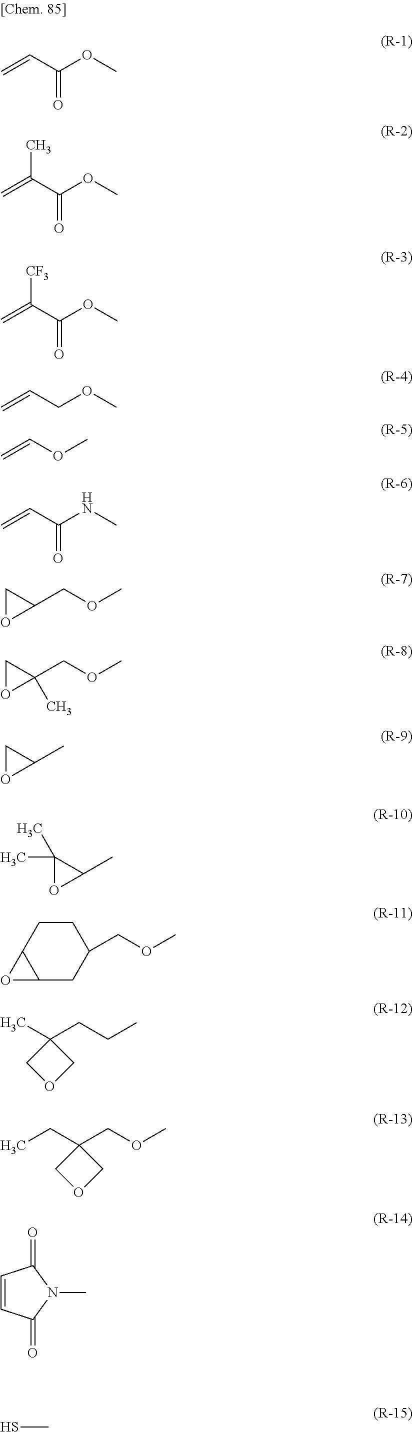

In the general formula (P), Z²⁰¹ and Z²⁰² independently denote —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (wherein Y¹ and Y² independently denote a fluorine atom or a hydrogen atom), —C≡C —, or a single bond, preferably −COO—, —OCO—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —C≡C—, or a single bond, more preferably −COO—, —OCO—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, or a single bond.

In the general formula (P), n²⁰¹ is 0, 1, or 2, preferably 0 or 1. Pluralities of M²⁰²s and Z²⁰²s, if present, may be different or the same M²⁰²s and Z²⁰²s, respectively.

At least one, preferably 1 to 5, more preferably 1 to 3, polymerizable compound represented by the general formula (P) may be contained.

The general formula (P) content preferably ranges from 0.01% to 2.00% by mass, more preferably 0.05% to 1.00% by mass, particularly preferably 0.10% to 0.50% by mass.

More specifically, when n²⁰¹ in the general formula (P) is 0, a ring structure between Sp²⁰¹ and Sp²⁰² is preferably represented by the formulae (XXa-1) to (XXa-5), more preferably the formulae (XXa-1) to (XXa-3), particularly preferably the formula (XXa-1) or (XXa-2). Each end of the formulae is bonded to Sp²⁰¹ or Sp²⁰².

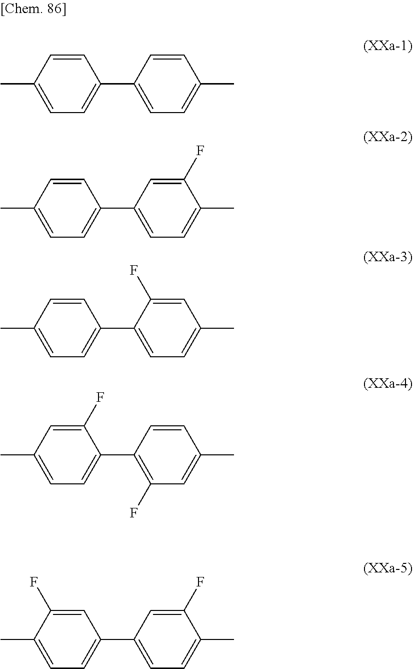

Polymerizable compounds represented by the general formula (P) having such a skeleton are most suitable for PSA liquid crystal display devices with respect to alignment regulating force after polymerization and can provide a satisfactory alignment state, thus causing little or no display unevenness.

Thus, the compounds represented by the formulae (XX-1) to the general formula (XX-10), more preferably the formulae (XX-1) to (XX-4), are preferred as polymerizable monomers.

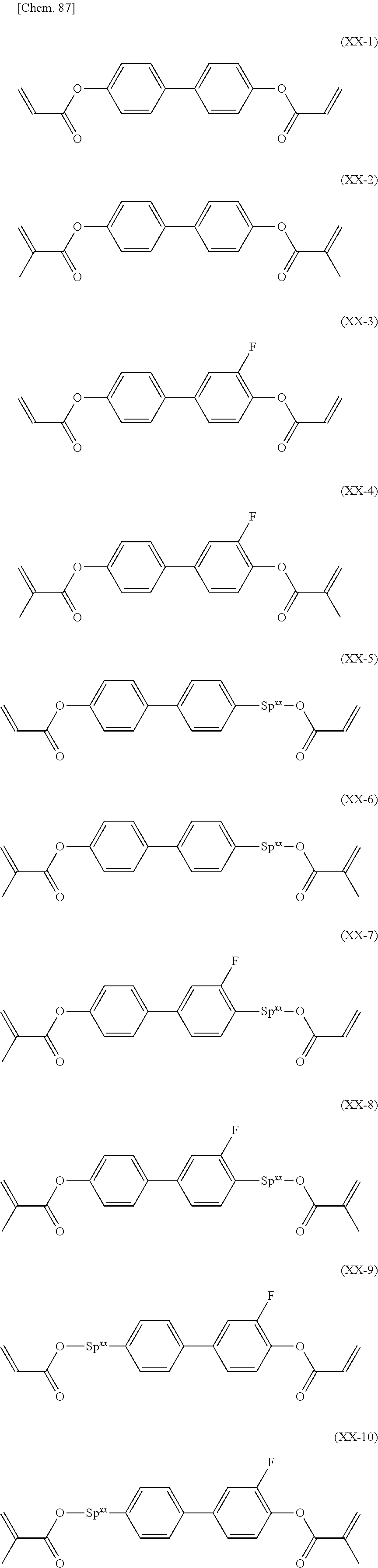

In the formula (XX-1) to the general formula (XX-10), Sp^{xx} denotes an alkylene group having 1 to 8 carbon atoms or —O—(CH₂)ₛ— (wherein s denotes an integer in the range of 2 to 7, and the oxygen atom is bonded to a ring).

In the formula (XX-1) to the general formula (XX-10), a hydrogen atom in the 1,4-phenylene groups may be further substituted with —F, —Cl, —CF₃, —CH₃, or any of the formulae (R-1) to (R-15).

When in the general formula (F) is 1, for example, the polymerizable compounds represented by the formulae (P31) to (P48) are preferred.

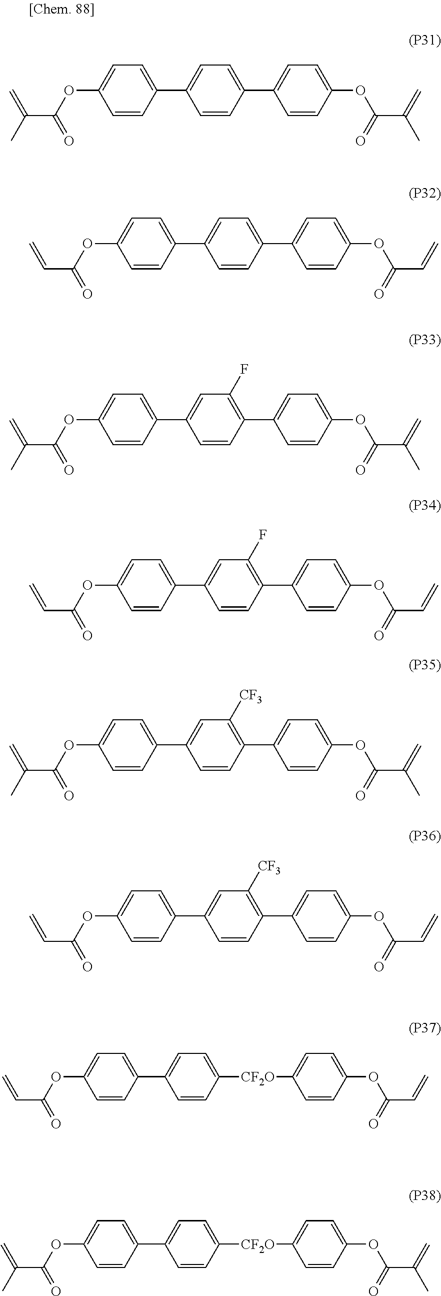

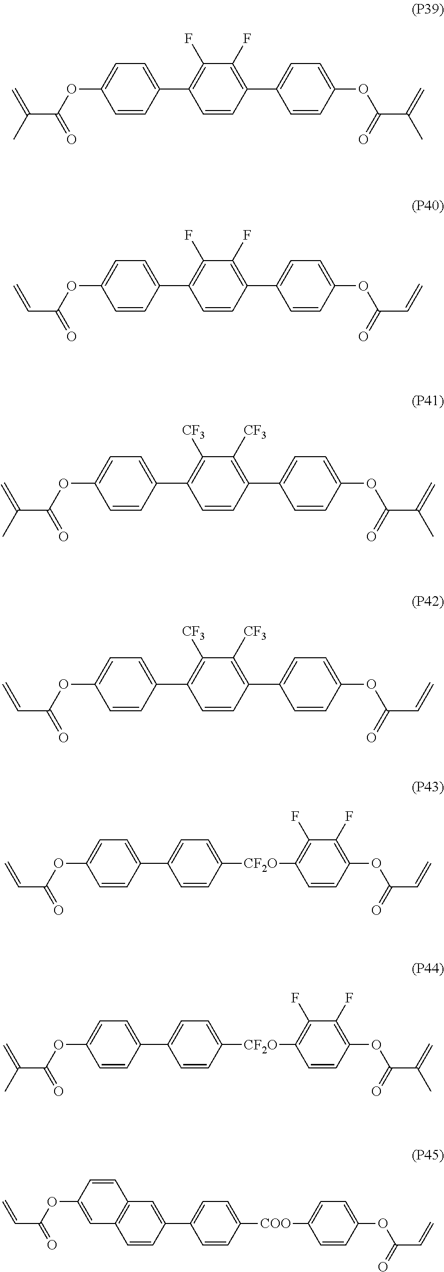

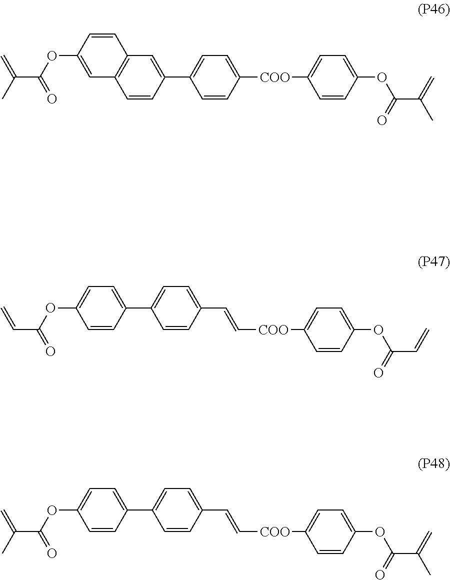

A hydrogen atom of the 1,4-phenylene groups and naphthalene groups in the formulae (P31) to (P48) may be further substituted with —F, —Cl, —CF₃, —CH₃, or any of the formulae (R-1) to (R-15).

Polymerizable compounds represented by the general formula (P) having such a skeleton are most suitable for PSA liquid crystal display devices with respect to alignment regulating force after polymerization and can provide a satisfactory alignment state, thus causing little or no display unevenness.

When n²⁰¹ in the general formula (P) is 1, and the general formula (P) includes a plurality of the formula (R-1) or (R-2), for example, the polymerizable compounds represented by the formulae (P301) to (P316) are preferred.

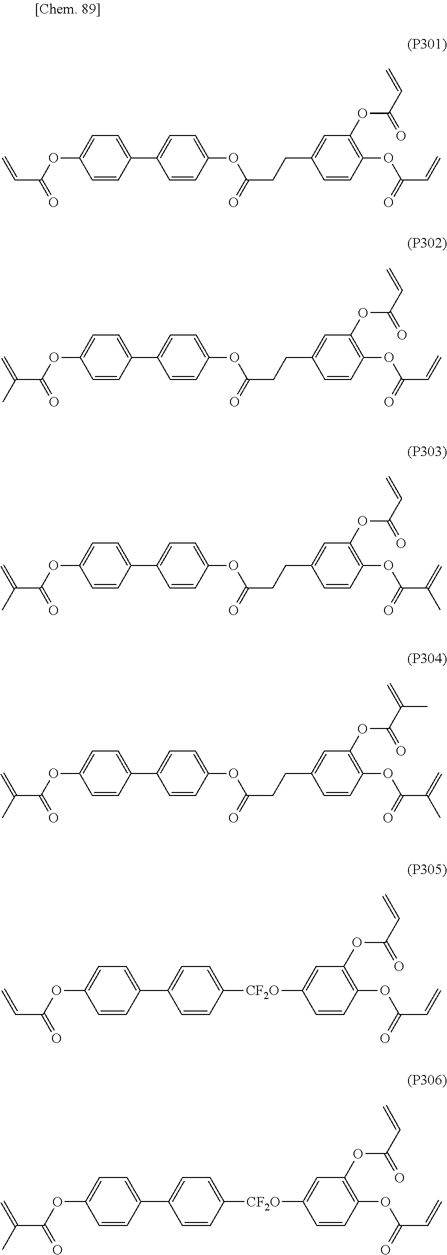

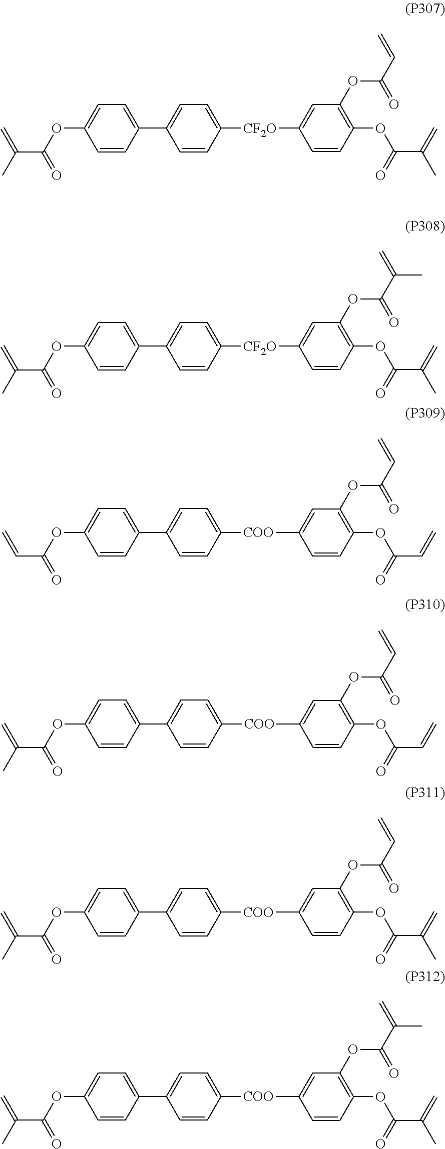

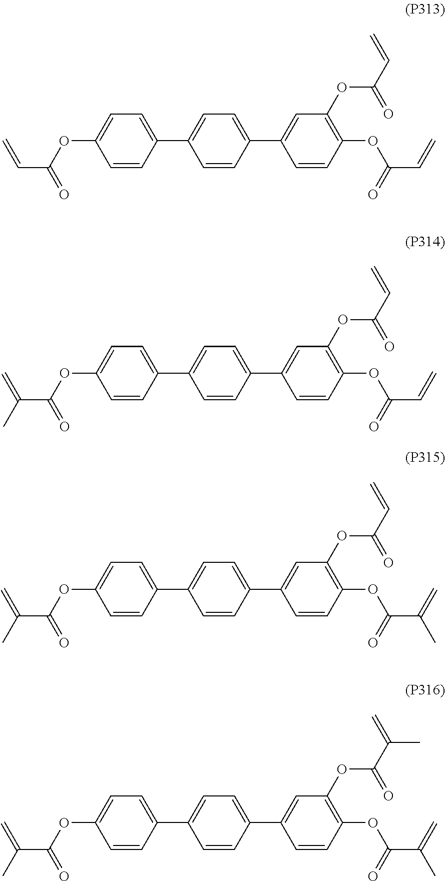

A hydrogen atom of the 1,4-phenylene groups and naphthalene groups in the formulae (P301) to (P316) may be further substituted with —F, —Cl, —CF₃, or —CH₃.

For example, polymerizable compounds represented by the general formula (P) are also preferably polymerizable compounds represented by the formulae (Ia-1) to (Ia-31).

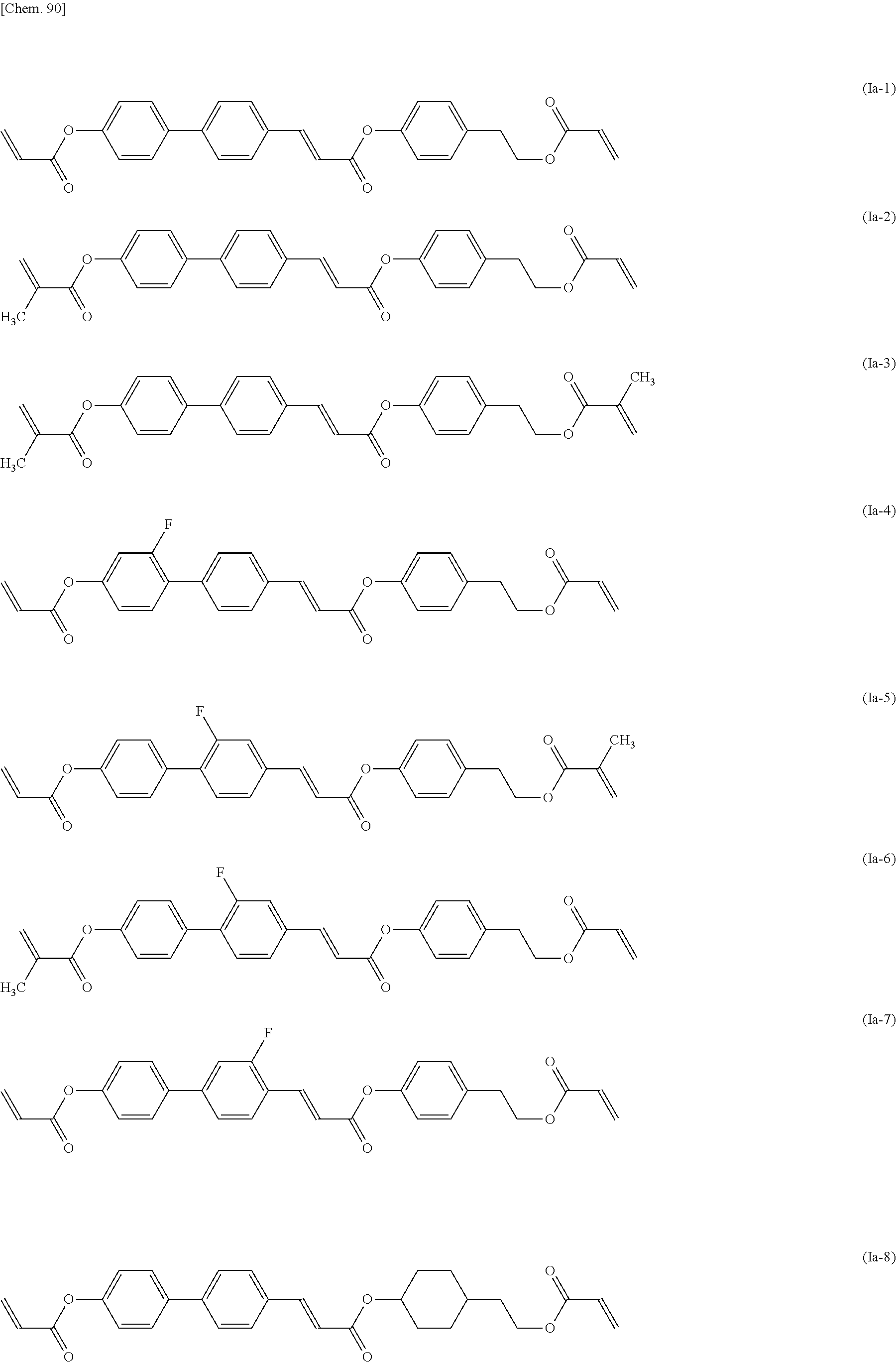

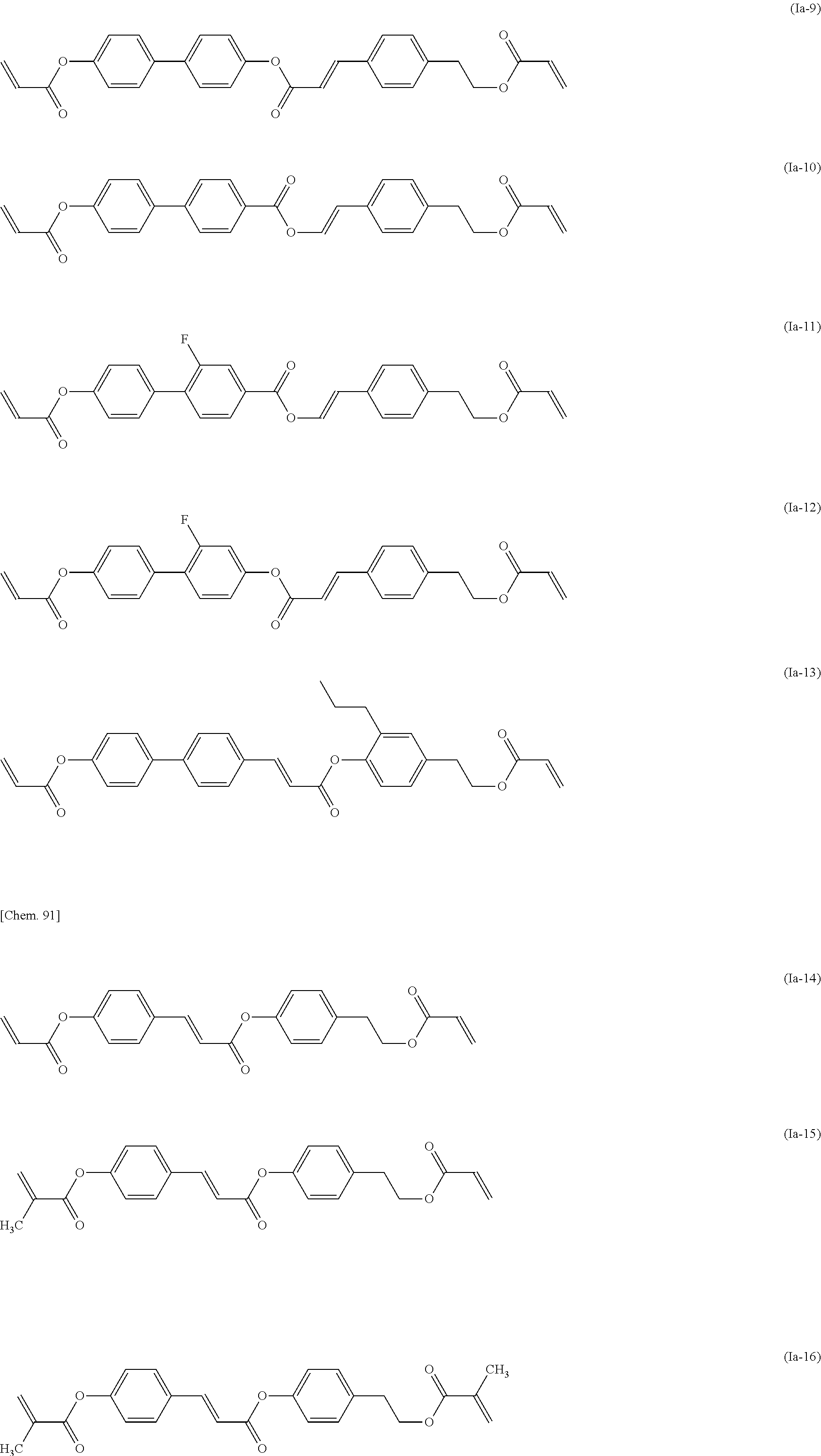

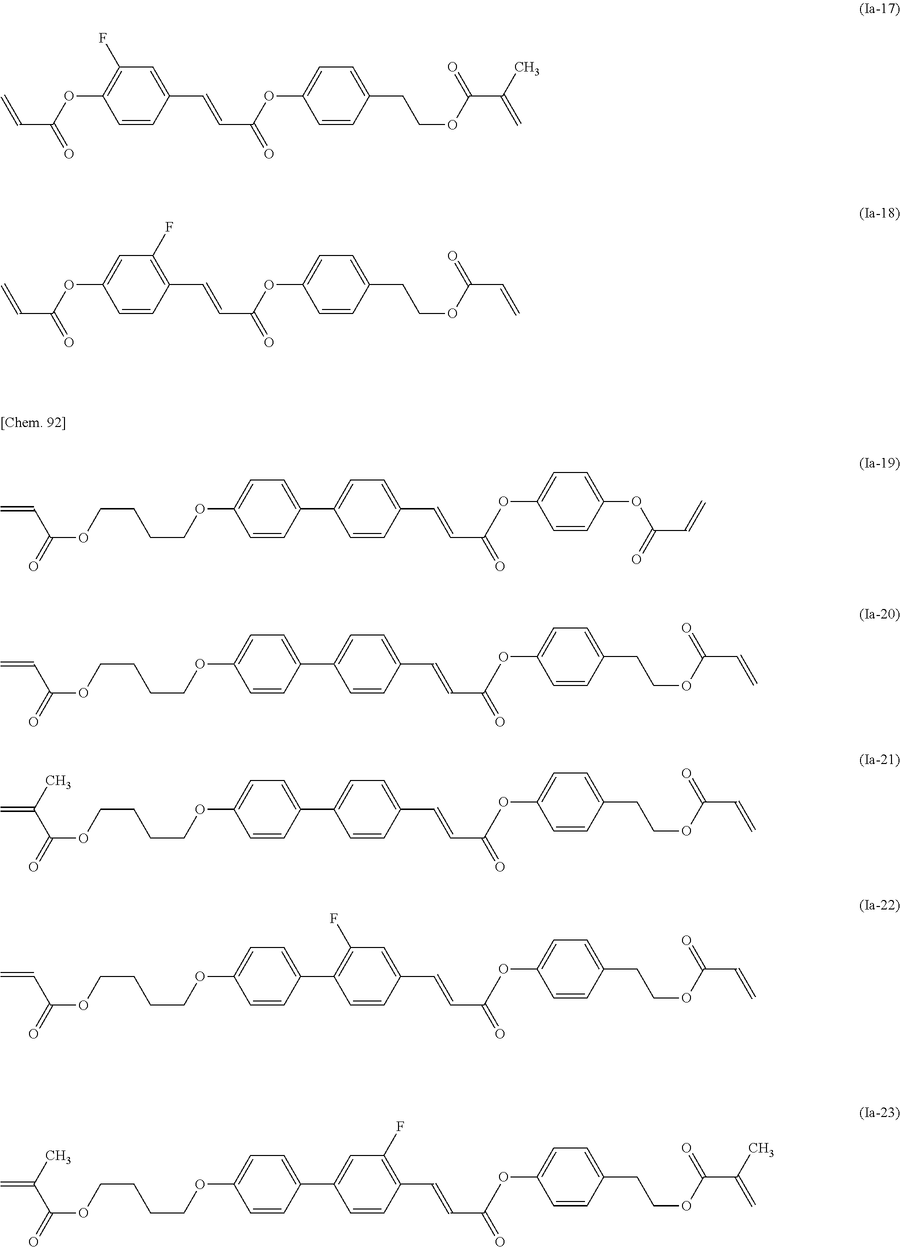

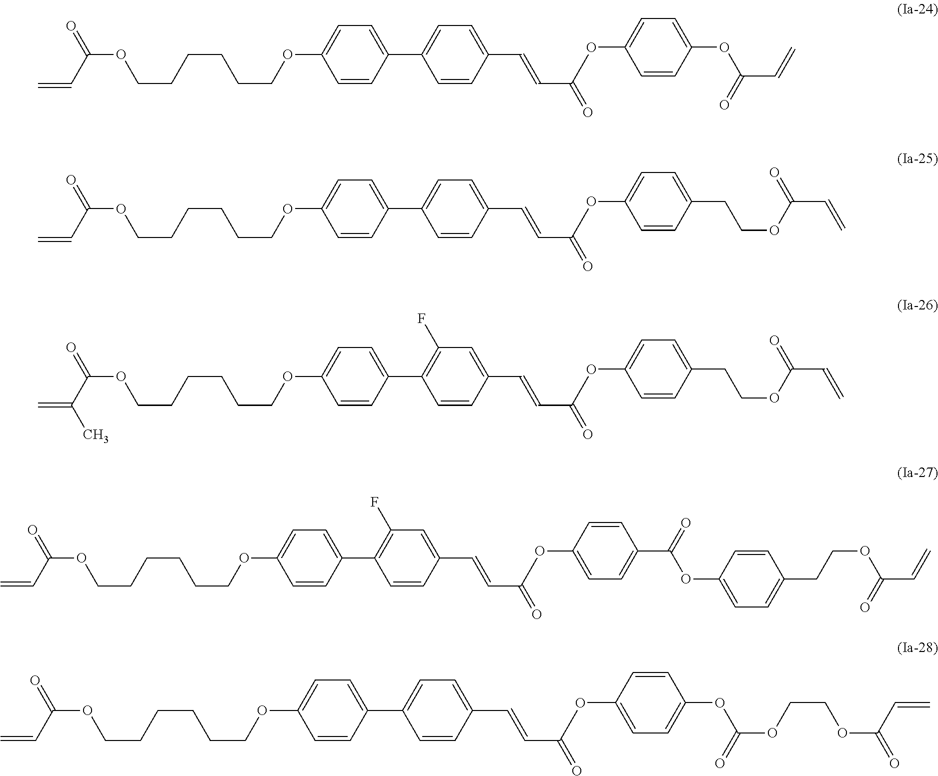

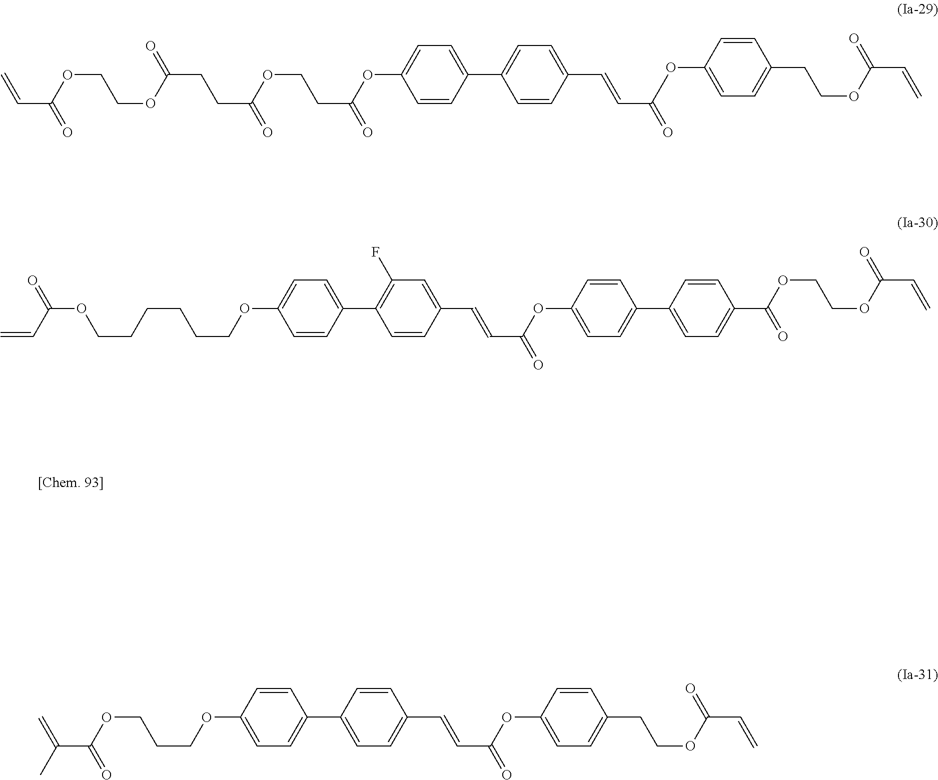

Preferred antioxidants are hindered phenols represented by the general formulae (H-1) to (H-4).

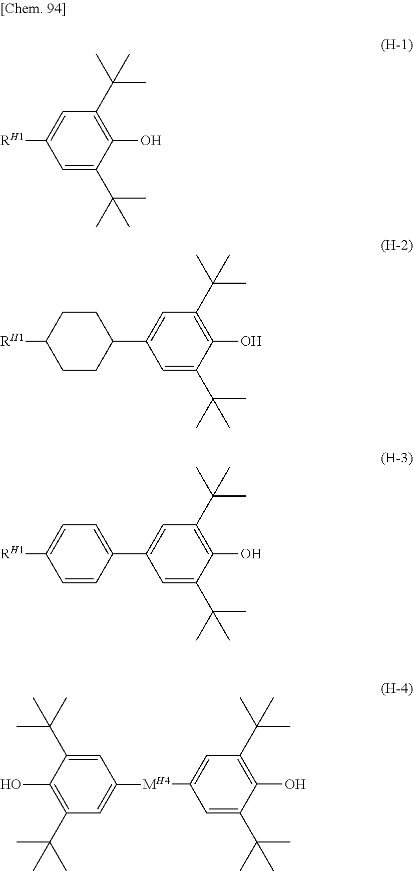

In the general formulae (H-1) to (H-4), denotes an alkyl group having 1 to 10 carbon atoms, an alkoxy group having 1 to 10 carbon atoms, an alkenyl group having 2 to 10 carbon atoms, or an alkenyloxy group having 2 to 10 carbon atoms, one —CH₂— or two or more nonadjacent —CH₂— groups in the groups may be independently substituted with —O— or —S—, and one or two or more hydrogen atoms in the groups may be independently substituted with a fluorine atom or a chlorine atom. More specifically, an alkyl group having 2 to 7 carbon atoms, an alkoxy group having 2 to 7 carbon atoms, an alkenyl group having 2 to 7 carbon atoms, or an alkenyloxy group having 2 to 7 carbon atoms is preferred, and an alkyl group having 3 to 7 carbon atoms or an alkenyl group having 2 to 7 carbon atoms is more preferred.

In the general formula (H-4), M^{H4} denotes an alkylene group having 1 to 15 carbon atoms (one or two or more —CH₂— groups in the alkylene group may be substituted with —O—, —CO—, —COO—, or —OCO—, provided that oxygen atoms are not directly adjacent to each other), —OCH₂—, —CH₂O—, —COO—, —OCO—, —CF₂O—, —OCF₂—, —CF₂CF₂—, —CH═CH—COO—, —CH═CH—OCO—, —COO—CH═CH—, —OCO—CH═CH—, —CH═CH—, —C≡C—, a single bond, a 1,4-phenylene group (a hydrogen atom in the 1,4-phenylene group may be substituted with a fluorine atom), or a trans-1,4-cyclohexylene group, preferably an alkylene group having 1 to 14 carbon atoms. The number of carbon atoms is preferably large in terms of volatility but is preferably not too large in terms of viscosity. Thus, the number of carbon atoms more preferably ranges from 2 to 12, still more preferably 3 to 10, still more preferably 4 to 10, still more preferably 5 to 10, still more preferably 6 to 10.

In the general formulae (H-1) to (H-4), one —CH═ or two or more nonadjacent —CH═ groups in the 1,4-phenylene groups may be substituted with —N═. A hydrogen atom in the 1,4-phenylene groups may be independently substituted with a fluorine atom or a chlorine atom.

In the general formulae (H-1) to (H-4), one —CH₂— or two or more nonadjacent —CH₂— groups in the 1,4-cyclohexylene groups may be substituted with —O— or —S—. A hydrogen atom in the 1,4-cyclohexylene groups may be independently substituted with a fluorine atom or a chlorine atom.

Additional specific examples include the formulae (H-11) to (H-15).

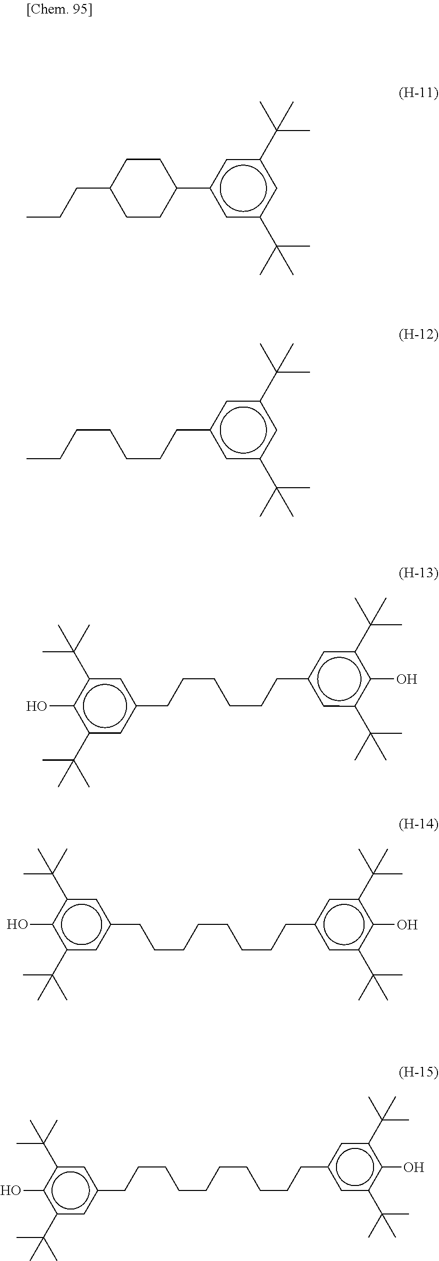

A liquid crystal composition according to the present invention may contain 1 ppm by mass or more, preferably 10 ppm by mass or more, preferably 20 ppm by mass or more, preferably 50 ppm by mass or more, antioxidant. The upper limit of the antioxidant content is 10000 ppm by mass, preferably 1000 ppm by mass, preferably 500 ppm by mass, preferably 100 ppm by mass.

A liquid crystal display device including a liquid crystal composition according to the present invention has no or few display defects, high display quality, and a high-speed response time, and can be particularly applied as an active-matrix liquid crystal display device to the TN, OCB, VA, VA-IPS, PSVA, PSA, FFS, IPS, or ECB mode, for example. The PSVA mode and the PSA mode are substantially synonymous.

Furthermore, a liquid crystal composition according to the present invention containing a polymerizable compound can provide a polymer-stabilized liquid crystal display device of the VA, PSA, TN, OCB, ECB, IPS, FFS, or VA-IPS mode manufactured by polymerizing the polymerizable compound in the liquid crystal composition under voltage application or under no voltage application.

### EXAMPLES

Although the present invention will be further described in the following examples, the present invention is not limited to these examples. The unit “%” with respect to compositions in the following examples and comparative examples refers to “% by mass”.

The following abbreviations are used to describe compounds in the examples.

(Side Chain)

-n —CₙH₂ₙ₊₁ a linear alkyl group having n carbon atoms

n- CₙH₂ₙ₊₁— a linear alkyl group having n carbon atoms

—On —OCₙH₂ₙ₊₁ a linear alkoxy group having n carbon atoms

nO— CnH₂ₙ₊₁O— a linear alkoxy group having n carbon atoms

—V —CH═CH₂

V— CH₂═CH—

—V1 —CH═CH—CH₃

1V— CH₃—CH═CH—

-2V —CH₂—CH₂—CH═CH₂

V2- CH₂═CH—CH₂—CH₂—

-2V1 —CH₂—CH₂—CH═CH—CH₃

1V2- CH₃—CH═CH—CH₂—CH₂—

(Linking Group)

—CFFO— —CF₂—O—

—OCFF— —O—CF₂—

-1O— —CH₂—O—

—O1- —O—CH₂—

—COO— —COO—

—OCO— —OCO—

(Ring Structure)

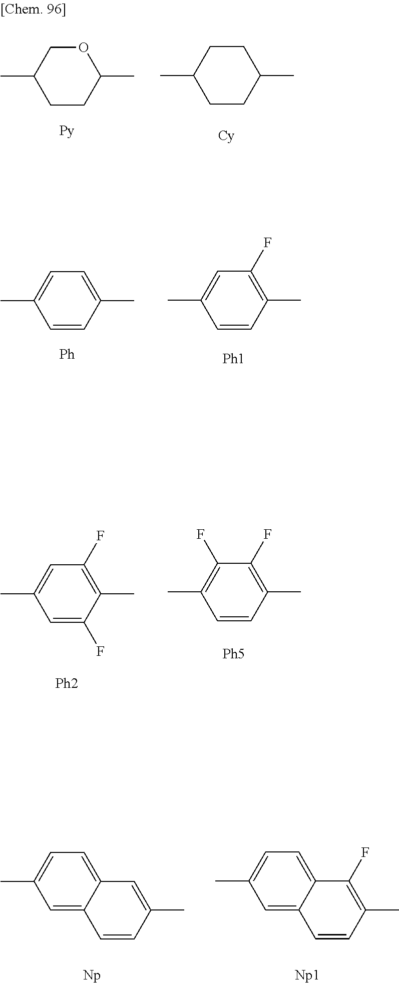

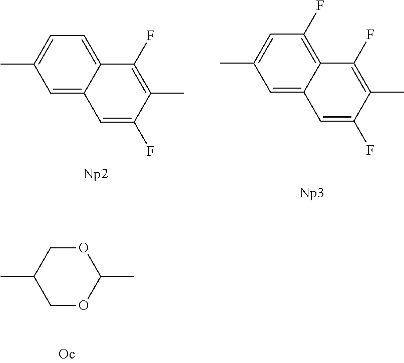

The compounds represented by the following formulae were used as compounds represented by the general formula (I).

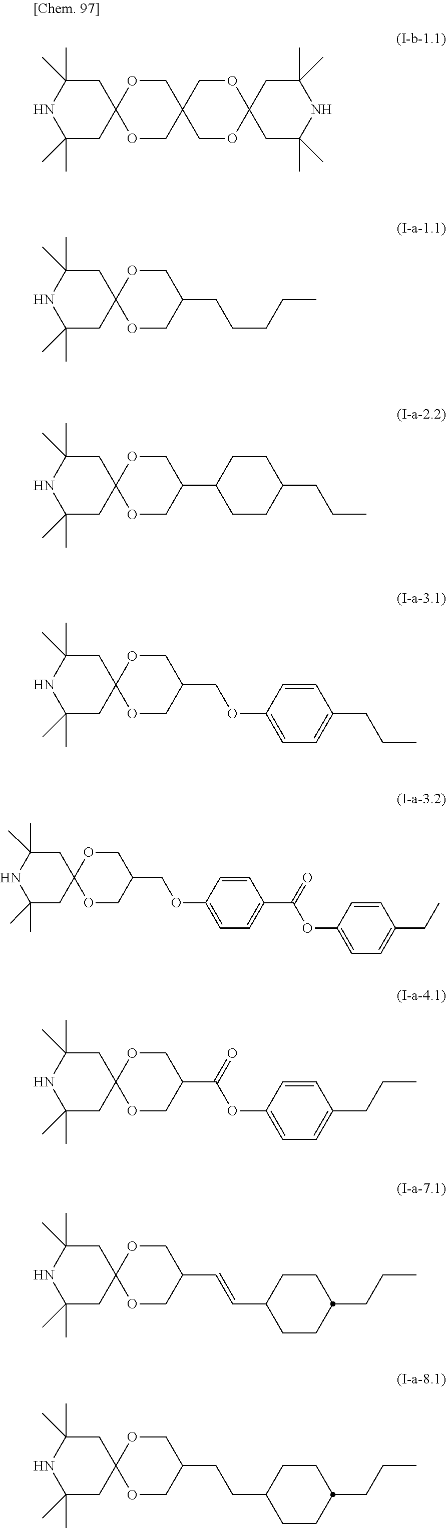

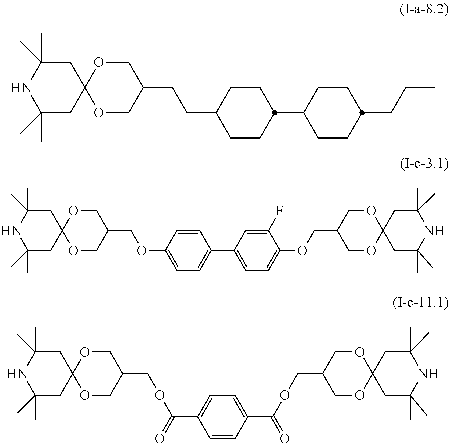

In the examples, the following characteristics were measured in composition examples.

Tₙᵢ: nematic phase-isotropic liquid phase transition temperature (° C.)

Δn: refractive index anisotropy at 25° C.

Δε: dielectric constant anisotropy at 25° C.

γ₁: rotational viscosity (mPa·s) at 25° C.

VHR (UV): voltage holding ratio (%) (1V, 60 Hz, 60° C.) after 150 (J) UV irradiation with a high-pressure mercury lamp. The illuminance was 100 mW/cm² at 365 nm.

### Comparative Example 1, Examples 1 to 3

The following LC-A liquid crystal composition was prepared and measured for the physical properties. The components and physical properties of the liquid crystal composition are listed in the table.

TABLE 1

| | LC-A |
|---|---|
| 3-Ph-Ph-1 | 8 |
| 3-Cy-Cy-V | 29 |
| 3-Cy-Cy-2 | 4 |
| 3-Cy-1O-Ph5-O1 | 3 |
| 3-Cy-1O-Ph5-O2 | 7 |
| 2-Cy-Cy-1O-Ph5-O2 | 13 |
| 3-Cy-Cy-1O-Ph5-O2 | 13 |
| 4-Cy-Cy-1O-Ph5-O2 | 7 |
| V-Cy-Cy-1O-Ph5-O2 | 6 |
| 3-Ph-Ph5-Ph-1 | 4 |
| 3-Ph-Ph5-Ph-2 | 6 |
| Total (%) | 100 |
| Tₙᵢ [° C.] | 76 |
| Δn | 0.098 |
| γ₁ [mPa · s] | 89 |
| Δε | −3.7 |

In Example 1, 0.10 parts by weight of the compound represented by the formula (I-b-1.1) was added to 100 parts by weight of the liquid crystal composition LC-A to prepare a liquid crystal composition LC-1. In Example 2, 0.05 parts by weight of the compound represented by the formula (I-b-1.1) was added to 100 parts by weight of the liquid crystal composition LC-A to prepare a liquid crystal composition LC-2. In Example 3, 0.02 parts by weight of the compound represented by the formula (I-b-1.1) was added to 100 parts by weight of the liquid crystal composition LC-A to prepare a liquid crystal composition LC-3. A liquid crystal composition composed of 100 parts by weight of LC-A was used as Comparative Example 1. The VHR (UV) results are listed in the table.

TABLE 2

| | Comparative | Exam- | Exam- | Exam- |
|---|---|---|---|---|
| | example 1 | ple 1 | ple 2 | ple 3 |
| | LC-A | LC-1 | LC-2 | LC-3 |
| Compound represented | — | 0.10 | 0.05 | 0.02 |
| by formula (I-b-1.1) | | | | |
| (parts by mass) | | | | |
| Liquid crystal | 100 | 100 | 100 | 100 |
| composition LC-A | | | | |
| (parts by mass) | | | | |
| VHR (UV) | 70 | 96 | 95 | 94 |

Examples 1 to 3 had a sufficiently higher than Comparative Example 1. Examples 1 to 3 had no display unevenness. The liquid crystal compositions LC-1, LC-2, and LC-3 had the same Tₙᵢ, Δn, Δε, and γ₁ as the liquid crystal composition LC-A.

### Comparative Example 2, Examples 4 to 6

The following LC-B liquid crystal composition was prepared and measured for the physical properties. The components and physical properties of the liquid crystal composition are listed in the table.

TABLE 3

| | LC-B |
|---|---|
| 3-Cy-Cy-V | 20 |
| 3-Cy-Cy-V1 | 10 |
| V-Cy-Ph-Ph-3 | 10 |
| 3-Cy-1O-Ph5-O2 | 8 |
| 1V-Cy-1O-Ph5-O1 | 4 |
| 1V-Cv-1O-Ph5-O2 | 4 |
| 3-Cy-Cy-1O-Ph5-O2 | 9 |
| V-Cy-Cy-1O-Ph5-O2 | 12 |
| 1V-Cy-Cy-1O-Ph5-O1 | 5 |
| 1V-Cy-Cy-1O-Ph5-O2 | 5 |
| 3-Ph-Ph5-Ph-1 | 5 |
| 3-Ph-Ph5-Ph-2 | 8 |
| Total (%) | 100 |
| Tₙᵢ [° C.] | 91 |
| Δn | 0.115 |
| γ₁ [mPa · s] | 121 |
| Δε | −4.0 |

In Example 4, 0.05 parts by weight of the compound represented by (I-b-1.1) was added to 100 parts by weight of the liquid crystal composition LC-B to prepare a liquid crystal composition LC-4. In Example 5, 0.05 parts by weight of the compound represented by the formula (I-a-1.1) was added to 100 parts by weight of the liquid crystal composition LC-B to prepare a liquid crystal composition LC-5. In Example 6, 0.08 parts by weight of the compound represented by the formula (I-a-2.2) was added to 100 parts by weight of the liquid crystal composition LC-B to prepare a liquid crystal composition. EC-6. A liquid crystal composition composed of 100 parts by weight of LC-B was used as Comparative Example 2. The VHR (UV) results are listed in the table.

TABLE 4

| | Comparative | Exam- | Exam- | Exam- |
|---|---|---|---|---|
| | example 2 | ple 4 | ple 5 | ple 6 |
| | LC-B | LC-4 | LC-5 | LC-6 |
| Compound represented | — | 0.05 | | |
| by formula (I-b-1.1) | | | | |
| (parts by mass) | | | | |
| Compound represented | — | — | 0.05 | — |
| by formula (I-a-1.1) | | | | |
| (parts by mass) | | | | |
| Compound represented | — | — | — | 0.08 |
| by formula (I-a-2.2) | | | | |
| (parts by mass) | | | | |
| Composition LC-B | 100 | 100 | 100 | 100 |
| (parts by mass) | | | | |
| VHR (UV) | 51 | 96 | 95 | 84 |

Examples 4 to 6 had a sufficiently higher VHR (UV) than Comparative Example 2. Examples 4 to 6 had no display unevenness. The liquid crystal compositions LC-A, LC-5, and LC-6 had the same Tₙᵢ, Δn, Δε, and γ₁ as the liquid crystal composition LC-B.

### Comparative Example 3, Examples 7 to 9

The following LC-C liquid crystal composition was prepared and measured for the physical properties. The components and physical properties of the liquid crystal composition are listed in the table.

TABLE 5

| | LC-C |
|---|---|
| 3-Cy-Cy-V1 | 12 |
| 3-Cy-Cy-2 | 16 |
| 1V-Cy-Cy-1O-Ph5-O2 | 6 |
| 1-Ph-2-Ph-Ph5-O2 | 4 |
| 3-Ph-2-Ph-Ph5-O2 | 6 |
| 3-Cy-Ph5-O2 | 13 |
| 3-Ph-Ph5-O2 | 13 |
| 2-Cy-Cy-Ph5-O2 | 7 |
| 3-Cy-Cy-Ph5-O2 | 7 |
| 2-Cy-Ph-Ph5-O2 | 8 |
| 3-Cy-Ph-Ph5-O2 | 8 |
| Total (%) | 100 |
| Tₙᵢ [° C.] | 76 |
| Δn | 0.114 |
| γ₁ [mPa · s] | 117 |
| Δε | −4.4 |

In Example 7, 0.07 parts by weight of the compound represented by the formula (I-b-1.1) was added to 100 parts by weight of the liquid crystal composition LC-C to prepare a liquid crystal composition LC-7. In Example 8, 0.03 parts by weight of the compound represented by the formula (I-a-1.1) and 0.03 parts by weight of the compound represented by the formula (I-a-8.2) were added to 100 parts by weight of the liquid crystal composition LC-C to prepare a liquid crystal composition LC-B. In Example 9, 0.02 parts by weight of the compound represented by the formula (I-a-1.1) and 0.05 parts by weight of the compound represented by the formula (I-a-8.2) were added to 100 parts by weight of the liquid crystal composition LC-C to prepare a liquid, crystal, composition LC-9. A liquid crystal composition, composed of 100 parts by weight of LC-C was used as Comparative Example 3. The VHR (UV) results are listed in the table.

TABLE 6

| | Comparative | Exam- | Exam- | Exam- |
|---|---|---|---|---|
| | example 3 | ple 7 | ple 8 | ple 9 |
| | LC-C | LC-7 | LC-8 | LC-9 |
| Compound represented | — | 0.07 | — | — |
| by formula (I-b-1.1) | | | | |
| (parts by mass) | | | | |
| Compound represented | — | — | 0.03 | 0.02 |
| by formula (I-a-1.1) | | | | |
| (parts by mass) | | | | |
| Compound represented | — | — | 0.03 | 0.05 |
| by formula (I-a-8.2) | | | | |
| (parts by mass) | | | | |
| Composition LC-C | 100 | 100 | 100 | 100 |
| (parts by mass) | | | | |
| VHR (UV) | 75 | 96 | 95 | 95 |

Examples 7 to 9 had a sufficiently higher VHR (UV) than Comparative Example 3. Examples 7 to 9 had no display unevenness. The liquid crystal compositions LC-7, LC-8, and LC-9 had the same Tₙᵢ, Δn, Δε, and γ₁ as the liquid crystal composition LC-C.

### Comparative Example 4, Examples 10 to 12

The following LC-D liquid crystal composition was prepared and measured for the physical properties. The components and physical properties of the liquid crystal composition are listed in the table.

TABLE 7

| | LC-D |
|---|---|
| 3-Cy-Cy-V | 28 |
| 1V-Cy-Cy-1O-Ph5-O2 | 6 |
| 1-Ph-2-Ph-Ph5-O2 | 4 |
| 3-Ph-2-Ph-Ph5-O2 | 6 |
| 3-Cy-Ph5-O2 | 13 |
| 3-Ph-Ph5-O2 | 13 |
| 2-Cy-Cy-Ph5-O2 | 7 |
| 3-Cy-Cy-Ph5-O2 | 7 |
| 2-Cy-Ph-Ph5-O2 | 8 |
| 3-Cy-Ph-Ph5-O2 | 8 |
| Total (%) | 100 |
| Tₙᵢ [° C.] | 73 |
| Δn | 0.112 |
| γ₁ [mPa · s] | 103 |
| Δε | −4.4 |

In Example 10, 0.08 parts by weight of the compound represented by the formula (I-b-1.1) was added to 100 parts by weight of the liquid crystal composition LC-D to prepare a liquid crystal composition LC-10. In Example 11, 0.08parts by weight of the compound represented by the formula (I-a-1.1) was added to 100 parts by weight of the liquid crystal composition LC-D to prepare a liquid crystal composition LC-11. In Example 12, 0.08 parts by weight of the compound represented by the formula (I-a-8.1) was added to 100 parts by weight of the liquid crystal composition LC-D to prepare a liquid crystal composition LC-12. A liquid crystal composition composed of 100 parts by weight of LC-D was used as Comparative Example 4. The VHR (UV) results are listed in the table.

TABLE 8

| | Comparative | Exam- | Exam- | Exam- |
|---|---|---|---|---|
| | example 4 | ple 10 | ple 11 | ple 12 |
| | LC-D | LC-10 | LC-11 | LC-12 |
| Compound represented | — | 0.08 | — | — |
| by formula (I-b-1.1) | | | | |
| (parts by mass) | | | | |
| Compound represented | — | — | 0.08 | — |
| by formula (I-a-1.1) | | | | |
| (parts by mass) | | | | |
| Compound represented | — | — | — | 0.08 |
| by formula (I-a-8.1) | | | | |
| (parts by mass) | | | | |
| Composition LC-D | 10 | 100 | 100 | 100 |
| (parts by mass) | | | | |
| VHR (UV) | 64 | 95 | 95 | 94 |

Examples 10 to 12 had a sufficiently higher VHR (UV) than Comparative Example 4. Examples 10 to 12 had no display unevenness. The liquid crystal compositions LC-10, LC-11, and LC-12 had the same Tₙᵢ, Δn, Δε, and γ₁ as the liquid crystal composition LC-D.

### Comparative Example 5, Examples 13 to 15

The following LC-E liquid crystal composition was prepared and measured for the physical properties. The components and physical properties of the liquid crystal composition are listed in the table.

TABLE 9

| | LC-E |
|---|---|
| 3-Cy-Cy-V | 26 |
| 3-Cy-Ph-Ph-2 | 6 |
| V-Cy-Cy-1O-Ph5-O2 | 6 |
| 1-Ph-2-Ph-Ph5-O2 | 4 |
| 3-Cy-Ph5-O2 | 7 |
| 3-Ph-Ph5-O2 | 13 |
| 2-Cy-Cy-Ph5-O2 | 10 |
| 3-Cy-Cy-Ph5-O2 | 10 |
| 2-Cy-Ph-Ph5-O2 | 6 |
| 3-Cy-Ph-Ph5-O2 | 6 |
| 3-Ph-Ph5-Ph-2 | 6 |
| Total (%) | 100 |
| Tₙᵢ [° C.] | 84 |
| Δn | 0.121 |
| γ₁ [mPa · s] | 106 |
| Δε | −3.7 |

In Example 13, 0.05 parts by weight of the compound represented by the formula (I-b-1.1) and 0.05 parts by weight of the compound represented by the formula (I-a-4.1) were added to 100 parts by weight of the liquid crystal composition LC-E to prepare a liquid crystal composition LC-13. In Example 14, 0.03 parts by weight of the compound represented by the formula (I-b-1.1), 0.03 parts by weight of the compound represented by the formula (I-a-3.1), and 0.03 parts by weight of the compound represented by the formula (I-a-3.2) were added to 100 parts by weight of the liquid crystal composition LC-E to prepare a liquid crystal composition LC-14. In Example 15, 0.05 parts by weight of the compound represented by the formula (I-b-1.1) and 0.05 parts by weight of the compound represented by the formula (I-a-3.2) were added to 100 parts by weight of the liquid crystal composition LC-E to prepare a liquid crystal composition LC-15. A liquid crystal composition composed of 100 parts by weight of LC-E was used as Comparative Example 5. The VHR (UV) results are listed in the table.

TABLE 10

| | Comparative | Exam- | Exam- | Exam- |
|---|---|---|---|---|
| | example 5 | ple 13 | ple 14 | ple 15 |
| | LC-E | LC-13 | LC-14 | LC-15 |
| Compound represented | — | 0.05 | 0.03 | 0.05 |
| by formula (I-b-1.1) | | | | |
| (parts by mass) | | | | |
| Compound represented | — | — | 0.03 | — |
| by formula (I-a-3.1) | | | | |
| (parts by mass) | | | | |
| Compound represented | — | — | 0.03 | 0.05 |
| by formula (I-a-3.2) | | | | |
| (parts by mass) | | | | |
| Compound represented | — | 0.05 | | — |
| by formula (I-a-4.1) | | | | |
| (parts by mass) | | | | |
| Composition LC-E | 100 | 100 | 100 | 100 |
| (parts by mass) | | | | |
| VHR (UV) | 75 | 95 | 95 | 95 |

Examples 13 to 15 had a sufficiently higher VHR (UV) than Comparative Example 5. Examples 13 to 15 had no display unevenness. The liquid crystal compositions LC-13, LC-14, and LC-15 had the same Tₙᵢ, Δn, Δε, and γ₁ as the liquid crystal composition LC-E.

### Comparative Example 6, Examples 16 to 18

The following LC-E liquid crystal composition was prepared and measured for the physical properties. The components, and physical properties of the liquid crystal composition, are listed in the table.

TABLE 11

| | LC-F |
|---|---|
| V-Cy-Cy-Y | 32 |
| 3-Ph-Ph-1 | 7 |
| 5-Ph-Ph-1 | 4 |
| 3-Cy-Cy-Ph-1 | 7 |
| 3-Cv-1O-Ph5-O2 | 5 |
| 2-Cy-Cy-1O-Ph5-O2 | 12 |
| 3-Cy-Cy-1O-Ph5-O2 | 11 |
| 3-Cy-Ph-Ph5-O3 | 7 |
| 3-Cy-Ph-Ph5-O4 | 9 |
| 4-Cy-Ph-Ph5-O3 | 6 |
| Total (%) | 100 |
| Tₙᵢ [° C.] | 76 |
| Δn | 0.101 |
| γ₁ [mPa · s] | 74 |
| Δε | −2.8 |

In Example 16, 0.08 parts by weight of the compound represented by the formula (I-b-1.1) was added to 100 parts by weight of the liquid crystal composition LC-F to prepare a liquid crystal composition LC-16. In Example 17, 0.08parts by weight of the compound represented by the formula (I-a-7.1) was added to 100 parts by weight of the liquid crystal composition LC-F to prepare a liquid crystal composition LC-17. In Example 18, 0.03 parts by weight of the compound represented by the formula. (I-a-8.1) and 0.03 parts by weight of the compound represented by the formula (I-c-3.1) were added to 100 parts by weight of the liquid crystal composition LC-F to prepare a liquid crystal composition LC-18. A liquid crystal composition composed of 100 parts by weight of LC-F was used as Comparative Example 6. The VHR (UV) results are listed in the table.

TABLE 12

| | Comparative | Exam- | Exam- | Exam- |
|---|---|---|---|---|
| | example 6 | ple 16 | ple 17 | ple 18 |
| | LC-F | LC-16 | LC-17 | LC-18 |
| Compound represented | — | 0.08 | — | — |
| by formula (I-b-1.1) | | | | |
| (parts by mass) | | | | |
| Compound represented | — | — | 0.08 | — |
| by formula (I-a-7.1) | | | | |
| (parts by mass) | | | | |
| Compound represented | — | — | — | 0.03 |
| by formula (I-a-8.1) | | | | |
| (parts by mass) | | | | |
| Compound represented | — | — | — | 0.03 |
| by formula (I-c-3.1) | | | | |
| (parts by mass) | | | | |
| Composition LC-F | 100 | 100 | 100 | 100 |
| (parts by mass) | | | | |
| VHR (UV) | 51 | 93 | 95 | 90 |

Examples 16 to 18 had a sufficiently higher VHR (UV) than Comparative Example 6. Examples 16 to 18 had no display unevenness. The liquid crystal compositions LC-16, LC-17, and LC-18 had the same Tₙᵢ, Δn, Δε, and γ₁ as the liquid crystal composition LC-F.

### (Examination of Response Time)

Liquid crystal display devices including the liquid crystal compositions LC-1 to EC-18 had a sufficiently high-speed response time for use in television sets. The cell thickness was 3.5 μm. The alignment film, was JALS2096. The conditions for response time measurements included Von of 6 V, Voff of 1 V, and a measurement temperature of 25° C. DMS703 from Autronic-Melchers GmbH was used.

### (Examination of Polymerizable Monomer Additive Composition)

A liquid crystal composition prepared from 99.6% by mass LC-1 and 0.4% by mass of the polymerizable monomer-represented by the formula (XX-2) was used to produce a PSVA liquid crystal display device. The liquid crystal display device had no display defect and had a sufficiently high-speed response time. Liquid crystal compositions prepared using LC-2 to LC18 instead of LC-1 were used to produce PSVA liquid crystal display devices. The liquid crystal display devices had no display defect and had a sufficiently high-speed response time.

A liquid crystal composition prepared from 99.6% by mass LC-1 and 0.4% by mass of the polymerizable monomer represented by the formula (XX-4) was used to produce a PSVA liquid crystal display device. The liquid crystal display device had no display defect and had a sufficiently high-speed response time. Liquid crystal compositions prepared using LC-2 to LC18 instead of LC-1 were used to produce PSVA liquid crystal display devices. The liquid crystal display devices had no display defect and had a sufficiently high-speed response time.

A liquid crystal composition was prepared from 99.7% LC-1 and 0.3% of the polymerizable monomer represented by (XX-4), and 20 ppm of the antioxidant (H-14) was added to the liquid crystal composition. The liquid crystal composition was used to produce a PSVA liquid crystal display device. The liquid crystal display device had no display defect and had a sufficiently high-speed response time. Liquid crystal compositions prepared using LC-2 to LC18 instead of LC-1 were used to produce PSVA liquid crystal display devices. The liquid crystal display devices had no display defect and had a sufficiently high-speed response time.

A liquid crystal composition prepared from 99.6% by mass LC-1 and 0.4% by mass of a polymerizable monomer represented by the formula (P-302) was used to produce a PSVA liquid crystal display device. The liquid crystal display device had no display defect and had a sufficiently high-speed response time. Likewise, liquid crystal compositions prepared using LC-2 and LC-3 instead of LC-1 were used to produce PSVA liquid crystal display devices. The liquid crystal display devices had no display defect and had a sufficiently high-speed response time. Liquid crystal compositions prepared using LC-2 to LC18 instead of LC-1were used to produce PSVA liquid crystal display devices. The liquid crystal display devices had no display defect and had a sufficiently high-speed response time.

A liquid crystal composition prepared from 99.6% by mass LC-1, 0.4% by mass of the polymerizable monomer represented by the formula (XX-4), and 0.1% by mass of the polymerizable monomer represented by the formula (Ia-31) was used to produce a PSVA liquid crystal display device. The liquid crystal display device had no display defect and had a sufficiently high-speed response time. Liquid crystal compositions prepared using LC-2 to LC18 instead of LC-1 were used to produce PSVA liquid crystal display devices. The liquid crystal display devices had no display defect and had a sufficiently high-speed response time.

### Comparative Examples 7 to 10, Examples 19 to 21

The following LC-G liquid crystal composition was prepared and measured for the physical properties. The components and physical properties of the liquid crystal composition are listed in the table.

TABLE 13

| | LC-G |
|---|---|
| 3-Cy-Cy-V0 | 43 |
| 3-Cy-Cy-V1 | 12 |
| 1V2-Ph-Ph-1 | 7 |
| 0V-Cy-Cy-Ph-1 | 11.5 |
| V2-Cy-Cy-Ph-1 | 9.5 |
| 3-Ph-Ph1-Ph-2 | 6 |
| 3-Pr-Ph-Ph2-CFFO-Ph3-F | 4.5 |
| 3-Ph-Ph1-Ph2-CFFO-Ph3-F | 6 |
| 3-Ph-Ph-Ph1-Ph2-F | 0.5 |
| Total (%) | 100 |
| Tₙᵢ [° C.] | 81 |
| Δn | 0.098 |
| γ₁ [mPa · s] | 35 |
| Δε | 2.4 |

In Example 19, 0.10 parts by weight of the compound represented by the formula (I-b-1.1) was added to 100 parts by weight of the liquid crystal composition LC-G to prepare a liquid crystal composition LC-19. In Example 20, 0.05 parts by weight of the compound represented by the formula (I-b-1.1) was added to 100 parts by weight of the liquid crystal composition LC-G to prepare a liquid, crystal composition LC-20. In Example 21, 0.02 parts by weight of the compound represented by the formula (I-b-1.1) was added to 100 parts by weight of the liquid crystal composition LC-G to prepare a liquid crystal composition LC-21. A liquid crystal composition composed of 100 parts by weight of LC-G was used as Comparative Example 7. In Comparative Example 8, 0.10 parts by weight of the compound represented by the following formula (HA) was added to 100 parts by weight of the liquid crystal composition LC-G to prepare a liquid crystal composition LC-G1. In Comparative Example 9, 0.05 parts by weight of the compound represented by the formula (HA) was added to 100 parts by weight of the liquid crystal composition LC-G to prepare a liquid crystal composition LC-G2. In Comparative Example 10, 0.02 parts by weight of the compound represented by the formula (HA) was added to 100 parts by weight of the liquid crystal composition LC-G to prepare a liquid crystal composition LC-G3. The VHR (UV) results are listed in the table.

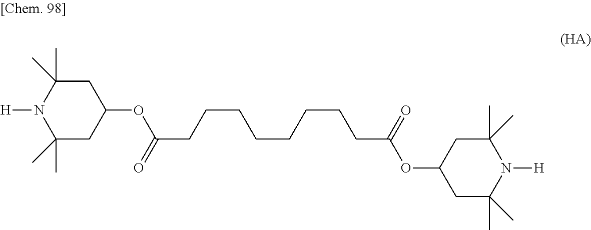 [SMILES: CC1(C)CC(OC(=O)CCCCCCCCC(=O)OC2CC(C)(C)NC(C)(C)C2)CC(C)(C)N1]

TABLE 14

| | Comparative | Comparative | Comparative | Comparative | | | |
|---|---|---|---|---|---|---|---|
| | example 7 | example 8 | example 9 | example 10 | Example 19 | Example 20 | Example 21 |
| | LC-G | LC-G1 | LC-G2 | LC-G3 | LC-19 | LG-20 | LC-21 |
| Compound represented | — | 0.10 | 0.05 | 0.02 | — | — | — |
| by formula (HA) | | | | | | | |
| (parts by mass) | | | | | | | |
| Compound represented | — | — | — | — | 0.10 | 0.05 | 0.02 |
| by formula (I-b-1.1) | | | | | | | |
| (parts by mass) | | | | | | | |
| Composition LC-G | 100 | 100 | 100 | 100 | 100 | 100 | 100 |
| (parts by mass) | | | | | | | |
| VHR (UV) | 82 | 83 | 86 | 86 | 88 | 88 | 88 |

Examples 13 to 21 had a sufficiently higher VHR (UV) than Comparative Example 7. Examples 19 to 21 had no display unevenness. The liquid crystal compositions LC-19, LC-20, and LC-21 had the same Tₙᵢ, Δn, Δε, and γ₁ as the liquid crystal composition LC-G. Examples 19 to 21 had a VHR (UV) equal to or higher than those of Comparative Examples 8 to 10, which included the compound having the hindered amine structure represented by the formula (HA).

### Comparative Example 11, Examples 22 to 24

The following LC-H liquid crystal composition was prepared and measured for the physical properties. The components and physical properties of the liquid crystal composition are listed in the table.

TABLE 15

| | LC-H |
|---|---|
| 3-Cy-Cy-V0 | 32.5 |
| 3-Cy-Cy-V1 | 2.5 |
| 0V-Cy-Cy-Ph-1 | 10 |
| 5-Cy-Cy-Ph-O1 | 2.5 |
| 3-Cy-Ph-Ph-Cy-3 | 3.5 |
| 3-Cy-Cy-Ph2-F | 8 |
| 3-Ph-Ph2-CFFO-Ph2-F | 9 |
| 3-Cy-Cy-CFFO-Ph2-F | 9.5 |
| 3-Cy-Cy-Ph1-Ph2-F | 4 |
| 3-Pr-Ph-Ph2-CFFO-Ph2-F | 8.5 |
| 3-Ph-Ph1-Ph2-CFFO-Ph2-F | 4 |
| 3-Cy-Ph-Ph2-Ph1-OCF3 | 6 |
| Total (%) | 100 |
| Tₙᵢ [° C.] | 100 |
| Δn | 0.100 |
| γ₁ [mPa · s] | 72 |
| Δε | 8.1 |

In Example 22, 0.05 parts by weight of the compound represented by the formula (I-b-1.1) was added to 100 parts by weight of the liquid crystal composition LC-H to prepare a liquid crystal composition LC-22. In Example 23, 0.05 parts by weight of the compound represented by the formula (I-a-2.2) was added to 100 parts by weight of the liquid crystal composition LC-H to prepare a liquid crystal composition LC-23. In Example 24, 0.08 parts by weight of the compound represented by the formula (I-a-7.1) was added to 100 parts by weight of the liquid crystal composition LC-H to prepare a liquid crystal composition LC-24. A liquid crystal composition composed of 100 parts by weight of LC-H was used as Comparative Example 11. The VHR (UV) results are listed in the table.

TABLE 16

| | Comparative | Exam- | Exam- | Exam- |
|---|---|---|---|---|
| | example 11 | ple 22 | ple 23 | ple 24 |
| | LC-H | LC-22 | LC-23 | LC-24 |
| Compound represented | — | 0.05 | | |
| by formula (I-b-1.1) | | | | |
| (parts by mass) | | | | |
| Compound represented | — | — | 0.05 | — |
| by formula (I-a-2.2) | | | | |
| (parts by mass) | | | | |
| Compound represented | — | — | — | 0.08 |
| by formula (I-a-7.1) | | | | |
| (parts by mass) | | | | |
| Composition LC-H | 100 | 100 | 100 | 100 |
| (parts by mass) | | | | |
| VHR (UV) | 83 | 92 | 91 | 93 |

Examples 22 to 24 had a sufficiently higher VHR (UV) than Comparative Example 11. Examples 22 to 24 had no display unevenness. The liquid crystal compositions LC-22, LC-23, and LC-24 had the same Tₙᵢ, Δn, Δε, and γ₁ as the liquid crystal composition LC-H.

### Comparative Example 12, Examples 25 to 27

The following LC-I liquid crystal composition was prepared and measured for the physical properties. The components and physical properties of the liquid crystal composition are listed in the table.

TABLE 17

| | LC-I |
|---|---|
| 3-Cy-Cy-V0 | 44 |
| 3-Cy-Cy-V1 | 16 |
| 5-Ph-Ph-1 | 3.5 |
| 3-Cy-Cy-Ph-1 | 6 |
| 3-Cy-Cy-Ph-3 | 1.5 |
| 3-Cy-Ph-Ph-2 | 7 |
| 2-Ph-Ph1-Ph-2V | 5 |
| 3-Ph1-Np2-F | 4 |
| 3-Cy-Ph1-Np2-F | 6 |
| 2-Ph-Ph1-Np2-F | 5 |
| 2-Cy-Cy-Ph-Ph1-F | 2 |
| Total (%) | 100 |
| Tₙᵢ [° C.] | 78 |
| Δn | 0.102 |
| γ₁ [mPa · s] | 38 |
| Δε | 2.3 |

In Example 25, 0.05 parts by weight of the compound represented by the formula (I-b-1.1) was added to 100 parts by weight of the liquid crystal composition LC-I to prepare a liquid crystal composition LC-25. In Example 26, 0.03 parts by weight of the compound represented by the formula (I-a-1.1) and 0.03 parts by weight of the compound represented by the formula (I-a-8.2) were added to 100 parts by weight of the liquid crystal composition LC-I to prepare a liquid crystal composition LC-26. In Example 27, 0.02 parts by weight of the compound represented by the formula (1-a-1.1) and 0.05 parts by weight of the compound represented by the formula (I-a-8.2) were added to 100 parts by weight of the liquid crystal composition LC-I to prepare a liquid crystal composition LC-27. A liquid crystal composition composed of 100 parts by weight of LC-I was used as Comparative Example 12. The VHR (UV) results are listed in the table.

TABLE 18

| | Comparative | Exam- | Exam- | Exam- |
|---|---|---|---|---|
| | example 12 | ple 25 | ple 26 | ple 27 |
| | LC-I | LC-25 | LC-26 | LC-27 |
| Compound represented | — | 0.05 | — | — |
| by formula (I-b-1.1) | | | | |
| (parts by mass) | | | | |
| Compound represented | — | — | 0.03 | 0.02 |
| by formula (I-a-1.1) | | | | |
| (parts by mass) | | | | |
| Compound represented | — | — | 0.03 | 0.05 |
| by formula (I-a-8.2) | | | | |
| (parts by mass) | | | | |
| Composition LC-I | 100 | 100 | 100 | 100 |
| (parts by mass) | | | | |
| VHR (UV) | 70 | 88 | 89 | 89 |

Examples 25 to 27 had a sufficiently higher VHR (UV) than Comparative Example 12. Examples 25 to 27 had no display unevenness. The liquid crystal compositions LC-25, LC-26, and LC-27 had the same Tₙᵢ, Δn, Δε, and γ₁ as the liquid crystal composition LC-I.

### Comparative Example 13, Examples 28 to 30

The following LC-J liquid crystal composition was prepared and measured for the physical properties. The components and physical properties of the liquid crystal composition are listed in the table.

TABLE 19

| | LC-J |
|---|---|
| 3-Cy-Cy-V0 | 40 |
| 3-Cy-Cy-2 | 4 |
| 5-Ph-Ph-1 | 1.5 |
| 0V-Cy-Cy-Ph-1 | 5.5 |
| 3-Cy-Ph-Ph-2 | 2 |
| 3-Cy-Cy-Ph2-F | 8 |
| 2-Ph2-O1-Cy-Ph2-Ph2-F | 5.5 |
| 3-Ph2-O1-Cy-Ph2-Ph2-F | 4.5 |
| 3-Ph2-O1-Ph-Np2-F | 10 |
| 3-Ph-Ph2-CFFO-Np2-F | 10 |
| 3-Ph-Ph1-Ph2-CFFO-Np2-F | 4 |
| 4-Ph-Ph1-Ph2-CFFO-Np2-F | 5 |
| Total (%) | 100 |
| Tₙᵢ [° C.] | 73 |
| Δn | 0.107 |
| γ₁ [mPa · s] | 78 |
| Δε | 11.7 |

In Example 28, 0.05 parts by weight of the compound represented by the formula (I-a-2.2) was added to 100 parts by weight of the liquid crystal composition LC-J to prepare a liquid crystal composition LC-28. In Example 29, 0.08 parts by weight of the compound represented by the formula (I-a-8.1) was added to 100 parts by weight of the liquid crystal composition LC-J to prepare a liquid crystal composition LC-29. In Example 30, 0.08 parts by weight of the compound represented by the formula (I-a-8.2) was added to 1.00 parts toy weight of the liquid crystal composition. LC-J to prepare a liquid crystal, composition LC-30. A liquid crystal composition composed of 100 parts by weight of LC-J was used as Comparative Example 13. The VHR (UV) results are listed in the table.

TABLE 20

| | Comparative | Exam- | Exam- | Exam- |
|---|---|---|---|---|
| | example 13 | ple 28 | ple 29 | ple 30 |
| | LC-J | LC-28 | LC-29 | LC-30 |
| Compound represented | — | 0.05 | — | — |
| by formula (I-a-2.2) | | | | |
| (parts by mass) | | | | |
| Compound represented | — | — | 0.08 | — |
| by formula (I-a-8.1) | | | | |
| (parts by mass) | | | | |
| Compound represented | — | — | — | 0.08 |
| by formula (I-a-8.2) | | | | |
| (parts by mass) | | | | |
| Composition LC-J | 100 | 100 | 100 | 100 |
| (parts by mass) | | | | |
| VHR (UV) | 72 | 89 | 90 | 89 |

Examples 28 to 30 had a sufficiently higher VHR (UV) than Comparative Example 13. Examples 28 to 30 had no display unevenness. The liquid crystal compositions LC-28, LC-29, and LC-30 had the same Tₙᵢ, Δn, Δε, and γ₁ as the liquid crystal composition LC-J.

### Comparative Example 14, Examples 31 to 33

The following LC-K liquid crystal composition was prepared and measured for the physical properties. The components and physical properties of the liquid crystal composition are listed in the table.

TABLE 21

| | LC-K |
|---|---|
| 3-Cy-Cy-V0 | 41 |
| 3-Cy-Cy-V1 | 11 |
| 5-Ph-Ph-1 | 2 |
| 3-Cy-Ph-Ph-2 | 6 |
| V-Cy-Ph-Ph-3 | 4 |
| 3-Ph-Ph1-Ph2-O1-V | 15 |
| 3-Cy-Ph-Ph2-O1-Ph2-F | 5 |
| 3-Ph2-O1-Oc-Ph-Ph2-F | 4 |
| 4-Ph2-O1-Oc-Ph-Ph2-F | 4 |
| 3-Ph2-O1-Oc-Ph1-Ph2-F | 5 |
| 5-Ph2-O1-Oc-Ph1-Ph2-F | 3 |
| Total (%) | 100 |
| Tₙᵢ [° C.] | 87 |
| Δn | 0.117 |
| γ₁ [mPa · s] | 54 |
| Δε | 6.3 |

In Example 31, 0.05 parts by weight of the compound represented by the formula (I-a-3.1) was added to 100 parts by weight of the liquid crystal composition LC-K to prepare a liquid crystal composition LC-31. In Example 32, 0.03 parts by weight of the compound represented by the formula (I-a-3.1), 0.03 parts by weight of the compound represented by the formula (I-a-3.2), and 0.03 parts by weight of the compound represented by the formula (I-a-4.1) were added to 100 parts by weight of the liquid crystal composition LC-K to prepare a liquid crystal composition LC-32. In Example 33, 0.05 parts by weight of the compound represented, by the formula (I-a-3.1) and 0.05 parts by weight of the compound, represented by the formula (I-a-4.1) were added to 100 parts by weight of the liquid crystal composition LC-K to prepare a liquid crystal composition LC-33. A liquid crystal composition composed of 100 parts by weight of LC-K was used as Comparative Example 14. The VHR (UV) results are listed in the table.

TABLE 22

| | Comparative | Exam- | Exam- | Exam- |
|---|---|---|---|---|
| | example 14 | ple 31 | ple 32 | ple 33 |
| | LC-K | LC-31 | LC-32 | LC-33 |
| Compound represented | — | 0.05 | 0.03 | 0.05 |
| by formula (I-a-3.1) | | | | |
| (parts by mass) | | | | |
| Compound represented | — | — | 0.03 | — |
| by formula (I-a-3.2) | | | | |
| (parts by mass) | | | | |
| Compound represented | — | — | 0.03 | 0.05 |
| by formula (I-a-4.1) | | | | |
| (parts by mass) | | | | |
| Composition LC-K | 100 | 100 | 100 | 100 |
| (parts by mass) | | | | |
| VHR (UV) | 73 | 87 | 88 | 89 |

Examples 31 to 33 had a sufficiently higher VHR (UV) than Comparative Example 14. Examples 31 to 33 had no display unevenness. The liquid crystal compositions LC-31, LC-32, and LC-33 had the same Tₙᵢ, Δn, Δε, and γ₁ as the liquid crystal composition LC-K.

### Comparative Example 15, Examples 34 to 37

The following LC-L liquid crystal composition was prepared and measured for the physical properties. The components and physical properties of the liquid crystal composition, are listed in the table.

TABLE 23

| | LC-L |
|---|---|
| 3-Cy-Cy-V | 15 |
| 3-Cy-Cy-V1 | 10 |
| 3-Cy-Cy-2 | 9 |
| 3-Cy-Cy-4 | 8 |
| 2-Cy-Ph-Ph5-O2 | 3 |
| 3-Cy-Ph-Ph5-O2 | 8 |
| 3-Ph-Ph5-Ph-2 | 9 |
| 3-Cy-Ph5-O2 | 6 |
| 3-Ph-Ph5-O2 | 14 |
| 3-Cy-Cy-Ph5-O2 | 10 |
| 5-Cy-Cy-Ph5-O2 | 8 |
| Total (%) | 100 |
| Tₙᵢ [° C.] | 76 |
| Δn | 0.105 |
| γ₁ [mPa · s] | 76 |
| Δε | −2.6 |
| VHR(UV) | 72 |

In Example 34, 0.09 parts by weight of the compound represented by the formula (I-b-1.1) was added to 100 parts by weight of the liquid crystal composition LC-L to prepare a liquid crystal composition LC-34. In Example 35, 0.09 parts by weight of the compound represented by the formula (I-a-2.2) was added to 100 parts by weight of the liquid crystal composition LC-L to prepare a liquid crystal composition LG-35. In Example 36, 0. 04 parts by weight of the compound represented by the formula (I-a-8.1) and 0.04 parts by weight of the compound represented by the formula (I-a-8.2) were added to 100 parts by weight of the liquid crystal composition LC-L to prepare a liquid crystal composition LC-36. In Example 37, 0.03 parts by weight of the compound represented by the formula (I-b-1.1), 0.03 parts by weight of the compound represented by the formula (I-a-2.2), 0.03 parts by weight of the compound represented by the formula (I-a-8.1), and 0.03 parts by weight of the compound represented by the formula (I-a-8.2) were added to 100 parts by weight of the liquid crystal composition LC-L to prepare a liquid crystal composition LC-37. A liquid crystal composition composed of 100 parts by weight of LC-L was used as Comparative Example 15. The VHR (UV) results are listed in the table.

TABLE 24

| | Compar- | | | | |
|---|---|---|---|---|---|
| | ative | | | | |
| | exam- | Exam- | Exam- | Exam- | Exam- |
| | ple 15 | ple 34 | ple 35 | ple 36 | ple 37 |
| | LC-L | LC-34 | LC-35 | LC-36 | LC-37 |
| Compound represented | | 0.09 | | | 0.03 |
| by formula (I-b-1.1) | | | | | |
| (parts by mass) | | | | | |
| Compound represented | | | 0.09 | | 0.03 |
| by formula (I-a-2.2) | | | | | |
| (parts by mass) | | | | | |
| Compound represented | | | | 0.04 | 0.03 |
| by formula (I-a-8.1) | | | | | |
| (parts by mass) | | | | | |
| Compound represented | | | | 0.04 | 0.03 |
| by formula (I-a-8.2) | | | | | |
| (parts by mass) | | | | | |
| Composition LC-L | 100 | 100 | 100 | 100 | 100 |
| (parts by mass) | | | | | |
| VHR (UV) | 72 | 95 | 94 | 94 | 95 |

Examples 34 to 37 had a sufficiently higher VHR (UV) than Comparative Example 15. Examples 34 to 37 had no display unevenness. The liquid crystal compositions LC-34, LC-35, LC-36, and LC-37 had the same Tₙᵢ, Δn, Δε, and γ₁ as the liquid crystal composition LC-L.

### Comparative Example 16, Examples 38 to 41

The following LC-M liquid crystal composition was prepared and measured for the physical properties. The components and physical properties of the liquid crystal composition are listed in the table.

TABLE 25

| | LC-M |
|---|---|
| 3-Cy-Cy-V | 15 |
| 3-Cy-Cy-V1 | 10 |
| 3-Cy-Cy-2 | 9 |
| 5-Ph-Ph-1 | 4 |
| 3-Cy-Ph-Ph-2 | 4 |
| 2-Cy-Ph-Ph5-O2 | 3 |
| 3-Cy-Ph-Ph5-O2 | 8 |
| 3-Ph-Ph5-Ph-2 | 9 |
| 3-Cy-Ph5-O2 | 20 |
| 3-Cy-Cy-Ph5-O2 | 10 |
| 5-Cy-Cy-Ph5-O2 | 8 |
| Total (%) | 100 |
| Tₙᵢ [° C.] | 76 |
| Δn | 0.105 |
| γ₁ [mPa · s] | 82 |
| Δε | −2.7 |
| VHR(UV) | 76 |

In Example 38, 0.09 parts by weight of the compound represented by the formula (I-b-1.1) was added to 100 parts by weight of the liquid crystal composition LC-M to prepare a liquid crystal composition LC-38. In Example 39, 0.09 parts by weight of the compound represented by the formula (I-a-2.2) was added to 100 parts by weight of the liquid crystal composition LC-M to prepare a liquid crystal composition LC-39. In Example 40, 0.04 parts by weight of the compound represented by the formula (I-a-8.1) and 0.04 parts by weight of the compound represented by the formula (I-a-8.2) were added to 100 parts by weight of the liquid crystal composition LC-M to prepare a liquid crystal composition LC-40. In Example 41, 0.03 parts by weight of the compound represented by the formula (I-b-1.1), 0.03 parts by weight of the compound represented by the formula (I-a-2.2), 0.03 parts by weight of the compound represented by the formula (I-a-8.1), and 0.03 parts by weight of the compound represented by the formula (I-a-8.2) were added to 100 parts by weight of the liquid crystal composition LC-M to prepare a liquid crystal composition LC-41. A liquid crystal composition composed of 100 parts by weight of LC-M was used as Comparative Example 16. The VHR (UV) results are listed in the table.

TABLE 26

| | Compar- | | | | |
|---|---|---|---|---|---|
| | ative | | | | |
| | exam- | Exam- | Exam- | Exam- | Exam- |
| | ple 16 | ple 38 | ple 39 | ple 40 | ple 41 |
| | LC-M | LC-38 | LC-39 | LC-40 | LC-41 |
| Compound represented | | 0.09 | | | 0.03 |
| by formula (I-b-1.1) | | | | | |
| (parts by mass) | | | | | |
| Compound represented | | | 0.09 | | 0.03 |
| by formula (I-a-2.2) | | | | | |
| (parts by mass) | | | | | |
| Compound represented | | | | 0.04 | 0.03 |
| by formula (I-a-8.1) | | | | | |
| (parts by mass) | | | | | |
| Compound represented | | | | 0.04 | 0.03 |
| by formula (I-a-8.2) | | | | | |
| (parts by mass) | | | | | |
| Composition LC-M | 100 | 100 | 100 | 100 | 100 |
| (parts by mass) | | | | | |
| VHR (UV) | 76 | 96 | 94 | 95 | 96 |

Examples 38 to 41 had a sufficiently higher VHR (UV) than Comparative Example 16. Examples 38 to 41 had no display unevenness. The liquid crystal compositions LC-38, LC-39, LC-40, and LC-41 had the same Tₙᵢ, Δn, Δε, and γ₁ as the liquid crystal composition LC-M.

The liquid crystal compositions LC-1 to LC41 according to the present invention left no drop mark on a substrate in the one drop fill (ODF) method. These liquid crystal display devices had no alignment unevenness. Furthermore, these liquid crystal display devices had no image sticking during operation.

### Examples 42 to 43

In Example 42, 0.05 parts by weight of the compound represented by the formula (I-c-11.1) was added to 100 parts by weight of the liquid crystal composition LC-A to prepare a liquid crystal composition LC-42. In Example 43, 0.05 parts by weight of the compound represented by the formula (I-c-11.1) was added to 100 parts by weight of the liquid crystal composition LC-B to prepare a liquid crystal composition LC-43. In Example 44, 0.02 parts by weight of the compound represented by (I-b-1.1) and 0.05 parts by weight of the compound represented by the formula (I-c-11.1) were added to 100 parts by weight of the liquid crystal composition LC-C to prepare a liquid crystal composition LC-44. In Example 45, 0.05 parts by weight of the compound represented by the formula (I-c-11.1) was added to 100 parts by weight of the liquid crystal composition LC-C to prepare a liquid crystal composition LC-45. In Example 46, 0.05 parts by weight of the compound represented by the formula (I-c-11.1) was added to 100 parts by weight of the liquid crystal composition LC-D to prepare a liquid crystal composition LC-46. In Example 47, 0.05 parts by weight of the compound represented by the formula (I-c-11.1) was added to 100 parts by weight of the liquid crystal composition LC-E to prepare a liquid crystal composition LC-47. In Example 48, 0.05 parts by weight of the compound represented by the formula (I-c-11.1) was added to 100 parts by weight of the liquid crystal composition LC-F to prepare a liquid crystal composition LC-48. The VHR (UV) results are listed in the table.

TABLE 27

| | Example 42 | Example 43 | Example 44 | Example 45 | Example 46 | Example 47 | Example 48 |
|---|---|---|---|---|---|---|---|
| | LC-42 | LC-43 | LC-44 | LC-45 | LC-46 | LC-47 | LC-48 |
| Compound represented | 0.05 | 0.05 | 0.05 | 0.05 | 0.05 | 0.05 | 0.08 |
| by formula (I-c-11.1) | | | | | | | |
| (parts by mass) | | | | | | | |
| Compound represented | | | 0.02 | | | | |
| by formula (I-b-1.1) | | | | | | | |
| (parts by mass) | | | | | | | |
| Composition | LC-A | LC-B | LC-C | LC-C | LC-D | LC-E | LC-F |
| (parts by mass) | | | | | | | |
| Total (parts by mass) | 100.05 | 100.05 | 100.07 | 100.05 | 100.05 | 100.05 | 100.08 |
| VHR (UV) | 96 | 96 | 97 | 97 | 96 | 96 | 94 |

Examples 42 to 48 had a sufficiently higher VHR (UV) than Comparative Examples 1 to 6. Examples 42 to 48 had no display unevenness. The liquid crystal compositions LC-42 to LG-48 had the same Tₙᵢ, Δn, Δε, and γ₁ as the liquid crystal compositions LC-A to LC-F without the compound represented by the formula (I-c-11.1) or without the compounds represented by the formulae (I-c-11.1) and (I-b-1.1).

### Examples 49 and 50

In Example 49, 0.10 parts by weight of the compound represented by the formula (I-c-11.1) was added to 100 parts by weight of the liquid crystal composition LC-G to prepare a liquid crystal composition LC-49. In Example 50, 0.05 parts by weight of the compound represented by the formula (I-c-11.1) was added to 100 parts by weight of the liquid crystal composition LC-G to prepare a liquid crystal composition LC-50. The VHR (UV) results are listed in the table.

TABLE 28

| | Example 49 | Example 50 |
|---|---|---|
| | LC-49 | LC-50 |
| Compound represented by formula | 0.10 | 0.05 |
| (I-c-11.1) (parts by mass) | | |
| Composition (parts by mass) | LC-G | LC-G |
| Total (parts by mass) | 100.10 | 100.05 |
| VHR (UV) | 90 | 89 |

Examples 49 and 50 had a sufficiently higher VHR (UV) than Comparative Example 7. Examples 45 and 50 had no display unevenness. The liquid crystal compositions LC-49 and LC-50 had the same Tₙᵢ, Δn, Δε, and γ₁ as LC-G without the compound represented by the formula (I-c-11.1). Thus, it was found that a liquid crystal composition according to the present invention had a sufficiently low rotational viscosity (γ₁), left no drop mark, had no display unevenness, and had a sufficiently high VHR (UV), without decreasing the refractive index anisotropy (Δn) or the nematic phase-isotropic liquid phase transition temperature (Tₙᵢ). A liquid crystal display device including a liquid crystal composition according to the present invention had no or few display defects and had high display quality and a high-speed response time.

1. A liquid crystal composition comprising one or two or more compounds represented by a general formula (I), 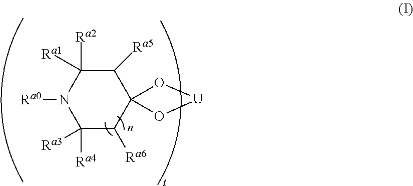
wherein R^{a0} denotes a hydrogen atom, a hydroxy group, an alkyl group having 1 to 12 carbon atoms, or an alkenyl group having 3 to 12 carbon atoms,
R^{a1}, R^{a2}, R^{a3}, and R^{a4} independently denote an alkyl group having 1 to 6 carbon atoms, or R^{a1} and R^{a2}, R^{a3} and R^{a4}, or both may together form a ring structure,
R^{a5} and R^{a6} independently denote a hydrogen atom or an alkyl group having 1 to 6 carbon atoms,
n is 0 or 1,
t ranges from 1 to 4, and
U denotes a (2×t)-valent organic group that forms a ring structure, and pluralities of R^{a0}s, R^{a1}s, R^{a2}s, R^{a3}s, R^{a4}s, R^{a5}s, and R^{a6}s, if present, may be the same or different R^{a0}s, R^{a1}s, R^{a2}s, R^{a3}s, R^{a4}s, R^{a5}s, and R^{a6}s, respectively.

2. The liquid crystal composition according to claim 1, further comprising one or two or more compounds represented by a general formula (II), 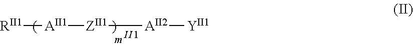
wherein R^{II1} denotes an alkyl group having 1 to 10 carbon atoms, and one —CH₂— or two or more nonadjacent —CH₂— groups in the alkyl group may be independently substituted with —CH═CH—, —C≡C—, —O—, —CO—, —COO—, or —OCO—,
A^{II1} and A^{II2} independently denote a group selected from the group consisting of
(a) a 1,4-cyclohexylene group (in which one —CH₂— or two or more nonadjacent —CH₂— groups may be substituted with —O—),
(b) a 1,4-phenylene group (in which one —CH═ or two or more nonadjacent —CH═ groups may be substituted with —N═), and
(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═ groups in the naphthalene-2,6-diyl group or the 1,2,3,4-tetrahydronaphthalene-2,6-diyl group may be substituted with —N═).
the groups (a), (b), and (c) may be independently substituted with a cyano group, a fluorine atom, or a chlorine atom,
Z^{II1} denotes a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,
Y^{II1} denotes a hydrogen atom, a fluorine atom, a chlorine atom, a cyano group, or an alkyl group having 1 to 10 carbon atoms, one —CH₂— or two or more nonadjacent —CH₂— groups in the alkyl group may be independently substituted with —CH═CH—, —C≡C—, —O—, —CO—, —COO—, or —OCO—, and one or two or more hydrogen atoms in the alkyl group may be substituted with a fluorine atom, and
m^{II1} is 1, 2, 3, or 4, and if m^{II1} is 2, 3, or 4, pluralities of A^{II1}s and Z^{II1}s may be the same or different A^{II1}s and Z^{II1}s, respectively.

3. The liquid crystal composition according to claim 1, wherein the liquid crystal composition has a negative dielectric constant anisotropy (Δε) at 25° C.

4. The liquid crystal composition according to claim 1, wherein the liquid crystal composition has a positive dielectric constant anisotropy (Δε) at 25° C.

5. The liquid crystal composition according to claim 1, wherein a total amount of the compounds represented by the general formula (I) in the liquid crystal composition ranges from 0.01% to 5% by mass.

6. The liquid crystal composition according to claim 2, wherein a total amount of the compounds represented by the general formula (II) in the liquid crystal composition ranges from 10% to 90% by mass.

7. The liquid crystal composition according to claim 1, wherein the liquid crystal composition has a refractive index anisotropy (Δn) in the range of 0.08 to 0.14 at 25° C., a rotational viscosity (γ1) in the range of 60 to 130 mPa·s at 25° C. and a nematic phase-isotropic liquid phase transition temperature (Tₙᵢ) in the range of 60° C. to 120° C.

8. The liquid crystal composition according to claim 1, comprising one or two or more polymerizable compounds and/or antioxidants.

9. A liquid crystal display device comprising the liquid crystal composition according to claim 1.
